(19) United States
(12) Patent Application Publication
(10) Pub. No.: US 2025/0217149 A1
(43) Pub. Date: Jul. 3, 2025

(54) APPARATUSES, METHODS, AND SYSTEMS FOR INSTRUCTIONS FOR MATRIX TRANSPOSE

(71) Applicant: Intel Corporation, Santa Clara, CA (US)

(72) Inventors: Kamlesh PILLAI, Bangalore (IN); Christopher J. HUGHES, Santa Clara, CA (US); Vinay JOSHI, Maharashatra (IN); Om Ji OMER, Bangalore (IN)

(21) Appl. No.: 18/401,410

(22) Filed: Dec. 30, 2023

(51) Int. Cl. G06F 9/30; G06F 17/16

(52) U.S. Cl. CPC G06F 9/30181; G06F 17/16

(57) ABSTRACT

Examples detailed herein at least include transpose circuitry that is external to a matrix operations accelerator. In some examples, the transpose circuitry at least includes a plurality of transpose engines to transpose a source matrix operand of a single instruction to generate a transposed source matrix, and control circuitry to direct the plurality of transpose engines to alternately operate in a parallel loading mode and a serial loading mode to generate the transposed source matrix, wherein the plurality of transposes engines and the control circuitry are at least a portion of transpose circuitry.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an example of configured tiles according to examples of the disclosure.

FIG. 1B illustrates an example of configured tiles according to examples of the disclosure.

FIG. 2 illustrates several examples of matrix storage according to examples of the disclosure.

FIG. 3 illustrates an example of a system utilizing a matrix (tile) operations accelerator according to examples of the disclosure.

FIGS. 4 and 5 show different examples of how memory is shared using a matrix operations accelerator.

FIG. 6 illustrates an example of matrix multiply accumulate operation using tiles (“TMMA”).

FIG. 7 illustrates an example of a subset of the execution of an iteration of a chained fused multiply accumulate instruction.

FIG. 8 illustrates an example of a subset of the execution of an iteration of a chained fused multiply accumulate instruction.

FIG. 9 illustrates an example of a subset of the execution of an iteration of a chained fused multiply accumulate instruction.

FIG. 10 illustrates an example of a subset of the execution of an iteration of chained fused multiply accumulate instruction.

FIG. 11 illustrates power-of-two sized SIMD implementations wherein the accumulators use input sizes that are larger than the inputs to the multipliers according to an example.

FIG. 12 illustrates an example of a system utilizing matrix operations circuitry.

FIG. 13 illustrates an example of a processor core pipeline supporting matrix operations using tiles.

FIG. 14 illustrates an example of a processor core pipeline supporting matrix operations using tiles.

FIG. 15 illustrates an example of a matrix expressed in row major format and column major format.

FIG. 16 illustrates an example of usage of matrices (tiles).

FIG. 17 illustrates an example a method of usage of matrices (tiles).

FIG. 18 illustrates support for configuration of the usage of tiles according to an example.

FIG. 19 illustrates an example of a description of the matrices (tiles) to be supported.

FIGS. 20A-20D illustrate examples of register(s).

FIG. 21 illustrates examples of one or more systems including a matrix operations accelerator and transpose circuitry.

FIG. 22 illustrates examples of transpose circuitry.

FIG. 23 illustrates examples of a transpose engine.

FIG. 24 illustrates examples of a data flow of a transport engine.

FIG. 25 illustrates an example presenting the transposition of a 4-D tensor.

FIG. 26 illustrates examples of enable handling in a transpose engine.

FIG. 27 illustrates an example of data loading using a mux.

FIG. 28 illustrates examples of a demultiplexer in writeback.

FIG. 29 illustrates examples of scaling.

FIG. 30 illustrates examples of output processing.

FIG. 31 illustrates example data flows inside the partial merge and write back block.

FIG. 32 illustrates an example method to process a TTMM instruction.

FIG. 33 illustrates examples of execution and source operand retrieval.

FIG. 34 illustrates an example method to process a TTCOMPUTE instruction.

FIG. 35 illustrates an example computing system.

FIG. 36 illustrates a block diagram of an example processor and/or System on a Chip (SoC) that may have one or more cores and an integrated memory controller.

FIG. 37 is a block diagram illustrating a computing system 3700 configured to implement one or more aspects of the examples described herein.

FIG. 38A illustrates examples of a parallel processor.

FIG. 38B illustrates examples of a block diagram of a partition unit.

FIG. 38C illustrates examples of a block diagram of a processing cluster within a parallel processing unit.

FIG. 38D illustrates examples of a graphics multiprocessor in which the graphics multiprocessor couples with the pipeline manager of the processing cluster.

FIGS. 39A-39C illustrate additional graphics multiprocessors, according to examples.

FIG. 40 shows a parallel compute system, according to some examples.

FIGS. 41A-41B illustrate a hybrid logical/physical view of a disaggregated parallel processor, according to examples described herein.

FIG. 42(A) is a block diagram illustrating both an example in-order pipeline and an example register renaming, out-of-order issue/execution pipeline according to examples.

FIG. 42(B) is a block diagram illustrating both an example in-order architecture core and an example register renaming, out-of-order issue/execution architecture core to be included in a processor according to examples.

FIG. 43 illustrates examples of execution unit(s) circuitry, such as execution unit(s) circuitry.

FIG. 44 is a block diagram of a register architecture according to some examples.

FIG. 45 illustrates examples of an instruction format.

FIG. 46 illustrates examples of an addressing information field.

FIGS. 47(A)-(B) illustrate examples of a first prefix.

FIGS. 48(A)-(D) illustrate examples of how the R, X, and B fields of the first prefix are used.

FIGS. 49(A)-(B) illustrate examples of a second prefix.

FIGS. 50(A)-(E) illustrate examples of a third prefix.

FIGS. 51A-51B illustrate thread execution logic including an array of processing elements employed in a graphics processor core according to examples described herein.

FIG. 52 illustrates an additional execution unit, according to an example.

FIG. 53 is a block diagram illustrating a graphics processor instruction formats 5300 according to some examples.

FIG. 54 is a block diagram of another example of a graphics processor.

FIG. 55A is a block diagram illustrating a graphics processor command format according to some examples.

FIG. 55B is a block diagram illustrating a graphics processor command sequence according to an example.

FIG. 56 is a block diagram illustrating the use of a software instruction converter to convert binary instructions in a source ISA to binary instructions in a target ISA according to examples.

FIG. 57 is a block diagram illustrating an IP core development system 5700 that may be used to manufacture an integrated circuit to perform operations according to some examples.

### DETAILED DESCRIPTION

In the following description, numerous specific details are set forth. However, it is understood that examples may be practiced without these specific details. In other instances, well-known circuits, structures, and techniques have not been shown in detail in order not to obscure the understanding of this description.

Matrices may be increasingly important in many computing tasks such as machine learning and other bulk data processing. Deep Learning is a class of machine learning algorithms. Deep learning architectures, such as deep neural networks, may be applied to fields including computer vision, speech recognition, natural language processing, audio recognition, social network filtering, machine translation, bioinformatics, and drug design.

Inference and training, two tools used for deep learning, may utilize low precision arithmetic. Maximizing throughput of deep learning algorithms and computations may assist in meeting the needs of deep learning processors, for example, those performing deep learning in a data center.

Matrix-matrix multiplication (a.k.a., GEMM or General Matrix Multiplication) is a compute-heavy operation on certain processors. Special hardware for matrix multiplication (e.g., GEMM) is a good option for improving the peak compute (and energy efficiency) of certain applications, such as deep learning. Some of these applications, including deep learning, can operate on input data elements with relatively few bits without losing accuracy, as long as the output elements have enough bits (e.g., more than the inputs).

In certain processors, handling matrices is a difficult and/or instruction intensive task. For example, rows of a matrix could be put into a plurality of packed data (e.g., SIMD or vector) registers and then operated on individually. For example, an add two 8×2 (e.g., row by column) matrices may require a load or gather into four packed data registers depending upon data sizes. Then a first add of packed data registers corresponding to a first row from each matrix is performed and a second add of packed data registers corresponding to a second row from each matrix is performed. Then the resulting packed data registers are scattered back to memory. While for small matrices this scenario may be acceptable, it is often not acceptable with larger matrices.

### DISCUSSION

Described herein are mechanisms to support matrix operations in computer hardware such as central processing units (CPUs), graphic processing units (GPUs), and accelerators. The matrix operations utilize 2-dimensional (2-D) data structures representing one or more packed regions of memory such as registers. Throughout this description, these 2-D data structures are referred to as tiles. Note that a matrix may be smaller than a tile (use less than all of a tile) or utilize a plurality of tiles (the matrix is larger than the size of any one tile). Throughout the description, matrix (tile) language is used to indicate operations performed using tiles that impact a matrix; whether or not that matrix is larger than any one tile is not typically relevant.

Each tile may be acted upon by different operations such as those that are detailed herein and include, but are not limited to: matrix (tile) multiplication, tile add, tile subtract, tile diagonal, tile zero, tile transform, tile dot product, tile broadcast, tile row broadcast, tile column broadcast, tile multiplication, tile multiplication and accumulation, tile move, etc. Additionally, support for operators such as the use of a scale and/or bias may be used with these operations or in support of non-numeric applications in the future, for instance, OpenCL “local memory,” data compression/decompression, etc. Also described herein are instructions for performing matrix operation (e.g., TILEPARTIALDOTPRODUCT) instructions.

Portions of storage (such as memory (non-volatile and volatile), registers, cache, etc.) are arranged into tiles of different horizontal and vertical dimensions. For example, a tile may have horizontal dimension of 4 (e.g., four rows of a matrix) and a vertical dimension of 8 (e.g., 8 columns of the matrix). Typically, the horizontal dimension is related to element sizes (e.g., 2-, 4-, 8-, 16-, 32-, 64-, 128-bit, etc.). Multiple datatypes (single precision floating point, double precision floating point, integer, etc.) may be supported.

### Exemplary Usage of Configured Tiles

In some examples, tile parameters can be configured. For example, a given tile may be configured to provide tile options. Exemplary tile options include but are not limited to: a number of rows of the tile, a number of columns of the tile, whether the tile is VALID, and whether the tile consists of a PAIR of equal-sized tiles.

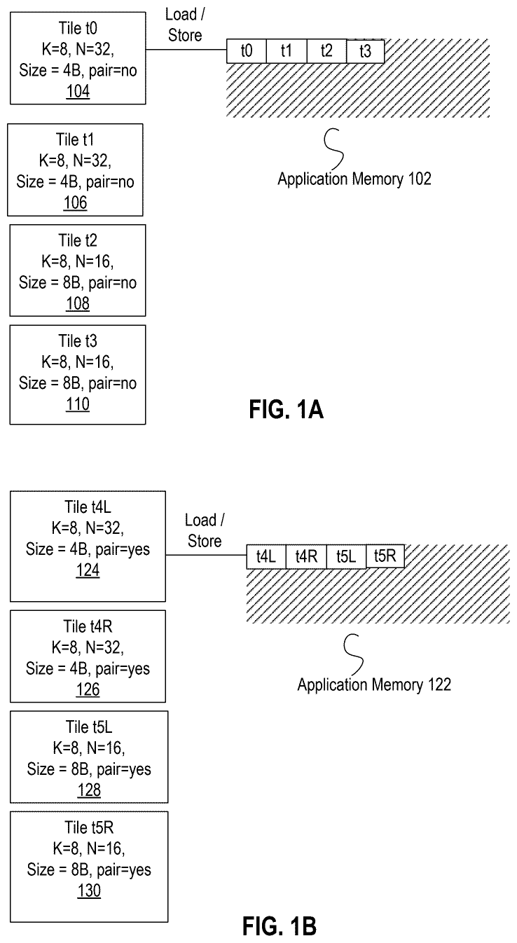

FIG. 1A illustrates an example of configured tiles. As shown, 4 KB of application memory 102 have stored thereon 4 1 kB titles, tile t0 104, tile t1 106, tile t2 108, and tile t3 110. In this example, the 4 tiles do not consist of pairs, and each have elements arranged in rows and columns. Tile t0 104 and tile t1 106 have K rows and N columns of 4-byte elements (e.g., single precision data), where K equals 8 and N=32. Tile t2 108 and tile t3 110 have K rows and N/2 columns of 8-byte elements (e.g., double precision data). As the double precision operands are twice the width of single precision, this configuration is consistent with a palette, used to provide tile options, supplying at least 4 names with total storage of at least 4 kB. In operation, the tiles can be loaded from and stored to memory using load and store operations. Depending upon the instruction encoding scheme used, the amount of available application memory, as well as the size, number, and configuration of available tiles varies.

FIG. 1B illustrates an example of configured tiles. As shown, 4 KB of application memory 122 have stored thereon 2 pairs of 1 kB-titles, the first pair being tile t4L 124 and tile t4R 126, and the second pair being tile t5L 128 and tile t5R 130. As shown the pairs of tiles are divided into a left tile and a right tile. In other examples, the pair of tiles are divided into an even tile and an odd tile. In this example, the 4 tiles each have elements arranged in rows and columns. Tile t4L 124 and tile t4R 126 have K rows and N columns of 4-byte elements (e.g., single precision floating point data), where K equals 8 and N equals 32. Tile t5L 128 and tile t5R 130 have K rows and N/2 columns of 8-byte elements (e.g., double precision floating point data). As the double precision operands are twice the width of single precision, this configuration is consistent with a palette, used to provide tile options, supplying at least 2 names with total storage of at least 4 kB. The four tiles of FIG. 1A use 4 names, each naming a 1 kB tile, whereas the 2 pairs of tiles in FIG. 1B can use 2 names to specify the paired tiles. In some examples, tile instructions accept a name of a paired tile as an operand. In operation, the tiles can be loaded from and stored to memory using load and store operations. Depending upon the instruction encoding scheme used, the amount of available application memory, as well as the size, number, and configuration of available tiles varies.

In some examples, tile parameters are definable. For example, a “palette” is used to provide tile options. Exemplary options include, but are not limited to: the number of tile names, the number of bytes in a row of storage, the number of rows and columns in a tile, etc. For example, a maximum “height” (number of rows) of a tile may be defined as:
Tile Max Rows=Architected Storage/(The Number of Palette Names*The Number of Bytes per row).

As such, an application can be written such that a fixed usage of names will be able to take advantage of different storage sizes across implementations.

Configuration of tiles is done using a tile configuration (“TILECONFIG”) instruction, where a particular tile usage is defined in a selected palette. This declaration includes the number of tile names to be used, the requested number of rows and columns per name (tile), and, in some examples, the requested datatype of each tile. In some examples, consistency checks are performed during the execution of a TILECONFIG instruction to determine that it matches the restrictions of the palette entry.

### Exemplary Tile Storage Types

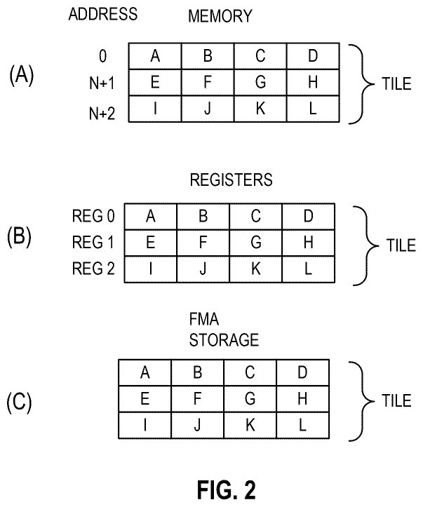

FIG. 2 illustrates several examples of matrix storage. In (A), a tile is stored in memory. As shown, each “row” consists of four packed data elements. To get to the next “row,” a stride value is used. Note that rows may be consecutively stored in memory. Strided memory accesses allows for access of one row to then next when the tile storage does not map the underlying memory array row width.

Tile loads from memory and stores to memory are typically strided accesses from the application memory to packed rows of data. Exemplary TILELOAD and TILESTORE instructions, or other instruction references to application memory as a TILE operand in load-op instructions, are, in some examples, restartable to handle (up to) 2*rows of page faults, unmasked floating point exceptions, and/or interrupts per instruction.

In (B), a matrix is stored in a tile comprised of a plurality of registers such as packed data registers (single instruction, multiple data (SIMD) or vector registers). In this example, the tile is overlaid on three physical registers. Typically, consecutive registers are used, however, this need not be the case.

In (C), a matrix is stored in a tile in non-register storage accessible to a fused multiply accumulate (FMA) circuit used in tile operations. This storage may be inside of a FMA, or adjacent to it. Additionally, in some examples, discussed below, the storage may be for a data element and not an entire row or tile.

The supported parameters for the TMMA architecture are reported via CPUID. In some examples, the list of information includes a maximum height and a maximum SIMD dimension. Configuring the TMMA architecture requires specifying the dimensions for each tile, the element size for each tile and the palette identifier. This configuration is done by executing the TILECONFIG instruction.

Successful execution of a TILECONFIG instruction enables subsequent TILE operators. A TILERELEASEALL instruction clears the tile configuration and disables the TILE operations (until the next TILECONFIG instructions executes). In some examples, XSAVE, XSTORE, etc. are used in context switching using tiles. In some examples, 2 XCRO bits are used in XSAVE, one for TILECONFIG metadata and one bit corresponding to actual tile payload data.

TILECONFIG not only configures the tile usage, but also sets a state variable indicating that the program is in a region of code with tiles configured. An implementation may enumerate restrictions on other instructions that can be used with a tile region such as no usage of an existing register set, etc.

Exiting a tile region is typically done with the TILERELEASEALL instruction. It takes no parameters and swiftly invalidates all tiles (indicating that the data no longer needs any saving or restoring) and clears the internal state corresponding to being in a tile region.

In some examples, tile operations will zero any rows and any columns beyond the dimensions specified by the tile configuration. For example, tile operations will zero the data beyond the configured number of columns (factoring in the size of the elements) as each row is written. For example, with 64-byte rows and a tile configured with 10 rows and 12 columns, an operation writing FP32 elements would write each of the first 10 rows with 12*4 bytes with output/result data and zero the remaining 4*4 bytes in each row. Tile operations also fully zero any rows after the first 10 configured rows. When using 1K tile with 64-byte rows, there would be 16 rows, so in this example, the last 6 rows would also be zeroed.

In some examples, a context restore instruction (e.g., XRSTOR), when loading data, enforces that the data beyond the configured rows for a tile will be maintained as zero. If there is no valid configuration, all rows are zeroed. XRSTOR of tile data can load garbage in the columns beyond those configured. It should not be possible for XRSTOR to clear beyond the number of columns configured because there is not an element width associated with the tile configuration.

Context save (e.g., XSAVE) exposes the entire TILE storage area when writing it to memory. If XRSTOR loaded garbage data into the rightmost part of a tile, that data will be saved by XSAVE. XSAVE will write zeros for rows beyond the number specified for each tile.

In some examples, tile instructions are restartable. The operations that access memory allow restart after page faults. The computational instructions that deal with floating point operations also allow for unmasked floating-point exceptions, with the masking of the exceptions controlled by a control and/or status register.

To support restarting instructions after these events, the instructions store information in the start registers detailed below.

### Matrix (Tile) Operation Systems

### Exemplary Hardware Support

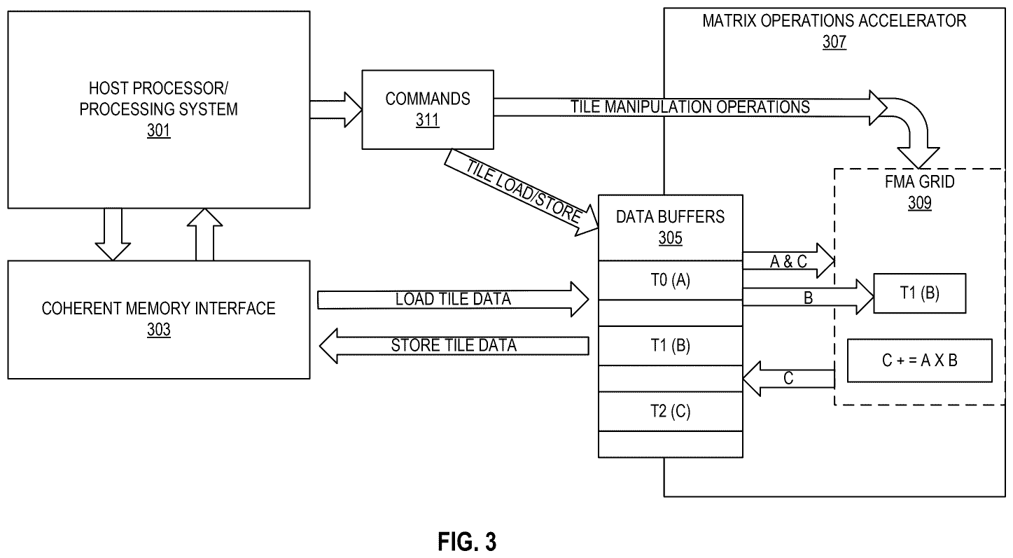

FIG. 3 illustrates an example of a system utilizing a matrix (tile) operations accelerator. In this illustration, a host processor/processing system 301 communicates commands 311 (e.g., matrix manipulation operations such as arithmetic or matrix manipulation operations, or load and store operations) to a matrix operations accelerator 307. However, this is shown this way for discussion purposes only. As detailed later, this accelerator 307 may be a part of a processing core. Typically, commands 311 that are tile manipulation operator instructions will refer to tiles as register-register (“reg-reg”) or register-memory (“reg-mem”) format. Other commands such as TILESTORE, TILELOAD, TILECONFIG, etc., do not perform data operations on a tile. Commands may be decoded instructions (e.g., micro-ops) or macro-instructions for the accelerator 307 to handle.

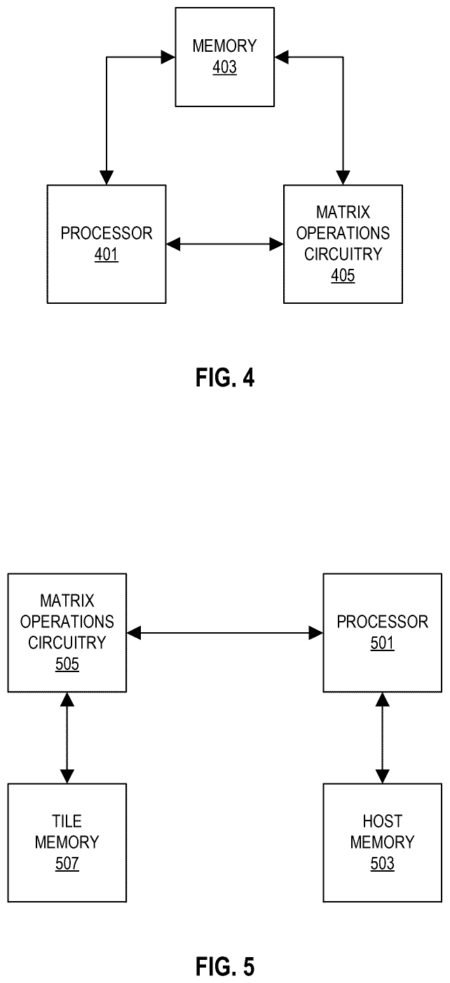

In this example, a coherent memory interface 303 is coupled to the host processor/processing system 301 and matrix operations accelerator 307 such that they can share memory. FIGS. 4 and 5 show different examples of how memory is shared using a matrix operations accelerator. As shown in FIG. 4, the host processor 401 and matrix operations accelerator circuitry 405 share the same memory 403. FIG. 5 illustrates an example where the host processor 501 and matrix operations accelerator 505 do not share memory but can access each other's memory. For example, processor 501 can access tile memory 507 and utilize its host memory 503 as normal. Similarly, the matrix operations accelerator 505 can access host memory 503, but more typically uses its own memory 507. Note these memories may be of different types.

In some examples, tiles are supported using an overlay over physical registers. For example, a tile may utilize 16 1,024-bit registers, 32 512-bit registers, etc. depending on the implementation. In some examples, the matrix operations utilize 2-dimensional (2-D) data structures representing one or more packed regions of memory such as registers. Throughout this description, these 2-D data structures are referred to as tiles or tile registers.

In some examples, the matrix operations accelerator 307 includes a plurality of FMAs 309 coupled to data buffers 305 (in some implementations, one or more of these buffers 305 are stored in the FMAs of the grid as shown). The data buffers 305 buffer tiles loaded from memory and/or tiles to be stored to memory (e.g., using a tileload or tilestore instruction). Data buffers may be, for example, a plurality of registers. Typically, these FMAs are arranged as a grid of chained FMAs 309 which are able to read and write tiles. In this example, the matrix operations accelerator 307 is to perform a matrix multiply operation using tiles T0, T1, and T2. At least one of tiles is housed in the FMA grid 309. In some examples, all tiles in an operation are stored in the FMA grid 309. In other examples, only a subset is stored in the FMA grid 309. As shown, T1 is housed and T0 and T2 are not. Note that A, B, and C refer to the matrices of these tiles which may or may not take up the entire space of the tile.

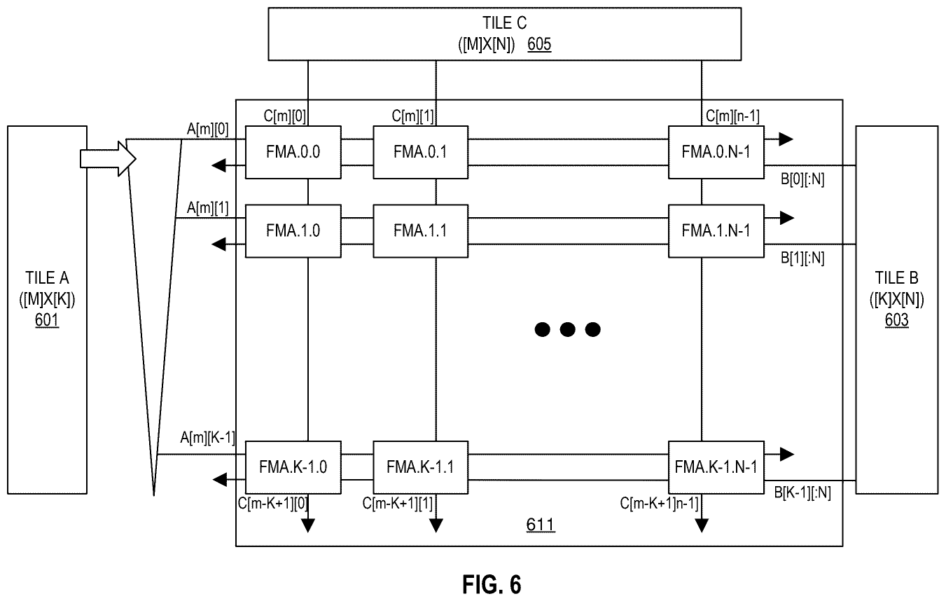

FIG. 6 illustrates an example of matrix multiply accumulate operation using tiles (“TMMA”).

The number of rows in the matrix (TILE A 601) matches the number of serial (chained) FMAs comprising the computation's latency in certain examples. An implementation is free to recirculate on a grid of smaller height, but the computation remains the same.

The source/destination vector comes from a tile of N rows (TILE C 605) and the grid of FMAs 611 performs N vector-matrix operations resulting in a complete instruction performing a matrix multiplication of tiles. Tile B 603 is the other vector source and supplies “broadcast” terms to the FMAs in each stage.

In operation, in some examples, the elements of matrix B (stored in a tile B 603) are spread across the rectangular grid of FMAs. Matrix B (stored in tile A 601) has its elements of a row transformed to match up with the columnar dimension of the rectangular grid of FMAs. At each FMA in the grid, an element of A and B are multiplied and added to the incoming summand (from above in the FIG.) and the outgoing sum is passed to the next row of FMAs (or the final output).

The latency of a single step is proportional to K (row height of matrix B) and dependent TMMAs typically have enough source-destination rows (either in a single tile or across tile) to hide that latency. An implementation may also split the SIMD (packed data element) dimension M (row height of matrix A) across time steps, but this simply changes the constant that K is multiplied by. When a program specifies a smaller K than the maximum enumerated by the TMMA, an implementation is free to implement this with “masking” or “early outs.”

The latency of an entire TMMA is proportional to N*K. The repeat rate is proportional to N. The number of MACs per TMMA instruction is N*K*M.

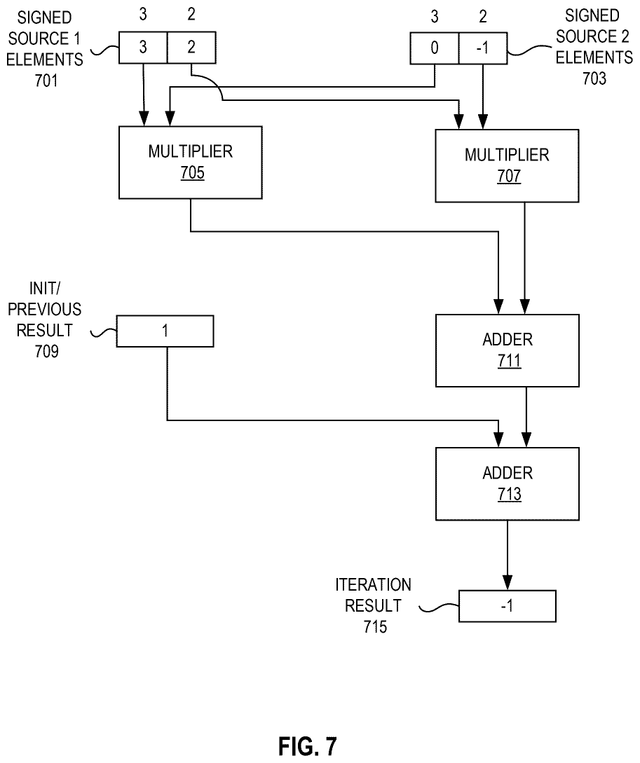

FIG. 7 illustrates an example of a subset of the execution of an iteration of a chained fused multiply accumulate instruction. In particular, this illustrates execution circuitry of an iteration of one packed data element position of the destination. In this example, the chained fused multiply accumulate is operating on signed sources wherein the accumulator is 2× the input data size.

A first signed source (source 1 701) and a second signed source (source 2 703) each have four packed data elements. Each of these packed data elements stores signed data such as floating-point data. A third signed source (source 3 709) has two packed data elements, each of which stores signed data. The sizes of the first and second signed sources 701 and 703 are half that of the third signed source (initial value or previous result) 709. For example, the first and second signed sources 701 and 703 could have 32-bit packed data elements (e.g., single precision floating point) while the third signed source 709 could have 64-bit packed data elements (e.g., double precision floating point).

In this illustration, only the two most significant packed data element positions of the first and second signed sources 701 and 703 and the most significant packed data element position of the third signed source 709 are shown. Of course, the other packed data element positions would also be processed.

As illustrated, packed data elements are processed in pairs. For example, the data of the most significant packed data element positions of the first and second signed sources 701 and 703 are multiplied using a multiplier circuit 705, and the data from second most significant packed data element positions of the first and second signed sources 701 and 703 are multiplied using a multiplier circuit 707. In some examples, these multiplier circuits 705 and 707 are reused for other packed data elements positions. In other examples, additional multiplier circuits are used so that the packed data elements are processed in parallel. In some contexts, parallel execution is done using lanes that are the size of the signed third source 709. The results of each of the multiplications are added using addition circuitry 711.

The result of the addition of the results of the multiplications is added to the data from most significant packed data element position of the signed source 3 709 (using a different adder 713 or the same adder 711).

Finally, the result of the second addition is either stored into the signed destination 715 in a packed data element position that corresponds to the packed data element position used from the signed third source 709 or passed on to the next iteration if there is one. In some examples, a writemask is applied to this storage such that if a corresponding writemask (bit) is set, the storage happens, and, if not set, the storage does not happen.

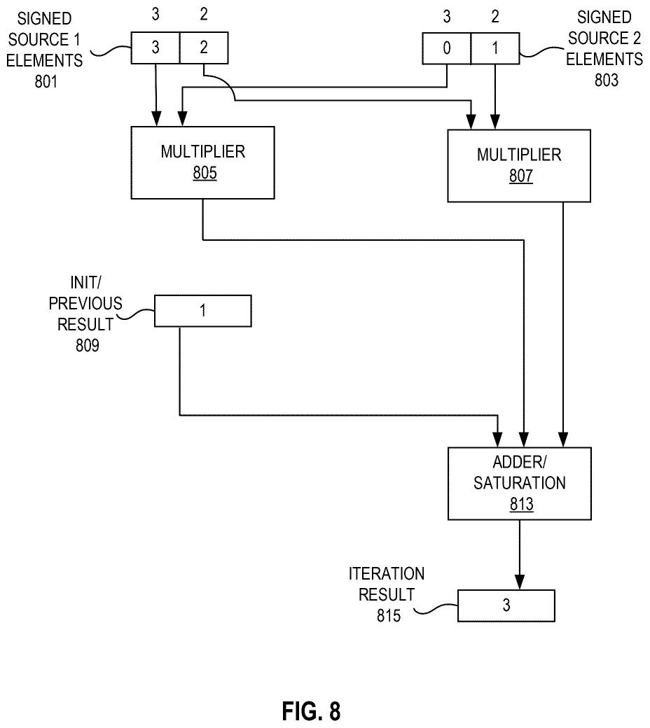

FIG. 8 illustrates an example of a subset of the execution of an iteration of a chained fused multiply accumulate instruction. In particular, this illustrates execution circuitry of an iteration of one packed data element position of the destination. In this example, the chained fused multiply accumulate is operating on signed sources wherein the accumulator is 2× the input data size.

A first signed source (source 1 801) and a second signed source (source 2 803) each have four packed data elements. Each of these packed data elements stores signed data such as integer data. A third signed source (source 3 809) has two packed data elements, each of which stores signed data. The sizes of the first and second signed sources 801 and 803 are half that of the third signed source 809. For example, the first and second signed sources 801 and 803 could have 32-bit packed data elements (e.g., single precision floating point) the third signed source 809 could have 64-bit packed data elements (e.g., double precision floating point).

In this illustration, only the two most significant packed data element positions of the first and second signed sources 801 and 803 and the most significant packed data element position of the third signed source 809 are shown. Of course, the other packed data element positions would also be processed.

As illustrated, packed data elements are processed in pairs. For example, the data of the most significant packed data element positions of the first and second signed sources 801 and 803 are multiplied using a multiplier circuit 805, and the data from second most significant packed data element positions of the first and second signed sources 801 and 803 are multiplied using a multiplier circuit 807. In some examples, these multiplier circuits 805 and 807 are reused for other packed data elements positions. In other examples, additional multiplier circuits are used so that the packed data elements are processed in parallel. In some contexts, parallel execution is done using lanes that are the size of the signed third source (initial value or previous iteration result) 809. The results of each of the multiplications are added to the signed third source 809 using addition/saturation circuitry 813.

Addition/saturation (accumulator) circuitry 813 preserves a sign of an operand when the addition results in a value that is too big. In particular, saturation evaluation occurs on the infinite precision result between the multi-way-add and the write to the destination or next iteration. When the accumulator 813 is floating point and the input terms are integer, the sum of products and the floating-point accumulator input value are turned into infinite precision values (fixed-point numbers of hundreds of bits), the addition of the multiplication results and the third input is performed, and a single rounding to the actual accumulator type is performed.

Unsigned saturation means the output values are limited to a maximum unsigned number for that element width (all 1s). Signed saturation means a value is limited to the be in the range between a minimum negative number and a max positive number for that element width (for bytes for example, the range is from −128 (=−2\hat{ }7) to 127 (=2\hat{ }7−1)).

The result of the addition and saturation check is stored into the signed result 815 in a packed data element position that corresponds to the packed data element position used from the signed third source 809 or passed on to the next iteration if there is one. In some examples, a writemask is applied to this storage such that if a corresponding writemask (bit) is set, the storage happens, and, if not set, the storage does not happen.

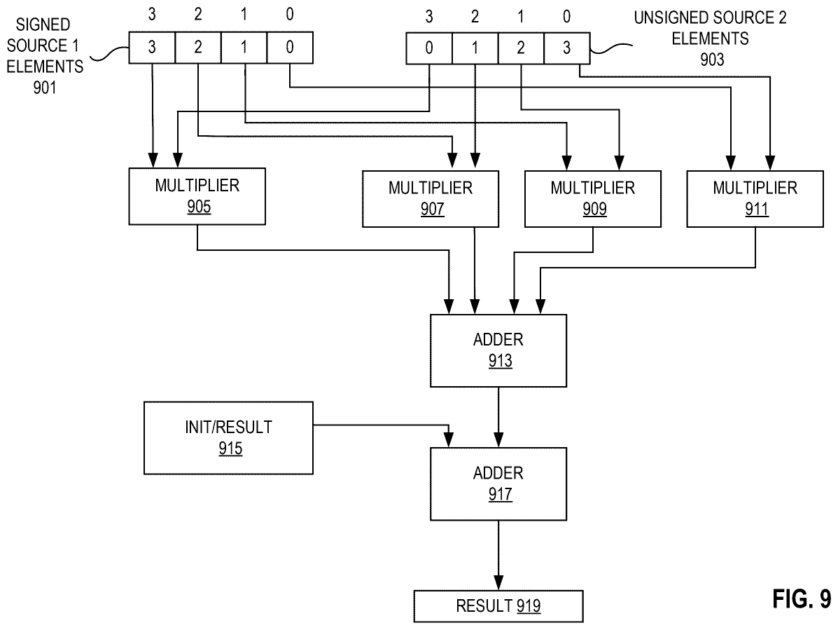

FIG. 9 illustrates an example of a subset of the execution of an iteration of a chained fused multiply accumulate instruction. In particular, this illustrates execution circuitry of an iteration of one packed data element position of the destination. In this example, the chained fused multiply accumulate is operating on a signed source and an unsigned source wherein the accumulator is 4× the input data size.

A first signed source (source 1 901) and a second unsigned source (source 2 903) each have four packed data elements. Each of these packed data elements has data such as floating point or integer data. A third signed source (initial value or result 915) has a packed data element of which stores signed data. The sizes of the first and second sources 901 and 903 are a quarter of the third signed source 915. For example, the first and second sources 901 and 903 could have 16-bit packed data elements (e.g., word) and the third signed source 915 could have 64-bit packed data elements (e.g., double precision floating point or 64-bit integer).

In this illustration, the four most significant packed data element positions of the first and second sources 901 and 903 and the most significant packed data element position of the third signed source 915 are shown. Of course, other packed data element positions would also be processed if there are any.

As illustrated, packed data elements are processed in quadruplets. For example, the data of the most significant packed data element positions of the first and second sources 901 and 903 are multiplied using a multiplier circuit 905, data from second most significant packed data element positions of the first and second sources 901 and 903 are multiplied using a multiplier circuit 907, data from third most significant packed data element positions of the first and second sources 901 and 903 are multiplied using a multiplier circuit 909, and data from the least significant packed data element positions of the first and second sources 901 and 903 are multiplied using a multiplier circuit 911. In some examples, the signed packed data elements of the first source 901 are sign extended and the unsigned packed data elements of the second source 903 are zero extended prior to the multiplications.

In some examples, these multiplier circuits 905-911 are reused for other packed data elements positions. In other examples, additional multiplier circuits are used so that the packed data elements are processed in parallel. In some contexts, parallel execution is done using lanes that are the size of the signed third source 915. The results of each of the multiplications are added using addition circuitry 913.

The result of the addition of the results of the multiplications is added to the data from most significant packed data element position of the signed source 3 915 (using a different adder 917 or the same adder 913).

Finally, the result 919 of the second addition is either stored into the signed destination in a packed data element position that corresponds to the packed data element position used from the signed third source 915 or passed to the next iteration. In some examples, a writemask is applied to this storage such that if a corresponding writemask (bit) is set, the storage happens, and, if not set, the storage does not happen.

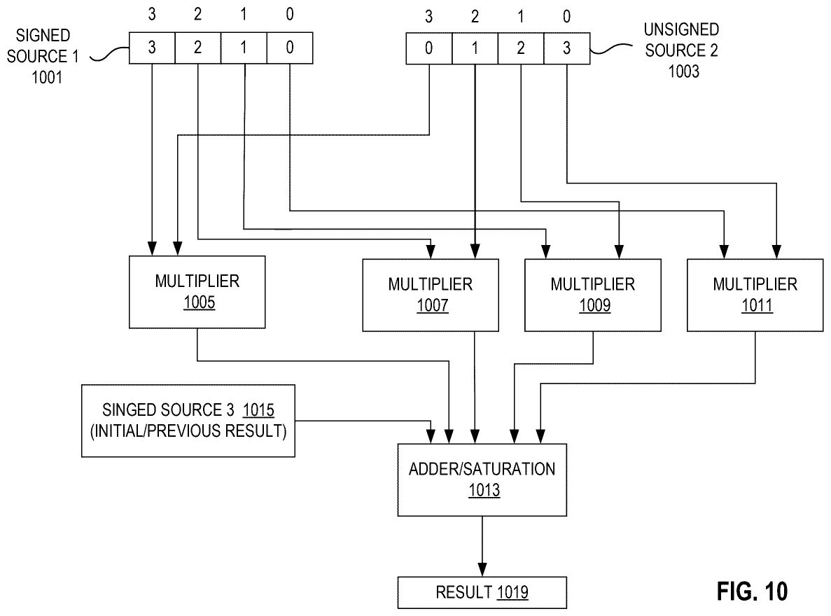

FIG. 10 illustrates an example of a subset of the execution of an iteration of chained fused multiply accumulate instruction. In particular, this illustrates execution circuitry of an iteration of one packed data element position of the destination. In this example, the chained fused multiply accumulate is operating on a signed source and an unsigned source wherein the accumulator is 4× the input data size.

A first signed source 1001 and a second unsigned source 1003 each have four packed data elements. Each of these packed data elements stores data such as floating point or integer data. A third signed source 1015 (initial or previous result) has a packed data element of which stores signed data. The sizes of the first and second sources are a quarter of the third signed source 1015 (initial or previous result). For example, the first and second sources could have 16-bit packed data elements (e.g., word) and the third signed source 1015 (initial or previous result) could have 64-bit packed data elements (e.g., double precision floating point or 64-bit integer).

In this illustration, the four most significant packed data element positions of the first signed source 1001 and the second unsigned source 1003 and the most significant packed data element position of the third signed source 1015 are shown. Of course, other packed data element positions would also be processed if there are any.

As illustrated, packed data elements are processed in quadruplets. For example, the data of the most significant packed data element positions of the first signed source 1001 and the second unsigned source 1003 are multiplied using a multiplier circuit 1005, data from second most significant packed data element positions of the first signed source 1001 and the second unsigned source 1003 are multiplied using a multiplier circuit 1007, data from third most significant packed data element positions of the first signed source 1001 and the second unsigned source 1003 are multiplied using a multiplier circuit 1009, and data from the least significant packed data element positions of the first signed source 1001 and the second unsigned source 1003 are multiplied using a multiplier circuit 1011. In some examples, the signed packed data elements of the first signed source 1001 are sign extended and the unsigned packed data elements of the second unsigned source 1003 are zero extended prior to the multiplications.

In some examples, these multiplier circuits 1005-1011 are reused for other packed data elements positions. In other examples, additional multiplier circuits are used so that the packed data elements are processed in parallel. In some contexts, parallel execution is done using lanes that are the size of third signed source 1015 (initial or previous result). The result of the addition of the results of the multiplications is added to the data from most significant packed data element position of third signed source 1015 (initial or previous result) using adder/saturation 1013 circuitry.

Addition/saturation (accumulator) circuitry 1013 preserves a sign of an operand when the addition results in a value that is too big or too small for signed saturation. In particular, saturation evaluation occurs on the infinite precision result between the multi-way-add and the write to the destination. When the accumulator 1013 is floating point and the input terms are integer, the sum of products and the floating-point accumulator input value are turned into infinite precision values (fixed-point numbers of hundreds of bits), the addition of the multiplication results and the third input is performed, and a single rounding to the actual accumulator type is performed.

The result 1019 of the addition and saturation check is stored into the signed destination in a packed data element position that corresponds to the packed data element position used from third signed source 1015 (initial or previous result) or passed to the next iteration. In some examples, a writemask is applied to this storage such that if a corresponding writemask (bit) is set, the storage happens, and, if not set, the storage does not happen.

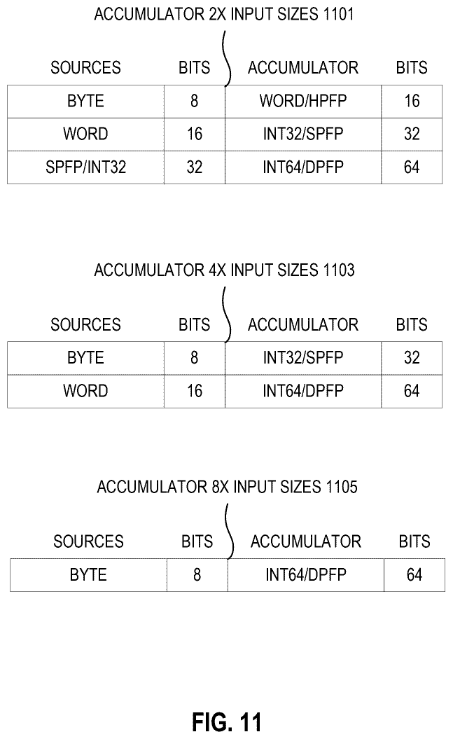

FIG. 11 illustrates power-of-two sized SIMD implementations wherein the accumulators use input sizes that are larger than the inputs to the multipliers according to an example. Note the source (to the multipliers) and accumulator values may be signed or unsigned values. For an accumulator having 2× input sizes (in other words, the accumulator input value is twice the size of the packed data element sizes of the sources), table 1101 illustrates different configurations. For byte sized sources, the accumulator uses word or half-precision floating-point (HPFP) values that are 16-bit in size. For word sized sources, the accumulator uses 32-bit integer or single-precision floating-point (SPFP) values that are 32-bit in size. For SPFP or 32-bit integer sized sources, the accumulator uses 64-integer or double-precision floating-point (DPFP) values that are 64-bit in size.

For an accumulator having 4× input sizes (in other words, the accumulator input value is four times the size of the packed data element sizes of the sources), table 1103 illustrates different configurations. For byte sized sources, the accumulator uses 32-bit integer or single-precision floating-point (SPFP) values that are 32-bit in size. For word sized sources, the accumulator uses 64-bit integer or double-precision floating-point (DPFP) values that are 64-bit in size in some examples.

For an accumulator having 8× input sizes (in other words, the accumulator input value is eight times the size of the packed data element sizes of the sources), table 1105 illustrates a configuration. For byte sized sources, the accumulator uses 64-bit integer.

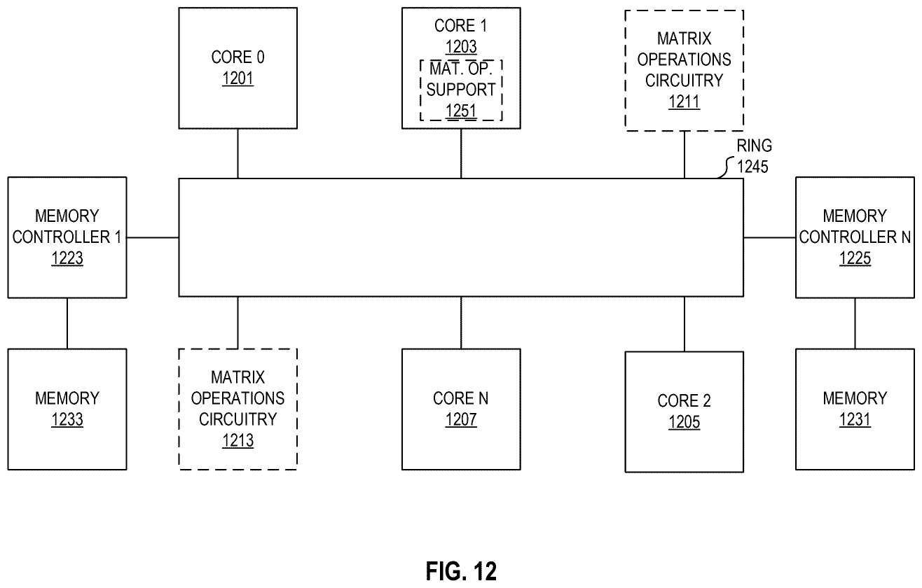

As hinted at earlier, matrix operations circuitry may be included in a core, or as an external accelerator. FIG. 12 illustrates an example of a system utilizing matrix operations circuitry. In this illustration, multiple entities are coupled with a ring interconnect 1245.

A plurality of cores, core 0 1201, core 1 1203, core 2 1205, and core N 1207 provide non-tile-based instruction support. In some examples, matrix operations circuitry 1251 is provided in a core 1203, and in other examples matrix operations circuitries 1211 and 1213 are accessible on the ring interconnect 1245.

Additionally, one or more memory controllers 1223-1225 are provided to communicate with memory 1233 and 1231 on behalf of the cores and/or matrix operations circuitry.

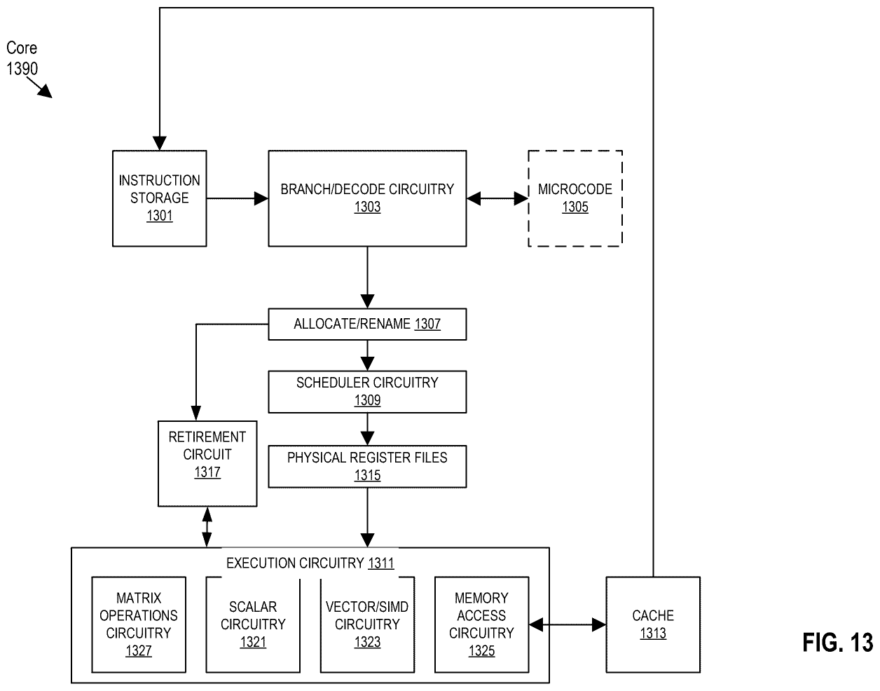

FIG. 13 illustrates an example of a processor core pipeline supporting matrix operations using tiles. Branch prediction and decode circuitry 1303 performs branch predicting of instructions, decoding of instructions, and/or both from instructions stored in instruction storage 1301. For example, instructions detailed herein may be stored in instruction storage. In some implementations, separate circuitry is used for branch prediction and in some examples, at least some instructions are decoded into one or more micro-operations, micro-code entry points, microinstructions, other instructions, or other control signals using microcode 1305. The branch prediction and decode circuitry 1303 may be implemented using various different mechanisms. Examples of suitable mechanisms include, but are not limited to, look-up tables, hardware implementations, programmable logic arrays (PLAs), microcode read only memories (ROMs), etc.

The branch prediction and decode circuitry 1303 is coupled to allocate/rename 1307 circuitry which is coupled, in some examples, to scheduler circuitry 1309. In some examples, these circuits provide register renaming, register allocation, and/or scheduling functionality by performing one or more of: 1) renaming logical operand values to physical operand values (e.g., a register alias table in some examples), 2) allocating status bits and flags to the decoded instruction, and 3) scheduling the decoded instruction for execution on execution circuitry out of an instruction pool (e.g., using a reservation station in some examples).

The scheduler circuitry 1309 represents any number of different schedulers, including reservations stations, central instruction window, etc. The scheduler circuitry 1309 is coupled to, or includes, physical register file(s) 1315. Each of the physical register file(s) 1315 represents one or more physical register files, different ones of which store one or more different data types, such as scalar integer, scalar floating point, packed integer, packed floating point, vector integer, vector floating point, status (e.g., an instruction pointer that is the address of the next instruction to be executed), tiles, etc. In one example, the physical register file(s) 1315 comprises vector registers circuitry, write mask registers circuitry, and scalar registers circuitry. These register circuits may provide architectural vector registers, vector mask registers, and general-purpose registers. The physical register file(s) 1315 is overlapped by a retirement circuit 1317 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement circuit 1317 and the physical register file(s) 1315 are coupled to the execution circuitry 1311.

While register renaming is described in the context of out-of-order execution, it should be understood that register renaming may be used in an in-order architecture. While the illustrated example of the processor may also include separate instruction and data cache units and a shared L2 cache unit, alternative examples may have a single internal cache for both instructions and data, such as, for example, a Level 1 (L1) internal cache, or multiple levels of internal cache. In some examples, the system may include a combination of an internal cache and an external cache that is external to the core and/or the processor. Alternatively, all of the cache may be external to the core and/or the processor.

The execution circuitry 1311 is a set of one or more execution circuits, including scalar circuitry 1321, vector/SIMD circuitry 1323, and matrix operations circuitry 1327, as well as memory access circuitry 1325 to access cache 1313. The execution circuits perform various operations (e.g., shifts, addition, subtraction, multiplication) and on various types of data (e.g., scalar floating point, packed integer, packed floating point, vector integer, vector floating point). While some examples may include a number of execution units dedicated to specific functions or sets of functions, other examples may include only one execution unit or multiple execution units that all perform all functions. The scalar circuitry 1321 performs scalar operations, the vector/SIMD circuitry 1323 performs vector/SIMD operations, and matrix operations circuitry 1327 performs matrix (tile) operations detailed herein.

By way of example, the exemplary register renaming, out-of-order issue/execution core architecture may implement a pipeline as follows: 1) an instruction fetch circuit performs fetch and length decoding stages; 2) the branch and decode circuitry 1303 performs a decode stage; 3) the allocate/rename 1307 circuitry performs an allocation stage and renaming stage; 4) the scheduler circuitry 1309 performs a schedule stage; 5) physical register file(s) (coupled to, or included in, the scheduler circuitry 1309 and allocate/rename 1307 circuitry and a memory unit perform a register read/memory read stage; the execution circuitry 1311 performs an execute stage; 6) a memory unit and the physical register file(s) unit(s) perform a write back/memory write stage; 7) various units may be involved in the exception handling stage; and 8) a retirement unit and the physical register file(s) unit(s) perform a commit stage.

The core may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one example, the core 1390 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

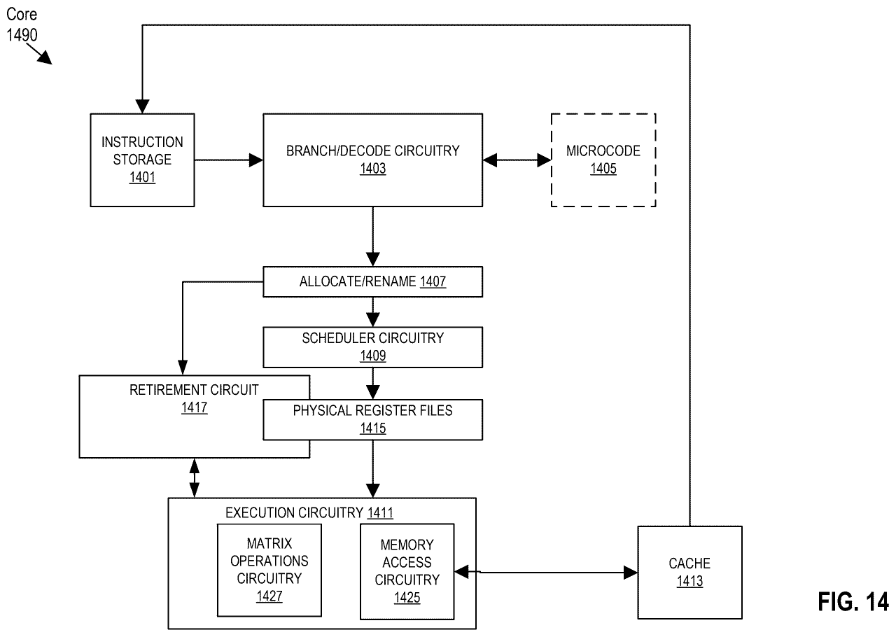

FIG. 14 illustrates an example of a processor core pipeline supporting matrix operations using tiles. Branch prediction and decode circuitry 1403 performs branch predicting of instructions, decoding of instructions, and/or both from instructions stored in instruction storage 1401. For example, instructions detailed herein may be stored in instruction storage. In some implementations, separate circuitry is used for branch prediction and in some examples, at least some instructions are decoded into one or more micro-operations, micro-code entry points, microinstructions, other instructions, or other control signals using microcode 1405. The branch prediction and decode circuitry 1403 may be implemented using various different mechanisms. Examples of suitable mechanisms include, but are not limited to, look-up tables, hardware implementations, programmable logic arrays (PLAs), microcode read only memories (ROMs), etc.

The branch prediction and decode circuitry 1403 is coupled to allocate/rename 1407 circuitry which is coupled, in some examples, to scheduler circuitry 1409. In some examples, these circuits provide register renaming, register allocation, and/or scheduling functionality by performing one or more of: 1) renaming logical operand values to physical operand values (e.g., a register alias table in some examples), 2) allocating status bits and flags to the decoded instruction, and 3) scheduling the decoded instruction for execution on execution circuitry out of an instruction pool (e.g., using a reservation station in some examples).

The scheduler circuitry 1409 represents any number of different schedulers, including reservations stations, central instruction window, etc. The scheduler unit(s) scheduler circuitry 1409 is coupled to, or includes, physical register file(s) 1415. Each of the physical register file(s) 1415 represents one or more physical register files, different ones of which store one or more different data types, such as scalar integer, scalar floating point, packed integer, packed floating point, vector integer, vector floating point, status (e.g., an instruction pointer that is the address of the next instruction to be executed), tiles, etc. In one example, the physical register file(s) 1415 comprises vector registers circuitry, write mask registers circuitry, and scalar registers circuitry. These register circuits may provide architectural vector registers, vector mask registers, and general-purpose registers. The physical register file(s) 1415 is overlapped by a retirement circuit 1417 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement circuit 1417 and the physical register file(s) 1415 are coupled to the execution circuitry 1411.

While register renaming is described in the context of out-of-order execution, it should be understood that register renaming may be used in an in-order architecture. While the illustrated example of the processor may also include separate instruction and data cache units and a shared L2 cache unit, alternative examples may have a single internal cache for both instructions and data, such as, for example, a Level 1 (L1) internal cache, or multiple levels of internal cache. In some examples, the system may include a combination of an internal cache and an external cache that is external to the core and/or the processor. Alternatively, all of the cache may be external to the core and/or the processor.

The execution circuitry 1411 a set of one or more execution circuits 1427 and a set of one or more memory access circuits 1425 to access cache 1413. The execution circuits 1427 perform matrix (tile) operations detailed herein.

By way of example, the exemplary register renaming, out-of-order issue/execution core architecture may implement a pipeline as follows: 1) an instruction fetch circuit performs fetch and length decoding stages; 2) the branch and decode circuitry 1403 performs a decode stage; 3) the allocate/rename 1407 circuitry performs an allocation stage and renaming stage; 4) the scheduler circuitry 1409 performs a schedule stage; 5) physical register file(s) (coupled to, or included in, the scheduler circuitry 1409 and allocate/rename 1407 circuitry and a memory unit perform a register read/memory read stage; the execution circuitry 1411 performs an execute stage; 6) a memory unit and the physical register file(s) unit(s) perform a write back/memory write stage; 7) various units may be involved in the exception handling stage; and 8) a retirement unit and the physical register file(s) unit(s) perform a commit stage.

The core may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one example, the core 1490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

### Layout

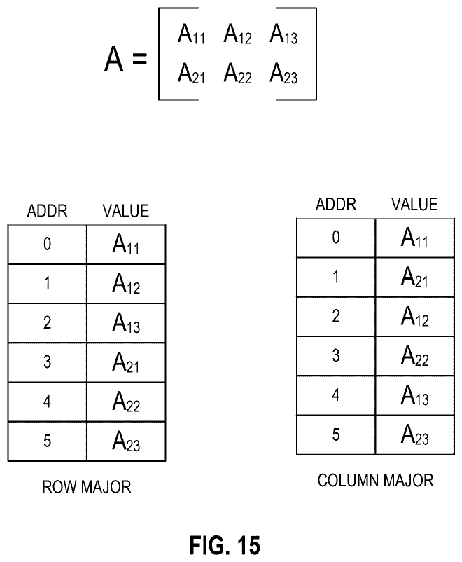

Throughout this description, data is expressed using row major data layout. Column major users should translate the terms according to their orientation. FIG. 15 illustrates an example of a matrix expressed in row major format and column major format. As shown, matrix A is a 2×3 matrix. When this matrix is stored in row major format, the data elements of a row are consecutive. When this matrix is stored in column major format, the data elements of a column are consecutive. It is a well-known property of matrices that AT*BT=(BA)T, where superscript T means transform. Reading column major data as row major data results in the matrix looking like the transform matrix.

In some examples, row-major semantics are utilized in hardware, and column major data is to swap the operand order with the result being transforms of matrix, but for subsequent column-major reads from memory it is the correct, non-transformed matrix.

For example, if there are two column-major matrices to multiply:

| a b | | g i k | ag + bh ai + bj ak + bl |
|---|---|---|---|
| c d * | h j l= | cg + dh ci + dj ck + dl | |
| e f | | eg + fh ei + fj ek + fl | |
| (3 × 2) | (2 × 3) | (3 × 3) | |

The input matrices would be stored in linear memory (column-major) as:
acebdf
and
ghijkl.

Reading those matrices as row-major with dimensions 2×3 and 3×2, they would appear as:

| | | |
|---|---|---|
| a c e | and | g h |
| b df | | i j |
| k l | | |

Swapping the order and matrix multiplying:

| | | |
|---|---|---|
| g h | a c e | ag + bh cg + dh eg + fh |
| i j * | b d f= | ai + bj ci + dj ei + fj |
| k l | | ak + bl ck + dl ek + fl |

The transform matrix is out and can then be stored in in row-major order:

$$ag + bh cg + dh eg + fh ai + bj ci + dj ei + fj ak + bl ck + dl ek + fl$$

and used in subsequent column major computations, it is the correct un-transformed matrix:

| | | |
|---|---|---|
| ag + bh | ai + bj | ak + bl |
| cg + dh | ci + dj | ck + dl |
| eg + fh | ei + fj | ek + fl |

### Exemplary Usage

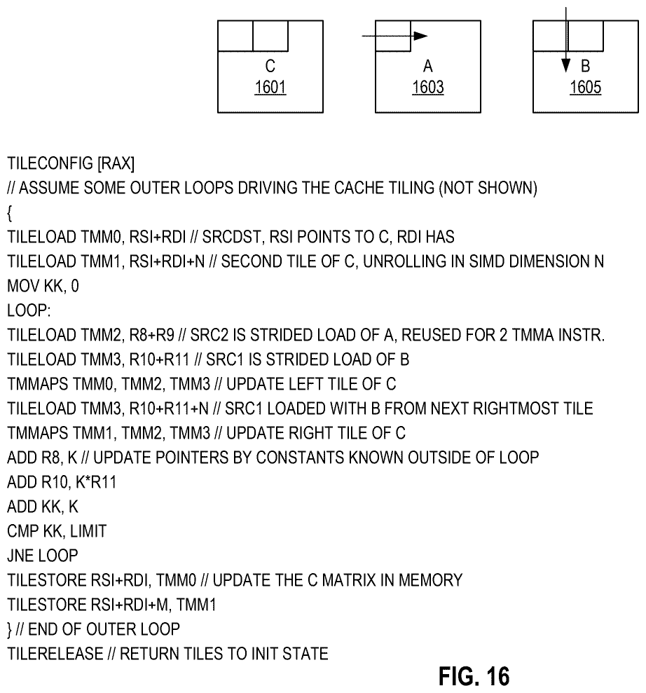

FIG. 16 illustrates an example of usage of matrices (tiles). In this example, matrix C 1601 includes two tiles, matrix A 1603 includes one tile, and matrix B 1605 includes two tiles. This figure shows an example of the inner loop of an algorithm to compute a matrix multiplication. In this example, two result tiles, tmm0 and tmm1, from matrix C 1601 are used to accumulate the intermediate results. One tile from the matrix A 1603 (tmm2) is re-used twice as it multiplied by two tiles from matrix B 1605. Pointers to load a new A matrix (tile) and two new B matrices (tiles) from the directions indicated by the arrows. An outer loop, not shown, adjusts the pointers for the C tiles.

The exemplary code as shown includes the usage of a tile configuration instruction and is executed to configure tile usage, load tiles, a loop to process the tiles, store tiles to memory, and release tile usage.

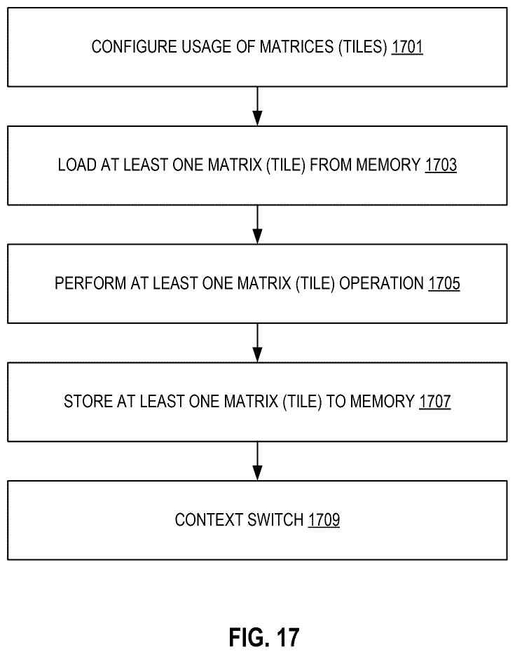

FIG. 17 illustrates an example of usage of matrices (tiles). At 1701, tile usage is configured. For example, a TILECONFIG instruction is executed to configure tile usage including setting a number of rows and columns per tile. Typically, at least one matrix (tile) is loaded from memory at 1703. At least one matrix (tile) operation is performed at 1705 using the matrices (tiles). At 1707, at least one matrix (tile) is stored out to memory and a context switch can occur at 1709.

### Exemplary Configuration

### Tile Configuration Hardware Support

As discussed above, tile usage typically needs to be configured prior to use. For example, full usage of all rows and columns may not be needed. Not only does not configuring these rows and columns save power in some examples, but the configuration may be used to determine if an operation will generate an error. For example, a matrix multiplication of the form (N×M)*(L×N) will typically not work if M and L are not the same.

Prior to using matrices using tiles, in some examples, tile support is to be configured. For example, how many rows and columns per tile, tiles that are to be used, etc. are configured. A TILECONFIG instruction is an improvement to a computer itself as it provides for support to configure the computer to use a matrix accelerator (either as a part of a processor core, or as an external device). In particular, an execution of the TILECONFIG instruction causes a configuration to be retrieved from memory and applied to matrix (tile) settings within a matrix accelerator.

### Tile Usage Configuration

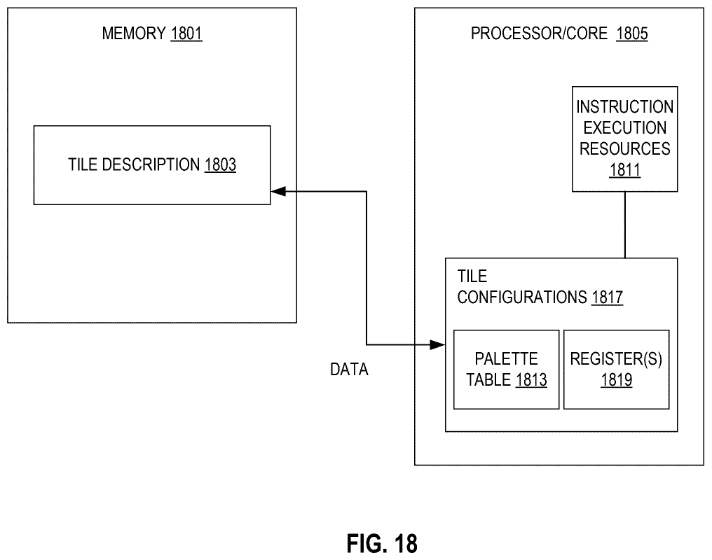

FIG. 18 illustrates support for configuration of the usage of tiles according to an example. A memory 1801 contains the tile description 1803 of the matrices (tiles) to be supported.

Instruction execution resources 1811 of a processor/core 1805 stores aspects of a tile description 1803 into tile configurations 1817. The tile configurations 1817 include palette table 1813 to detail what tiles for a palette are configured (the number of rows and columns in each tile) and a marking that matrix support is in use. In particular, instruction execution resources 1811 are configured to use tiles as specified by the tile configurations 1817. The instruction execution resources 1811 may also include a machine specific register or configuration register to indicate tile usage. Additional values such as in-use and start values are also set. The tile configurations 1817 utilize register(s) 1819 to store tile usage and configuration information.

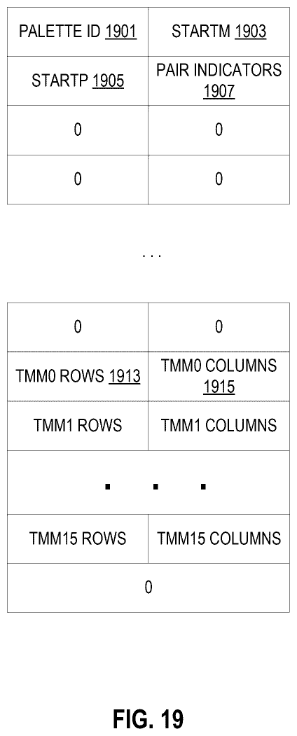

FIG. 19 illustrates an example of a description of the matrices (tiles) to be supported. This is the description that is to be stored upon an execution of a STTILECFG instruction. In this example, each field is a byte. In byte [0], a palette ID 1901 is stored. The palette ID is used to index a palette table 1813 which stores, per palette ID, a number of bytes in a tile, and bytes per row of the tiles that are associated with this ID as defined by the configuration.

Byte 1 stores a value to be stored in a “startRow” register 1903 and byte 2 stores a value to be stored in a register, startP 1905. To support restarting instructions after these events, the instructions store information these registers. To support restarting instructions after break events such as those detailed above, the instructions store information in these registers. The startRow value indicates the row that should be used for restart. The startP value indicates the position within the row for store operations when pairs are used and, in some examples, indicates the lower half of the row (in the lower tile of a pair) or higher half of the row (in the higher tile of a pair). Generally, the position in the row (the column) is not needed.

With the exception of TILECONFIG and STTILECFG, successfully executing matrix (tile) instructions will set both startRow and startP to zero.

Any time an interrupted matrix (tile) instruction is not restarted, it is the responsibility of software to zero the startRow and startP values. For example, unmasked floating point exception handlers might decide to finish the operation in software and change the program counter value to another instruction, usually the next instruction. In this case the software exception handler must zero the startRow and startP values in the exception presented to it by the operating system before resuming the program. The operating system will subsequently reload those values using a restore instruction.

Byte 3 stores an indication of pairs (1b per tile) of tiles 1907.

Bytes 16-17 store the number of rows 1913 and columns 1915 for tile 0, bytes 18-19 store the number of rows and columns for tile 1, etc. In other words, each 2-byte group specifies a number of rows and columns for a tile. If a group of 2 bytes is not used to specify tile parameters, they should have the value zero. Specifying tile parameters for more tiles than the implementation limit or the palette limit results in a fault. Unconfigured tiles are set to an initial state with 0 rows, 0 columns.

Finally, the configuration in memory typically ends with an ending delineation such as all zeros for several consecutive bytes.

### Exemplary Tile and Tile Configuration Storage

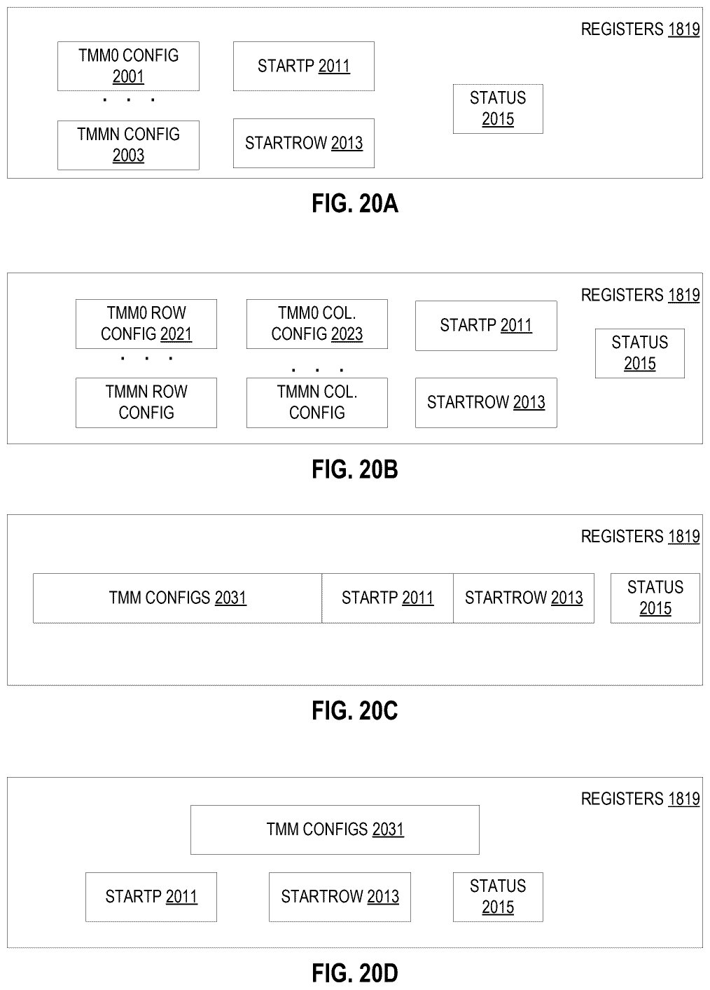

FIGS. 20A-20D illustrate examples of register(s) 1819. FIG. 20A illustrates a plurality of registers 1819. As shown each tile (TMM0 2001 . . . . TMMN 2003) has a separate register with each register storing a row and column size for that particular tile. StartP 2011 and StartRow 2013 are stored in separate registers. One or more status registers 2015 are set (e.g., TILES_CONFIGURED=1) to indicate tiles are configured for use.

FIG. 20B illustrates a plurality of registers 1819. As shown each tile has separate registers for its rows and columns. For example, TMM0 rows configuration 2021, TMM0 columns configuration 2023, StartP 2011 and StartRow 2013 are stored in separate registers. One or more status registers 2015 are set (e.g., TILES_CONFIGURED=1) to indicate tiles are configured for use.

FIG. 20C illustrates a single register 1819. As shown, this register stores tile configurations (rows and columns per tile) 2031, StartP 2011, and StartRow 2013 are stored in single register as packed data registers. One or more status registers 2015 are set (e.g., TILES_CONFIGURED=1) to indicate tiles are configured for use.

FIG. 20D illustrates a plurality of registers 1819. As shown, a single register stores tile configuration (rows and columns per tile) 2031. StartP and StartRow are stored in separate registers 2011 and 2013. One or more status registers 2015 are set (e.g., TILES_CONFIGURED=1) to indicate tiles are configured for use.

Other combinations are contemplated such as combining the start registers into a single register where they are shown separately, etc.

### Circuitry to Perform Floating-Point Operations on a Fixed-Point Systolic Array

In certain examples, it is desirable for high-end high performance computing (HPC) systems to move beyond exascale (e.g., where exascale refers to a computer that performs at least 10\hat{ }18 floating-point operations per second), e.g., using 5-10 exa(quintillion) floating point operations (“flops”) for certain double-precision matrix multiplications (e.g., to meet a HPLinpack benchmark).

To achieve these performance targets, substantial improvements in performance-per-Watt are required over existing architectures. Certain architectures (e.g., central processing unit (CPU), graphics processing unit (GPU), field programmable gate array (FPGA), custom processor, artificial intelligence (AI) specific accelerators, etc.) use hardware matrix operation (e.g., multiplication) accelerators in the form of systolic arrays to enhance low-precision AI performance. In certain examples, the systolic array is a two-dimensional grid of processing elements to perform processing operations, e.g., on input matrices.

The operations may be performed on numerical data having different formats (e.g., representations) in a computing system (e.g., accelerator and/or processor). In certain examples, a number is in fixed-point format or a floating-point format. An integer may be represented in a binary format. A signed integer may be represented in a two's (2's) complement format (e.g., where the leading bit being zero indicates a positive integer and a leading bit being one indicates a negative integer), e.g., but the leading bit is part of the number. A signed integer may be represented in a signed magnitude format that is divided into two parts of the (i) sign bit and (ii) magnitude, e.g., where the sign bit is 1 for a negative number and 0 for a positive number, and the magnitude of the number is represented with the binary form of the number. For example, where in signed magnitude a 0 has two different representations: the first is +0 (e.g., +0 being 0:0000000) and the second is-0 (e.g., −0 being 1:0000000) and in 2's complement a 0 has only one representation for −0 and +0 (+0 or −0 both being 00000000). A (e.g., real) number may be represented in floating-point format, e.g., to represent, with a fixed number of digits, numbers of different orders of magnitude.

One example of a numerical format is where a number is generally approximated to a fixed number of significant digits (the significand) and scaled using an exponent in some fixed base (e.g., a base of two, ten, or sixteen). An example of a floating-point format is as follows:

$$x = significand \times {base}^{exponent} \qquad ( 1 )$$

An example of a floating-point format (where S represents a sign bit, M a mantissa, and E an exponent) is as follows:

$$x = {( - 1 )}^{S} \times 1. M \times {2}^{E - bias} \qquad ( 2 )$$

In accordance with the IEEE 754 standard for binary floating-point (FP) arithmetic, the mantissa is an unsigned number (e.g., a binary fraction) and a normalized floating-point number has a single one in the most-significant-bit (MSB) position. In certain examples, this bit (e.g., to the left of the decimal point) is implicit and therefore the mantissa does not need to store it. In certain examples, the exponent is represented here as a non-negative integer from which a constant bias is subtracted. Examples of floating-point formats are floating point 16 (e.g., binary16), floating point 32 (e.g., binary32), floating point 64 (e.g., binary64), floating point 128 (e.g., binary128), and floating point 256 (e.g., binary256), although any number of sign, significand (e.g., mantissa thereof), or exponent bits may be used in certain examples. In one example, binary16 format has one bit for the sign bit, 5 bits for the exponent, and 11 bits implicit (10 explicitly stored) for the significand. In one example, binary32 format has one bit for the sign bit, 8 bits for the exponent, and 24 bits implicit (23 explicitly stored) for the significand. In one example, binary64 format has one bit for the sign bit, 11 bits for the exponent, and 53 bits implicit (52 explicitly stored) for the significand. In one example, binary128 format has one bit for the sign bit, 15 bits for the exponent, and 113 bits implicit (112 bits explicitly stored) for the significand. In one example, binary256 format has one bit for the sign bit, 19 bits for the exponent, and 237 bits implicit (236 bits explicitly stored) for the significand.

In certain examples, the systolic array is a two-dimensional grid of fixed-point (e.g., integer only) processing elements. In certain examples, a two-dimensional grid of floating-point (e.g., floating-point only) processing elements utilize more power and takes more time to perform an operation compares to a two-dimensional grid of fixed-point (e.g., integer only) processing elements. In certain examples, it is desirable to not utilize and/or not include a floating-point systolic array (e.g., floating-point only) within a computing system (e.g., processor). In certain examples, it is desirable to not utilize and/or not include a two-dimensional grid of floating-point (e.g., floating-point only) processing elements within a computing system (e.g., processor). In certain examples, it is desirable to not utilize vector execution circuitry to perform floating-point matrix operations (e.g., vector execution circuitry to implement chained multiply accumulate operations (e.g., QMADD, OMADD)), e.g., to instead utilize a (e.g., faster and/or more power efficient) two-dimensional grid of fixed-point (e.g., integer only) processing elements to perform floating-point operations. In certain examples, a QMADD operation (e.g., instruction) is to use vector execution circuitry to perform a matrix multiplication of two 2×2 input matrices and accumulate the results with a third 2×2 matrix, and an OMADD operation (e.g., instruction) is to use vector execution circuitry to perform a matrix multiplication of two 4×4 input matrices and accumulate the results with a third 4×4 matrix.

Examples herein overcome these issues by introducing circuitry (e.g., floating-point support circuitry) to support operations on floating-point values by a two-dimensional grid of fixed-point (e.g., integer only) processing elements, e.g., such that values are still input into the two-dimensional grid of fixed-point (e.g., integer only) processing elements as fixed-point values but the floating-point support circuitry enables floating-point inputs and floating-point outputs to be generated by a hardware matrix operation (e.g., multiplication) accelerator via its two-dimensional grid of fixed-point (e.g., integer only) processing elements. Examples herein enable the emulation of floating-point types (e.g., single and/or double precision) using the fixed-point (e.g., integer) arithmetic support provided by a systolic array. In certain examples, this approach requires minimal modifications to existing systolic arrays, e.g., allowing the systolic array to function on both integer values and floating-point values (e.g., via the floating-point support circuitry).

Examples herein improve the functioning of a computer (e.g., processor) by allowing floating-point values to be processed by a two-dimensional grid of fixed-point (e.g., integer only) processing elements, e.g., by including floating-point support circuitry as discussed herein. As discussed herein, the floating-point support circuitry allows for a computer (e.g., processor) to support floating-point matrix operations (e.g., arithmetic) with its two-dimensional grid of fixed-point (e.g., fixed-point only) processing elements without utilizing (and/or not even including) a floating-point systolic array (e.g., floating-point only) within the computer (e.g., processor). As discussed herein, the floating-point support circuitry allows for a computer (e.g., processor) to support floating-point matrix operations (e.g., arithmetic) with its two-dimensional grid of fixed-point (e.g., fixed-point only) processing elements without utilizing (and/or not even including) a two-dimensional grid of floating-point (e.g., floating-point only) processing elements within a computer (e.g., processor). As discussed herein, the floating-point support circuitry also allows for minimal modifications to an (e.g., existing) fixed-point systolic array where it is desired to add floating-point functionality.

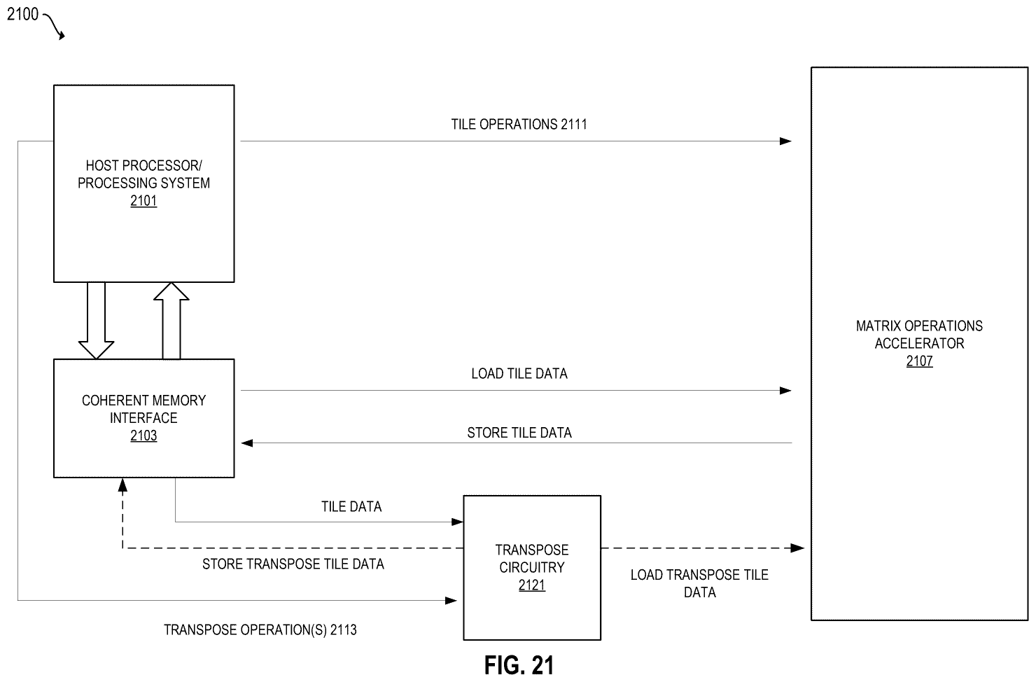

In certain examples, a processor (e.g., core) supports one or more instructions that are to cause floating-point support circuitry to enable support of floating-point matrix operations (e.g., arithmetic) with a two-dimensional grid of fixed-point (e.g., fixed-point only) processing elements. Those instructions disclosed herein are improvements to the functioning of a processor (e.g., of a computer) itself. Instruction decoder circuitry (e.g., a decoder) not having such an instruction as a part of its instruction set would not decode as discussed herein. An execution circuit not having such an instruction as a part of its instruction set would not execute as discussed herein. For example, a processor that, is to (i) decode, by a decoder circuit of a hardware processor comprising a matrix operations accelerator circuit including a two-dimensional grid of fixed-point processing elements, floating-point support circuitry coupled to the two-dimensional grid of fixed-point processing elements, and storage for a first, a second, and a destination two-dimensional floating-point matrices coupled to the floating-point support circuitry, the single “floating-point matrix operations” instruction into a decoded single instruction, the single “floating-point matrix operations” instruction including a first field that identifies the first two-dimensional floating-point matrix, a second field that identifies the second two-dimensional floating-point matrix, and an opcode that indicates an execution circuit of the hardware processor is to cause the matrix operations accelerator circuit to: determine, by the floating-point support circuitry, an extreme exponent for each row of the first two-dimensional floating-point matrix and for each column of the second two-dimensional floating-point matrix, generate, by the floating-point support circuitry, a first fixed-point matrix from the first two-dimensional floating-point matrix and a second fixed-point matrix from the second two-dimensional floating-point matrix, generate, by the two-dimensional grid of fixed-point processing elements, corresponding fixed-point results by a multiplication of fixed-point elements of the first fixed-point matrix by corresponding fixed-point elements of the second fixed-point matrix, scale, by the floating-point support circuitry, the corresponding fixed-point results according to the extreme exponents to generate scaled fixed-point results, generate, by the floating-point support circuitry, a resultant floating-point matrix from the scaled fixed-point results, and store the resultant floating-point matrix into the destination two-dimensional floating-point matrix, and (ii) execute, by the execution circuit of the hardware processor, the decoded single instruction according to the opcode. Certain examples herein allow for multiple precision (e.g., floating-point) matrix multiplication. Certain examples herein allow a matrix operations accelerator circuit including a two-dimensional grid of fixed-point processing elements to process (i) fixed point (e.g., integer) input values when in a first mode and (ii) floating-point input values when in a second mode, see, e.g., the discussion of FIGS. 21-41.

In certain examples, matrix multiplication can be thought of as a set of dot product calculations (with much data reuse between dot products). One key idea of examples herein is for a processor to include floating-point support circuitry that enables support of floating-point matrix operations (e.g., arithmetic) with a two-dimensional grid of fixed-point (e.g., fixed-point only) processing elements. In certain examples, the floating-point support circuitry determines the binary “point” of each dot product by examining the input matrices, e.g., once a fixed-point is chosen, the floating-point support circuitry then translates all floating-point input values into fixed-point (e.g., as they stream into the systolic array). To deal with the lower precision (e.g., fixed precision) of certain systolic arrays (e.g., two-dimensional grid of fixed-point (e.g., fixed-point only) processing elements), certain examples herein include floating-point support circuitry that breaks input elements into chunk sized (e.g., word-sized) pieces, and thus (e.g., narrow) chunk sized (e.g., word) multiplications are then used to complete a wider element (e.g., word) multiplication. In certain examples, all multiplication and accumulation in the systolic array are performed in fixed-point, and the results are converted back into floating-point at the end of the matrix multiplication.

Such floating-point support circuitry and two-dimensional grid of fixed-point (e.g., fixed-point only) processing elements cannot practically be performed in the human mind (or with pen and paper). Such floating-point support circuitry is an improvement in the functioning of a computer as discussed herein. An example improvement realized by the floating-point support circuitry is improved matrix multiplication performance and performance per Watt of power consumed, e.g., from 3-8 times better than without using the floating-point support circuitry. Another example improvement realized by the floating-point support circuitry is the ability to add floating-point support to an (e.g., existing) systolic array, e.g., as a component in processor architectures. An example improvement realized by the floating-point support circuitry is because it uses fixed-point, more performance is unlocked where arrays have more integer multiplication support than floating-point multiplication support. Surprisingly, in certain examples, operating in fixed-point also improves the accuracy of the matrix multiplications, which will unlock additional performance gains in some application use cases. Also note that by eliminating the need for floating-point systolic arrays, the fixed-point (e.g., AI) systolic arrays could be made larger in a processor and/or also achieve higher AI performance points.

Hardware acceleration for AI-based applications is widely pursued to meet stringent latency, throughput, cost, and energy efficiency requirements. Matrix transpose (tensor reshape) operation is critically required in attention layers (as in transformer-based architectures for both inference and training), gradient computation during back-propagation (in training) and many other tensor-reshape operators as present in deep neural network (DNN) models. The dimensionality and size of the tensor (to be transposed) significantly increase the required configurability in transpose operation and the complexity of hardware accelerators supporting the transpose operation.

Most of the state-of-the-art artificial intelligence (A)I hardware solutions perform matrix transpose (tensor reshape) as an individual operator (i.e., precedent and/or subsequent operators such as GEMM/convolution are not fused with the transpose/reshape operation, instead they write-back output data before the transpose operation or freshly read input data after the transpose operation respectively). It often adds latency overheads and energy inefficiencies due to multiple to-and-fro data movements attenuating the benefits of tightly coupled efficient GEMM/Convolution engine.

Some state-of-the-art hardware accelerators that support a transpose operation employ a memory buffer to hold a block/tile of a matrix. Input tensor data is read from main memory to the buffer memory and written back to main memory after performing block-transpose operation. An increase in tensor dimensionality further adds to intermediate buffer requirements and the design complexity to support all possible modes of tensor reshapes. Additionally, some approaches use software to execute transpose operations through non-matrix (e.g., vector) instructions and then load into a data buffer.

Examples herein describe a unified and area/energy efficient accelerator architecture for matrix transpose with GEMM/convolution accelerator supporting streaming (in-line with GEMM), buffering, and hybrid modes of execution while enabling all configurable permutations for multi-dimensional matrix transpose (tensor reshape) operator through a minimal and fundamental set of instructions.

FIG. 21 illustrates examples of one or more systems 2100 including a matrix operations accelerator 2107 and transpose circuitry 2301. In this illustration, a host processor/processing system 2101 communicates commands 2111 (e.g., matrix manipulation operations such as arithmetic or matrix manipulation operations, or load and store operations, etc.) to a matrix operations accelerator 2107 and/or transpose commands 2113 (e.g., transpose instructions, transpose operations, etc.) to transpose circuitry 2301. In some examples, FIG. 21 illustrates a system-on-a-chip. In some examples, the memory is not a part of the system-on-a-chip. In some examples, the transpose circuitry 2301 is a part of a GPU. In some examples, the transpose circuitry 2301 is standalone circuitry.

In some examples, one or both of the accelerator 2107 and/or transpose circuitry are a part of a processing core. Typically, commands 2111 or 2113 that are tile manipulation operator instructions will refer to tiles as register-register (“reg-reg”) or register-memory (“reg-mem”) format. Other commands such as TILESTORE, TILELOAD, TILECONFIG, etc., do not perform data operations on a tile. In some examples, commands are decoded instructions (e.g., micro-ops) or macro-instructions for the accelerator 2107 and/or transpose circuitry 2121 to handle.

In this example, a coherent memory interface 2103 is coupled to the host processor/processing system 2101 and matrix operations accelerator 2107 and/or transpose circuitry 2121 such that they can share memory. FIGS. 4 and 5 show different examples of how memory is shared using a matrix operations accelerator.

In some examples, the transpose circuitry 2121 is a hardware accelerator supporting streaming transpose operation for any given N-dimensional matrix in which streaming behavior. In some examples, data control circuitry of the transpose circuitry 2121 alternates read and write operation between serial and parallel modes and uses control block generating read/write addresses accordingly.

Capability and software configurability of the transpose hardware to be operated in three different modes: 1) streaming mode, 2) buffer mode and 3) dual mode simultaneously supporting streaming and buffer modes. The dual mode is used for scenarios where the transposed matrix is required more than once, in such cases the proposed hardware writes the transposed matrix to the memory along with the streaming them for the initial requirement. Thus, for the next subsequent requirements the transposed data can be read directly from the memory without invoking the proposed hardware. Simultaneous streaming and buffering mode help in avoiding both initial latency overheads and repeated transpose invocations.

An instruction to drive the proposed hardware providing software configurability.

The proposed solution prevents data corruption by efficiently arranging the control bits and synchronizing the read and write operations to the transpose (transposition) engines in accordance with the control bits.

The proposed solution is a scalable design architecture for area efficient and higher throughput implementation. Also, it provides a universal support for matrix transpose (tensor reshape) function with any-to-any data-layout across all data-precisions.

The proposed solution comes with an inbuild support to handle transpose of a non-square matrices. It avoids accessing invalid source locations to support non-square matrices efficiently (non-cubical tensors).

In some examples, the transpose circuitry 2121 supports a tile transpose instruction (e.g., TTMM) to transpose a tile from memory/register to memory/register allowing input and/or output to be in memory. An example of a TTMM instruction is TTMM tmm1/sibmem, tmm2/sibmem where the destination is indicated by tmm1 (destination tile) or a sibmem address and the source is indicated by tmm2 (source tile) or sibmem address which will be read. Note that TTMM is an opcode mnemonic of the instruction. In some examples, the opcode is provided by field 4503, BPG12, or 5504. In some examples, source and/or destination locations are provided by one or more of bits from a prefix 4501 (e.g., R-bit, VVVV, etc.), addressing information 4505 (e.g., reg 4644, R/M 4646, SIB byte 4604, etc.), 4118, 4120, 4122, 4124, 4126, etc. In some examples, the prefix is the second prefix 4501(B) detailed herein. SIBMEM uses one or more of a scale, index, and base to generate addresses.

In some examples, the transpose circuitry 2121 helps support one or more transpose and compute (e.g., TTCOMPUTE) instructions. A TTCOMPUTE instruction first transposes one or more tiles using transpose circuitry 2121 and the matrix operations accelerator 2107 uses the transposed tile(s) in a compute operation such as multiply, dot-product, add, subtract, divide, etc. An example of a TTCOMPUTE instruction is TTCOMPUTE tmm1/sibmem, tmm2/sibmem, tmm3/sibmem where the destination is indicated by tmm1 (destination tile) or a sibmem address and the sources are indicated by tmm2 and tmm3 (source tile) or sibmem address which will be read. Note that TTCOMPUTE is an opcode mnemonic of the instruction. In some examples, the opcode is provided by field 4503, BPG12, or 5504. In some examples, source and/or destination locations are provided by one or more of bits from a prefix 4501 (e.g., R-bit, VVVV, etc.), addressing information 4505 (e.g., reg 4644, R/M 4646, SIB byte 4604, etc.), 4118, 4120, 4122, 4124, 4126, etc. In some examples, the prefix is the second prefix 4501(B) detailed herein. In some examples, which tile(s) to transpose is provided by the opcode. In some examples, which tile(s) to transpose is provided by other means such as an immediate or prefix.

In some examples, the transpose circuitry 2121 helps support one or more compute and transpose (e.g., TCOMPUTE) instructions. A TCOMPUTE instruction first performs a compute operation such as multiply, dot-product, add, subtract, divide, etc. the matrix operations accelerator 2107 and then transposes the results using the transpose circuitry 2121. An example of a TCOMPUTE instruction is TCOMPUTE tmm1/sibmem, tmm2/sibmem, tmm3/sibmem where the destination is indicated by tmm1 (destination tile) or a sibmem address and the sources are indicated by tmm2 and tmm3 (source tile) or sibmem address which will be read. Note that TCOMPUTE is an opcode mnemonic of the instruction. In some examples, the opcode is provided by field 4503, BPG12, or 5504. In some examples, source and/or destination locations are provided by one or more of bits from a prefix 4501 (e.g., R-bit, VVVV, etc.), addressing information 4505 (e.g., reg 4644, R/M 4646, SIB byte 4604, etc.), 4118, 4120, 4122, 4124, 4126, etc. In some examples, the prefix is the second prefix 4501(B) detailed herein. In some examples, which tile(s) to transpose is provided by the opcode. In some examples, which tile(s) to transpose is provided by other means such as an immediate or prefix.

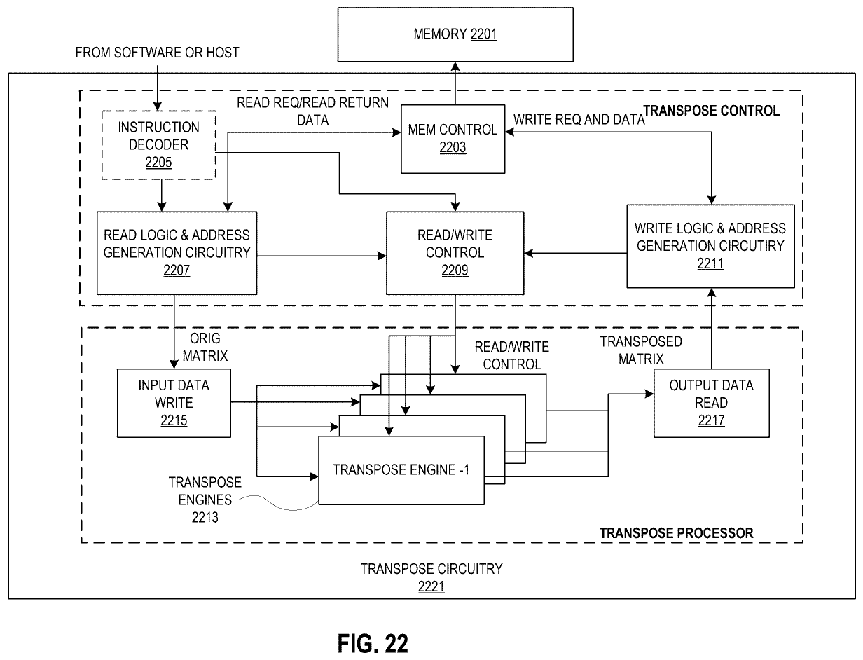

FIG. 22 illustrates examples of transpose circuitry such as transpose circuitry 2121. In some examples, the transpose circuitry 2121 supports at least two operating modes: 1) a buffer mode and 2) a streaming mode. In the buffer mode, transposed output data from the transpose circuitry 2121 is written back to some storage (for example: memory or register) (e.g., for a TTMM) and in the streaming mode the is streamed out from the transpose circuitry 2121 without writing to the memory (e.g., for a TTCOMPUTE). In some examples, the transpose circuitry 2121 allows for both modes to be enabled simultaneously where the output data will be written back to the memory and will also be streaming out providing an option to reuse the transposed data for future operations.

As shown, the transpose circuitry 2121 may be logically partitioned into two sections: transpose control and a transpose processor. The transpose control section contains logic to consume a current matrix format and dimension along with a targeted transposed format and programs an internal state machine with the appropriate address jumps to use while performing input reads from the memory 2201.

In some examples, an instruction decoder 2205 of the transpose circuitry 2121 decodes a transpose instruction (e.g., one of the instructions detailed above) to configure the read/write control circuitry 2209 (used for read/write control of one or more transport engines 2213) and/or read logic and address generation circuitry 2207 which generates addresses to read from memory 2201. Note that memory 2201 may be external memory (e.g., random access memory, storage, etc.) or registers. A memory control unit 220 provides read matrix (tile) data from memory 2201 and writes matrix data to memory 2211 (using information such as an address or tile identifier provide by write logic and address generation circuitry 2211).

The read/write control circuitry 2209 determines (e.g., using a state machine) how incoming data is to be written to one or more transpose engines 2213 of the transpose processor. It also decides how data will be read back from these transpose engines 2213 to get a transposed row. In a streaming mode, the read/write control circuitry 2209 switches between writing serially and parallelly across the set of transposed engines 2213 after a pre-defined number of cycles. In a parallel mode, each element of a matrix is written to the same transpose engine. In the serial mode, each element of the matrix is written to a transpose engine. The transpose read mode always follows the write mode. Thus, after an initial latency of few cycles a throughput of one transposed row of matrix elements per cycle can be achieved which maximizes memory bandwidth utilization. For a large matrix, the read/write control 2209 may internally divide the large matrix into smaller matrices and uses the read logic and address generation circuitry 2207 to compute the addresses accordingly to make sure that the data is rearranged in an appropriate manner. This removes the dependency from software to divide or configure the larger matrices to a dimension suitable for hardware.

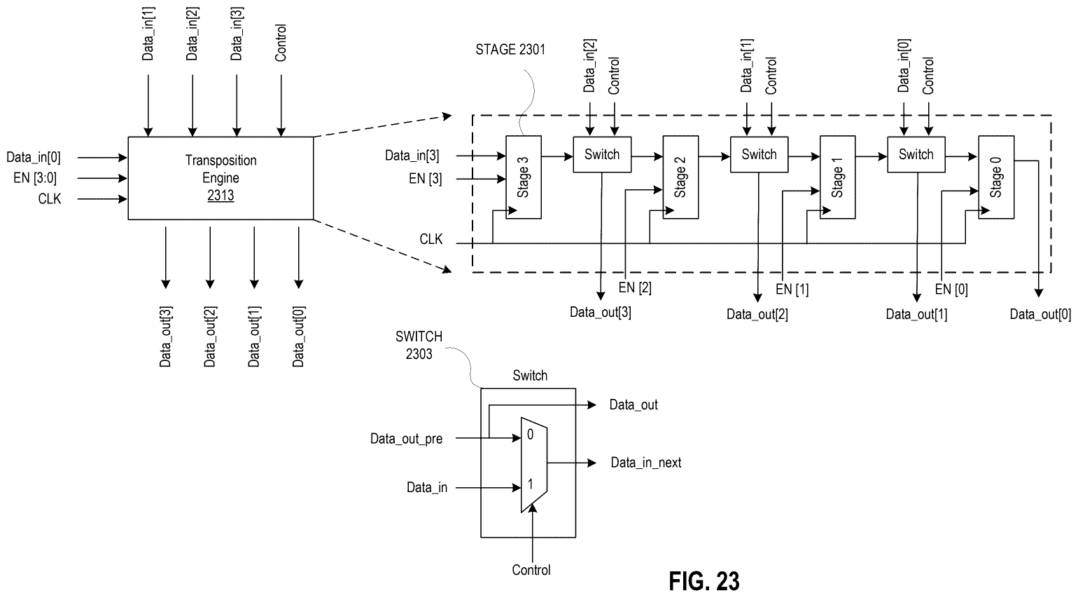

FIG. 23 illustrates examples of a transpose engine. As illustrated, a transpose engine comprises a plurality of stages 2301 coupled to switches (e.g., multiplexers) 2303. Each stage includes a data storage device such as flip-flops, one or more registers, etc. In some examples, each stage is a 32-bit register. Each stage is enabled by an enable (EN) signal. Each switch 2303 enables serial-in/parallel-in operations between the subsequent stages of registers.

In some examples, an operation of the transpose circuitry 2121 with the memory control 2203 being instructed (based on a decoded instruction) to issue a read request for the input matrix. After every read, a bit is passed on to the read/write control circuitry 2209 to update a counter and a control bit based on the counter value. The control bit dictates how the input data to be loaded into the transpose engines 2213 within a transpose processor. The input data may be loaded in parallel to a single transpose engine (e.g., when the control bit==1 (note that the opposite convention may be used)) or one element per transpose engine (e.g., when the control bit==0).

In some examples, the counter in the read/write control circuitry 2209 starts from a number (e.g., 3) and decrements until 0. Once the counter hits a zero the control bit will be complemented, and the counter get reset to 3 again. Note the opposite convention of counting up to 3, etc. may be used. Note that the number to count from (or to) aligns with the number of stages in a transport engine.

The operation for data output is same as how the data is getting loaded currently. For example, when the control bit==1 (such that the data is getting loaded in parallel) the output will be read in parallel manner (such that data will be read from a single transpose engine). Similarly for control bit==0 (such that data is getting loaded in serial manner across transpose engines), the output will be read in serial manner (one element from each transpose engine). In general, when control==1 there is a parallel load and parallel read. When control==0 there is a serial load and serial read.

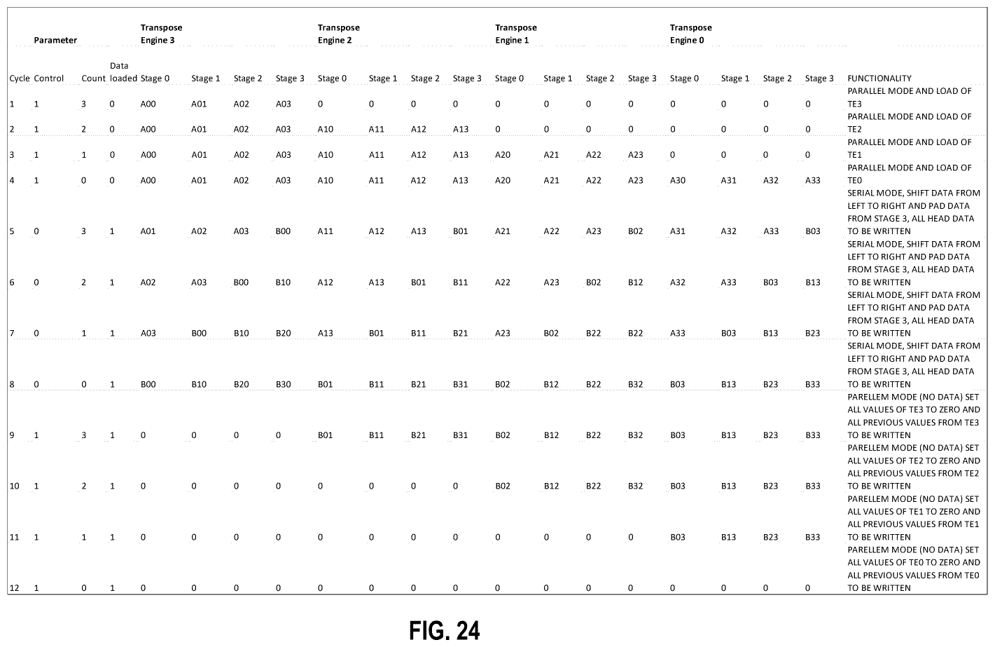

FIG. 24 illustrates examples of a data flow of a transport engine. This data flow is for the transpose of a 2-D tensor where each element of the tensor is 32-bit floating-point number (fp32) with a memory bandwidth of 16 Bytes/cycle. As such, each read from the memory will provide four elements of fp32. To perform this operation, a transpose processor will use four sets of transport engines each with 128 bits, arranged as 4×128 bits, where each row is capable of handling 128 bits.

During a parallel write operation to the transpose processor each set of registers is written one-by-one (i.e., one transpose engine at a time), while in serial write mode one element of fp32 is written per register set (i.e., one element per transpose engine per write). At the end of the fourth cycle, the write mode is toggled (either from serial to parallel or parallel to serial) and continues to the next set of write operations to the register sets. Similarly, at the end of fourth cycle read/write control 2209 logic changes to a read mode which follows the current write mode (i.e., if current write mode is serial, read mode will be serial and vice versa). Thus, making it feasible to read transposed tensor data every cycle.

2-D tensors A and B are shown as two 4×4 tensors (elements are indexed as A_{(row,column)}/B_{(row,column)}) below:

Tensor A

| | | | |
|---|---|---|---|
| A00 | A01 | A02 | A03 |
| A10 | A11 | A12 | A13 |
| A20 | A21 | A22 | A23 |
| A30 | A31 | A32 | A33 |

Tensor B

| | | | |
|---|---|---|---|
| B00 | B01 | B02 | B03 |
| B10 | B11 | B12 | B13 |
| B20 | B21 | B22 | B23 |
| B30 | B31 | B32 | B33 |

As shown in cycle 1, A00, A01, A02, A03 are read from memory and are loaded into transpose engine (TE) 3. In cycle 2, A10, A11, A12, A13 are read from memory and are loaded into Transpose engine 2. In cycle 3, A20, A21, A22, A23 are read from memory and are loaded into Transpose engine 1. In cycle 4, A30, A31, A32, A33 are read from memory and are loaded into Transpose engine 0.

In cycle 5, the data loaded bit is set high by the read/write control 2209 indicating that output writing can start as all transpose engines are full. The control bit is also changed to 0. Thus, B00, B01, B02, B03 are read and are loaded in a serial manner one element per transpose engine. The first row of transposed matrix A is read in serial (i.e., one element from head of each transpose engine (i.e., A00, A10, A20 and A30)) and the remaining data is shifted toward the head of the engine).

In cycle 6, B10, B11, B12, B13 are read and are loaded in a serial manner one element per transpose engine. We also shift the previous data to next stage within the transpose engine. The second row of transposed matrix A is read in serial (i.e., one element from head of each transpose engine (i.e., A01, A11, A21 and A31) and the remaining data is shifted toward the head of the engine).

In cycle 7, B20, B21, B22, B23 are read and are loaded in a serial manner one element per transpose engine. We also shift the previous data to next stage within the transpose engine. The third row of transposed matrix A is read in serial (i.e., one element from head of each transpose engine (i.e., A02, A12, A22 and A32) and the remaining data is shifted toward the head of the engine).

In cycle 8, B30, B31, B32, B33 are read and are loaded in a serial manner one element per transpose engine. We also shift the previous data to next stage within the transpose engine. The fourth row of transposed matrix A is read in serial (i.e., one element from head of each transpose engine (i.e., A03, A13, A23 and A33) and the remaining data is shifted toward the head of the engine).

The remaining cycles read out the B matrix.

A larger matrix can be broken into multiple smaller matrices using the transpose control block by generating address jumps. This is achieved by taking memory bandwidth and word-line dimension into consideration internally. One or more state machines of the read/write control 2209 are programmed accordingly before commencing the transpose operation. This removes the dependency from software to divide or configure the larger matrices to a dimension suitable for hardware.

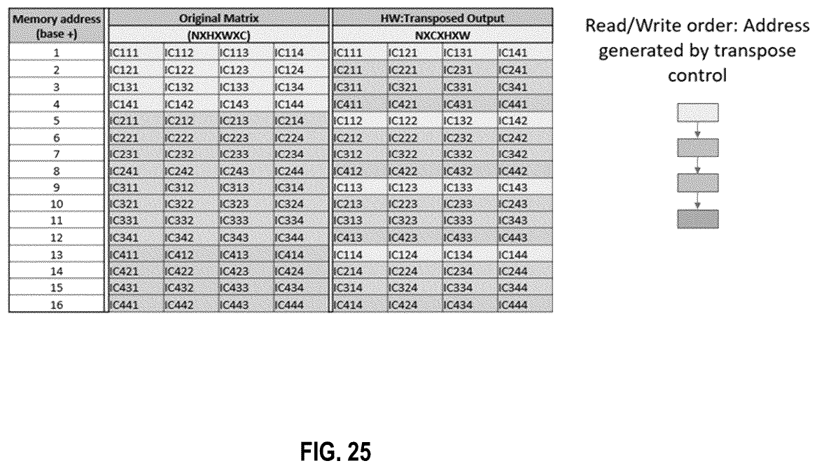

N-dimensional tensors may also be supported. FIG. 25 illustrates an example presenting the transposition of a 4-D tensor.

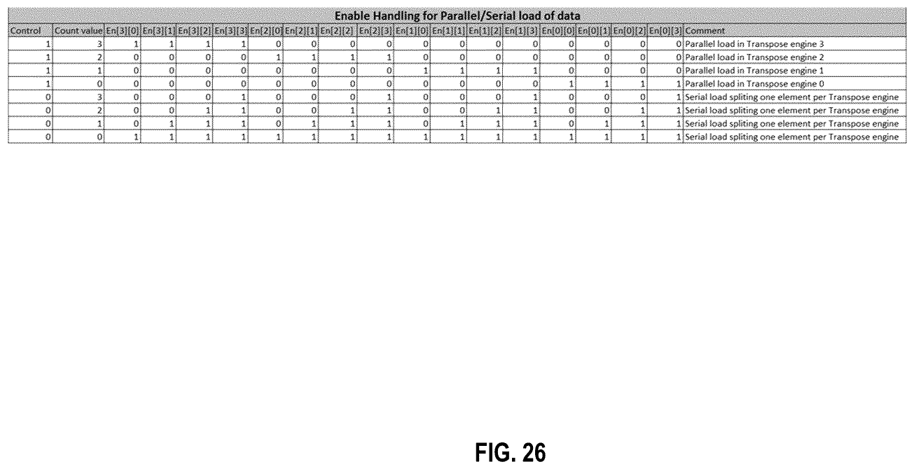

FIG. 26 illustrates examples of enable handling in a transpose engine. In these examples, the enable bits are in a format of EN [TE][STAGE]. In this illustration, when control==1 and count value==3 all enable bits of transpose engine 3 get enabled. As such, read data is loaded in all four stages (one element per stage) of TE3. When control==1 and count value==2 all enable bits of transpose engine 2 get enabled, etc. When control==0 and count value—3, one enable bit of each transpose engine gets enabled. This allows for read data to be loaded in one stage (one element per transpose engine). When control==0 && count value==2, one enable bit of each transpose engine gets enabled which loads read data into one stage and previous data is be pushed to next stage within the same transpose engine, etc.

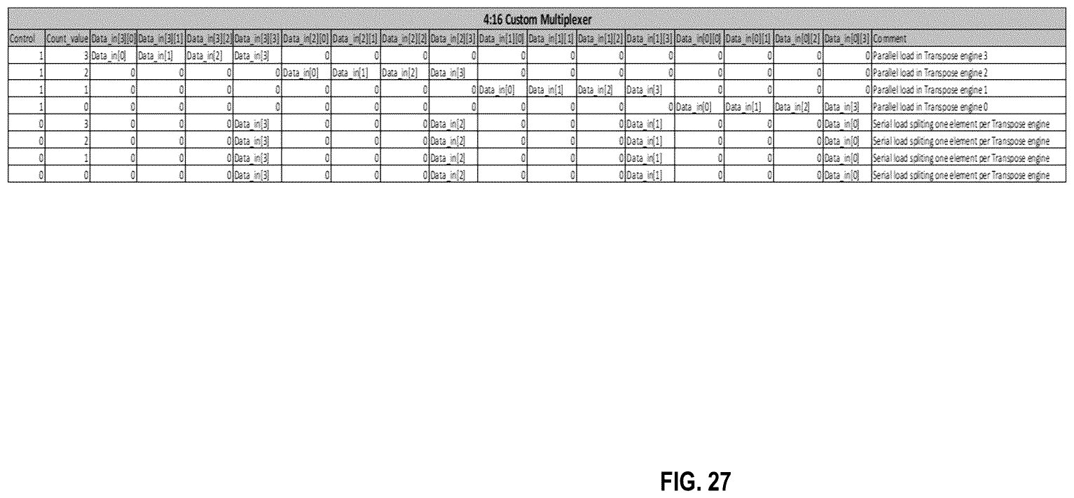

In some examples, data loading to transpose engines is performed by an input data write block 2215 using a multiplexer. FIG. 27 illustrates an example of data loading using a mux. In this illustration, each read from the memory pulls in four data elements (e.g., {Data_in[3],Data_in[2],Data_in[1],Data_in[0]}). For the parallel load mode (control==1) each transpose engine is loaded independently as shown based on the “count” value. When control==0, one element per transpose engine is loaded.

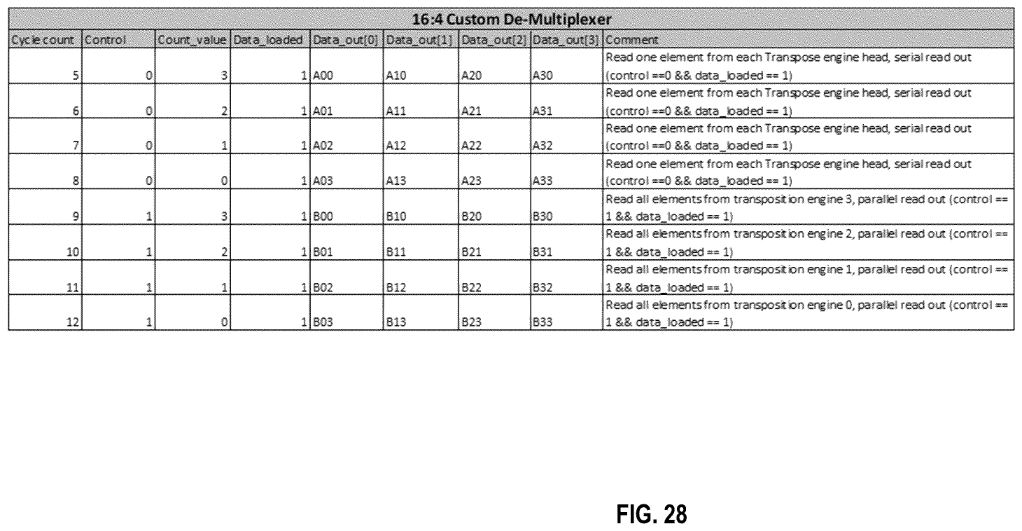

An output data read circuit 2217 writes the transposed matrix row back to memory through a demultiplexer. FIG. 28 illustrates examples of a demultiplexer in writeback. For the first four cycles since the transpose engine is not filled a data_loaded bit is low (this is not shown). From cycle 5 onward the data_loaded bit is set high indicating a transpose engine is filled. At cycle 5, the control==0 and one element is read from each transpose engine. Subsequent cycles read one element per transpose engine. At cycle 9 the control==1 and all elements from single transpose engine are read (in this example TE3 is read). Subsequent cycles read out entire transpose engines.

In some examples, the larger matrices are supported. For example, when one row of matrix fits into more than one memory row (e.g., A00-A07 take up more than one memory row, etc.) the memory control 2203 starts reading all odd memory rows first and then reads even memory rows. This alternation allows for odd memory locations to be a first matrix and even memory locations to be a second matrix.

| Mem | Matrix | |
|---|---|---|
| row | row | Matrix Elements |

| | | | | | |
|---|---|---|---|---|---|
| 1 | 1 | A00 | A01 | A02 | A03 |
| 2 | 1 | A04 | A05 | A06 | A07 |
| 3 | 2 | A10 | A11 | A12 | A13 |
| 4 | 2 | A14 | A15 | A16 | A17 |
| 5 | 3 | A20 | A21 | A22 | A23 |
| 6 | 3 | A24 | A25 | A26 | A27 |
| 7 | 4 | A30 | A31 | A32 | A33 |
| 8 | 4 | A34 | A35 | A36 | A37 |

The output of this approach for the example above is shown in the table below.

| Hard- | Processing | Processing | Output | | | | |
|---|---|---|---|---|---|---|---|
| ware | Mem row: | Matrix row: | Mem | | | | |
| Cycles | Input | Input | location | Output written | | | |
| 1 | 1 | 1 | | | | | |
| 2 | 3 | 2 | | | | | |
| 3 | 5 | 3 | | | | | |
| 4 | 7 | 4 | | | | | |
| 5 | 2 | 1 | O1 | A00 | A10 | A20 | A30 |
| 6 | 4 | 2 | O2 | A01 | A11 | A21 | A31 |
| 7 | 6 | 3 | O3 | A02 | A12 | A22 | A32 |
| 8 | 8 | 4 | O4 | A03 | A13 | A23 | A33 |
| 9 | | | O5 | A04 | A14 | A24 | A34 |
| 10 | | | O6 | A05 | A15 | A25 | A35 |
| 11 | | | O7 | A06 | A16 | A26 | A36 |
| 12 | | | O8 | A07 | A17 | A27 | A37 |

In situations where one row of matrix fits in memory row, but the number of rows is more than number of columns (such that the transpose will have more columns than rows), the matrix will be operated on row-by-row, but while writing out the result the read/write control 2209 causes the generation of an output address in such a way that transposed matrix is written first at the odd locations and then onto the even locations. This causes the transposed matrix to be written in a correct order where each matrix row will fit into more than one memory row. The table below illustrates an example of a matrix for this situation.

| Mem | Matrix | |
|---|---|---|
| row | row | Matrix Elements |

| | | | | | |
|---|---|---|---|---|---|
| 1 | 1 | A00 | A01 | A02 | A03 |
| 2 | 2 | A10 | A11 | A12 | A13 |
| 3 | 3 | A20 | A21 | A22 | A23 |
| 4 | 4 | A30 | A31 | A32 | A33 |
| 5 | 5 | A40 | A41 | A42 | A43 |
| 6 | 6 | A50 | A51 | A52 | A53 |
| 7 | 7 | A60 | A61 | A62 | A63 |
| 8 | 8 | A70 | A71 | A72 | A73 |

As shown in the table below, the alternating writing generates the proper transposed matrix.

| Hard- | | | | | | | |
|---|---|---|---|---|---|---|---|
| ware | Processing | Processing | Mem | | | | |
| Cycles | Mem row | Matrix row | location | Output written | | | |
| 1 | 1 | 1 | | | | | |
| 2 | 2 | 2 | | | | | |
| 3 | 3 | 3 | | | | | |
| 4 | 4 | 4 | | | | | |
| 5 | 5 | 5 | O1 | A00 | A10 | A20 | A30 |
| 6 | 6 | 6 | O3 | A01 | A11 | A12 | A31 |
| 7 | 7 | 7 | O5 | A02 | A12 | A22 | A32 |
| 8 | 8 | 8 | O7 | A03 | A13 | A23 | A33 |
| 9 | 9 | 9 | O2 | A40 | A50 | A60 | A70 |
| 10 | 10 | 10 | O4 | A41 | A51 | A61 | A71 |
| 11 | 11 | 11 | O6 | A42 | A52 | A62 | A72 |
| 12 | 12 | 12 | O8 | A43 | A53 | A63 | A73 |

In some examples, the memory width is larger than the width used in the transpose circuitry 2221. Since the hardware width is half of the memory width, each memory location will be read twice. A walk downward in the memory using hardware width is first performed and a resultant matrix of hardware width is produced. The next set of elements of the same data again is read from the start of the matrix. The table below shows the read.

| Memory | Matrix | | | | | | | | |
|---|---|---|---|---|---|---|---|---|---|
| Row | row | Matrix Elements | | | | | | | |
| 1 | 1 | A00 | A01 | A02 | A03 | A04 | A05 | A06 | A07 |
| 2 | 2 | A10 | A11 | A12 | A13 | A14 | A15 | A16 | A17 |
| 3 | 3 | A20 | A21 | A22 | A23 | A24 | A25 | A26 | A27 |
| 4 | 4 | A30 | A31 | A32 | A33 | A34 | A35 | A36 | A37 |
| 5 | 5 | A40 | A41 | A42 | A43 | A44 | A45 | A46 | A47 |
| 6 | 6 | A50 | A51 | A52 | A53 | A54 | A55 | A56 | A57 |
| 7 | 7 | A60 | A61 | A62 | A63 | A64 | A65 | A66 | A67 |
| 8 | 8 | A70 | A71 | A72 | A73 | A74 | A75 | A76 | A77 |

For writing data out, two cycles are used to write out one transposed matrix row. The table below shows the output writes.

| Output Mem | |
|---|---|
| location | Output matrix element |

| | | | | |
|---|---|---|---|---|
| O1 | A00 | A10 | A20 | A30 |
| O3 | A01 | A11 | A21 | A31 |
| O5 | A02 | A12 | A22 | A32 |
| O7 | A03 | A13 | A23 | A33 |
| O1 | A40 | A50 | A60 | A70 |
| O3 | A41 | A51 | A61 | A71 |
| O5 | A42 | A52 | A62 | A72 |
| O7 | A43 | A53 | A63 | A73 |
| O2 | A04 | A14 | A24 | A34 |
| O4 | A05 | A15 | A25 | A35 |
| O6 | A06 | A16 | A26 | A36 |
| O8 | A07 | A17 | A27 | A37 |
| O2 | A44 | A54 | A64 | A74 |
| O4 | A45 | A55 | A65 | A75 |
| O6 | A46 | A56 | A66 | A76 |
| O8 | A47 | A57 | A67 | A77 |

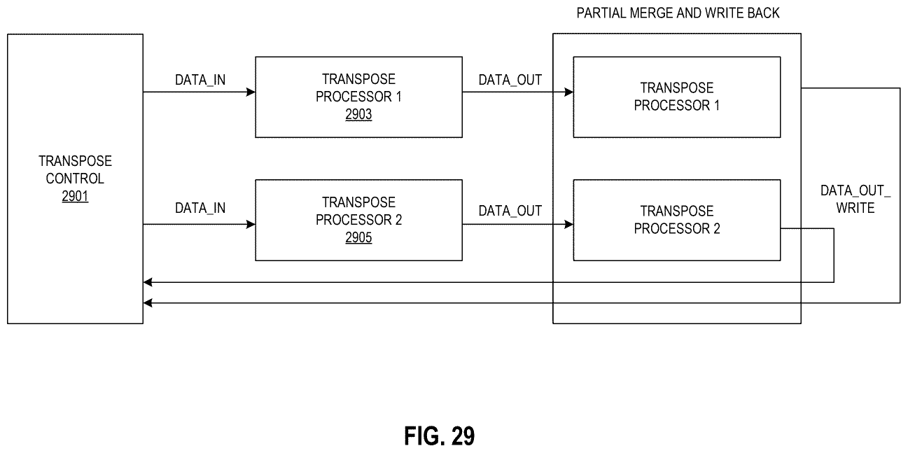

In some examples, the use of transpose processors is scalable. For example, to increase the throughput from a half row per cycle to one row per cycle the hardware is replicated. Partial writes are collected and then write requests are issued after merging the partial writes. FIG. 29 illustrates examples of scaling. As shown, the transpose control circuitry 2901 is coupled to two transpose processors (transpose processor 1 2903 and transpose processor 2 2905). Their outputs are merged and provided back to the transpose control 2901 for write out to memory.

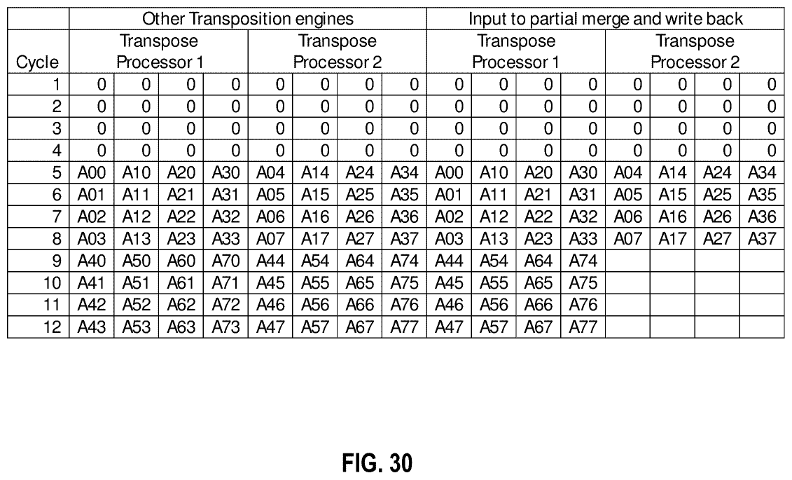

In this illustration, one row of memory is read and fed it to both transpose processors 2903 and 2905 either in serial manner (control==0) or in parallel manner (control==1). FIG. 30 illustrates examples of output processing.

Output from the transpose processor 1 2903 and transpose processor 2 2905 are written directly back to themselves as shown in the partial merge and write back block. Once the transpose processors are full, only one of the transpose processors is loaded while the other is held without affecting the previous value.

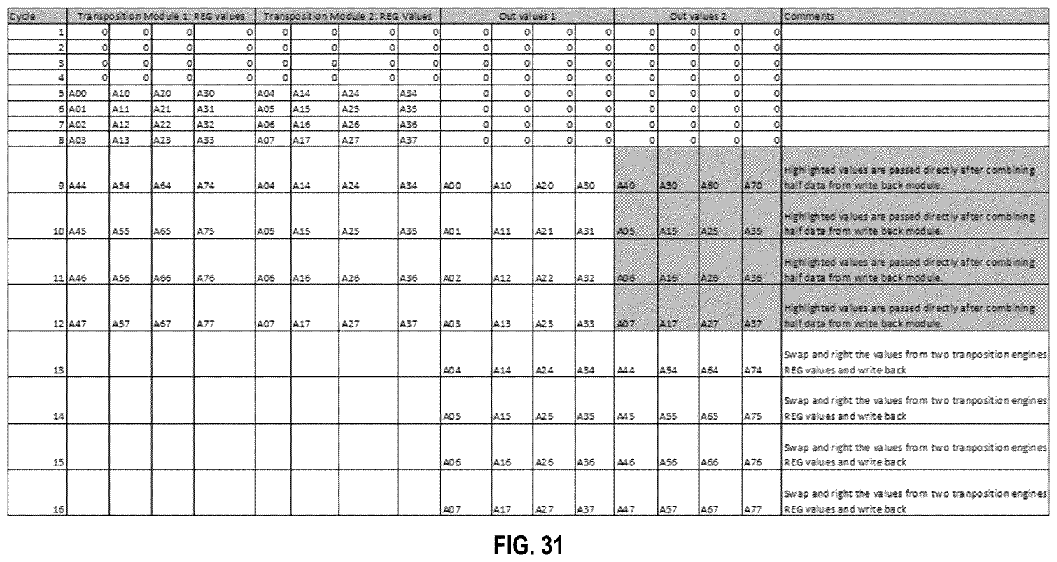

FIG. 31 illustrates example data flows inside the partial merge and write back block. From cycle 5 onward the transposition processor 1 2903 and transpose processor 2 2905 start writing out values to partial merge and write back block as shown in the previous table. Each output is directly stored in the partial merge blocks. Once the transpose processors in the partial merge block are full, from cycle 9 onwards the transposed data is written back to memory. During the first four cycles of write, half of the output (4 elements) is merged from partial merge block and the other half is directly read from the input to the partial block while remaining inputs are stored in the location within partial merge block from where the 4 elements of were pushed out to the write bus. This continues for four cycles and then the groups of 4 elements are swapped within the partial merge and then more write requests are issued. With each write from cycle 13 onward one location from each transposition processor are read which helps in pipelining the further processing in case of larger matrix dimensions.

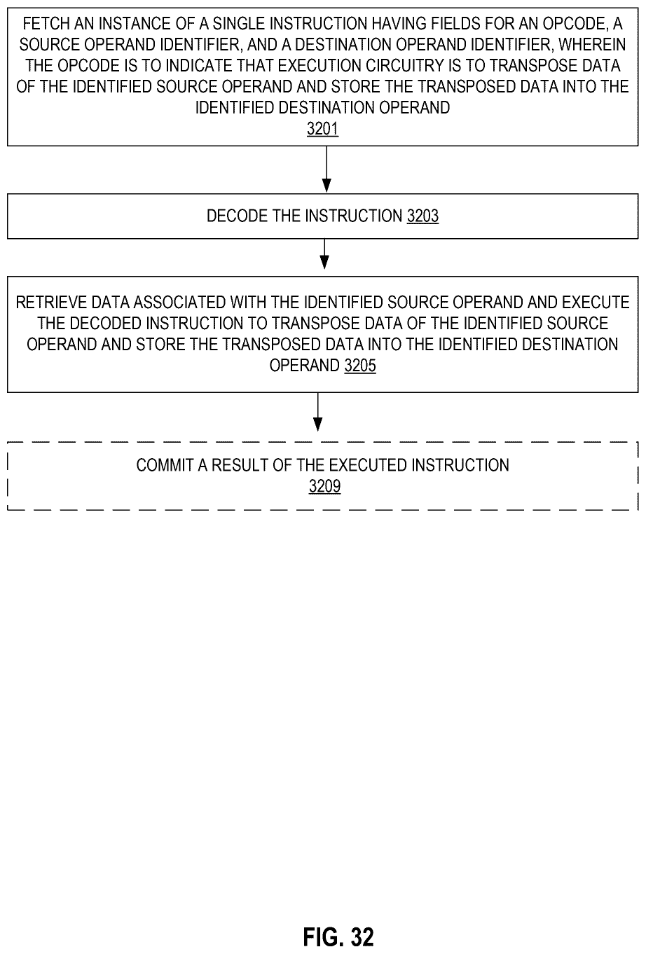

FIG. 32 illustrates an example method to process a TTMM instruction. In some examples, transpose circuitry 2221 performs at least some of these operations. However, some operations such as fetch and decode may be performed in a host processor.

At 3201, an instance of single instruction is fetched. For example, a TTMM instruction is fetched. the instruction includes fields for an opcode, a source operand identifier, and a destination operand identifier, wherein the opcode is to indicate that execution circuitry is to transpose data of the identified source operand and store the transposed data into the identified destination operand. The source operand identifier may be for a tile or a memory location storing a tile. The destination operand identifier may be for a tile or a memory location for storing a tile.

The fetched instruction is decoded at 3203. For example, the fetched TTMM instruction is decoded by decoder circuitry such as decoder circuitry 'ISAB05, decoder 2205, or decode circuitry 4240 detailed herein.

Data associated with the identified source operand is retrieved and the decoded instruction is executed by the transpose circuitry 2221 to transpose data of the identified source operand and store the transposed data into the identified destination operand at 3205. Note that the execution may use one or more alternating memory row reads, alternating writes, reading memory locations twice, writing out in multiple cycles, etc.

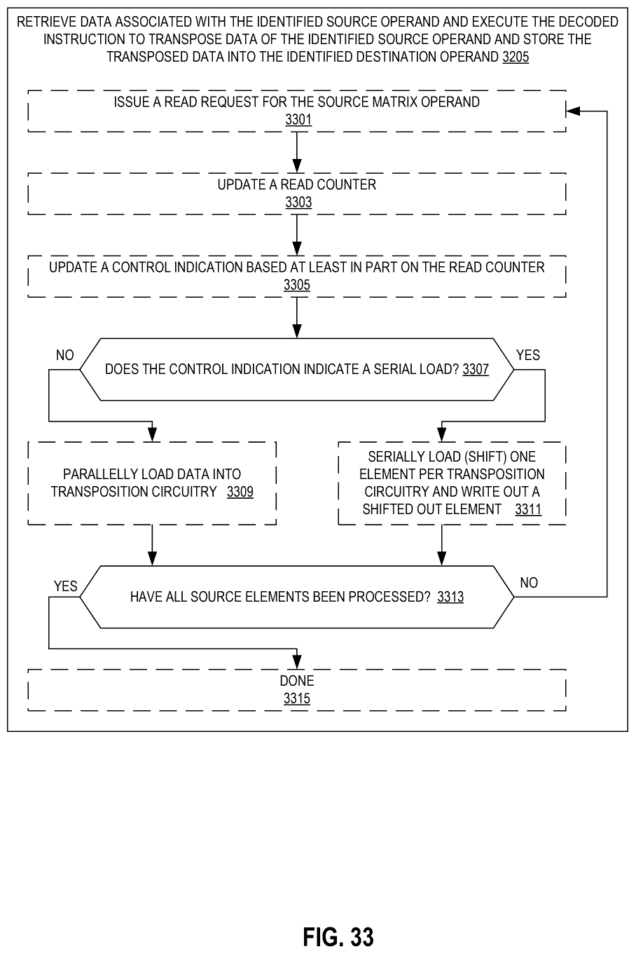

FIG. 33 illustrates examples of execution and source operand retrieval. In some examples, at 3301 a read request is issued for a source matrix operand. This request may be to memory or a tile (e.g., registers). In some examples, the read logic and address generation circuitry 2207 generates the request. In some examples, memory control 2203 performs the read, and/or using replication as detailed above.

A read counter is updated at 3303. For example, a read counter maintained by read/write control 2209. A control indication is updated, for example, by read/write control. 2209, based at least in part on the read counter at 3305. Examples of these updating have been discussed above.

A determination of if the control indication indicates a serial load is made at 3307. In some examples, the control indication is used to make this determination. If a serial load is not indicated, then data is parallelly loaded into a transpose engine (or other transposition circuitry) at 3309. If a serial load is indicated, then a serially load (shift) of one element per transposition circuitry and write out of a shifted out element is performed at 3311.

A determination is made of if all source elements been processed is made at 3313. In particular, have all of the transpose engines had all of their data written out? If not, then another read request is issued, etc. If yes, then the execution can complete at 3315.

In some examples, the instruction is committed or retired at 3209.

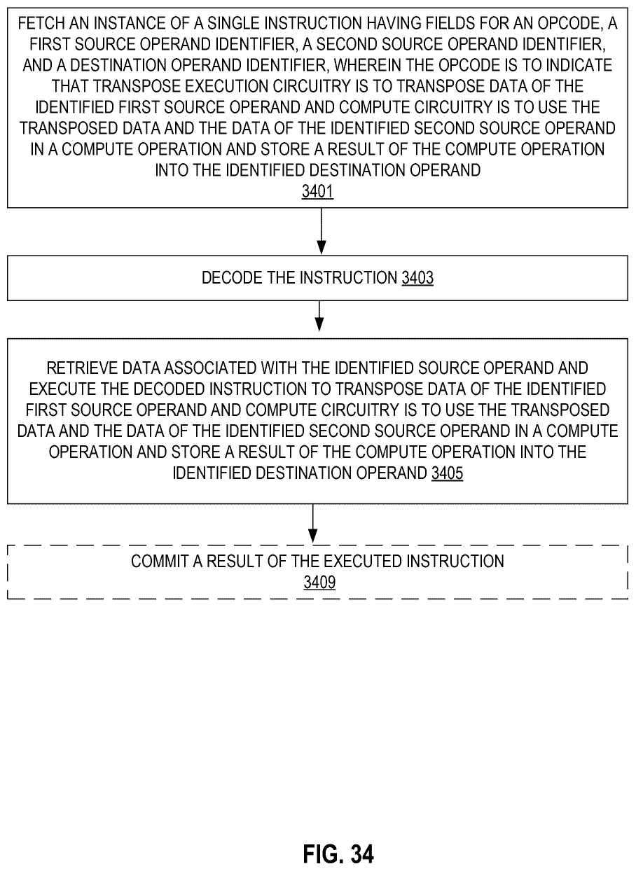

FIG. 34 illustrates an example method to process a TTCOMPUTE instruction. In some examples, transpose circuitry 2221 performs at least some of these operations. However, some operations such as fetch and decode may be performed in a host processor. Additionally, the compute is performed by a matrix operations accelerator such as matrix operations accelerator 2207.

At 3401, an instance of single instruction is fetched. For example, a TTCOMPUTE instruction is fetched. the instruction includes Fields for an opcode, a first source operand identifier, a second source operand identifier, and a destination operand identifier, wherein the opcode is to indicate that transpose execution circuitry is to transpose data of the identified first source operand and compute circuitry is to use the transposed data and the data of the identified second source operand in a compute operation and store a result of the compute operation into the identified destination operand. One or more of the source operand identifiers may be for a tile or a memory location storing a tile. The destination operand identifier may be for a tile or a memory location for storing a tile. In some examples, the transposed data is stored.

The fetched instruction is decoded at 3403. For example, the fetched TTCOMPUTE instruction is decoded by decoder circuitry such as decoder circuitry 'ISAB05, decoder 2205, or decode circuitry 4240 detailed herein.

Data associated with the identified source operands is retrieved and the decoded instruction is executed by the transpose circuitry 2221 and a matrix operations accelerator 2207 to transpose data of the identified first source operand and compute circuitry is to use the transposed data and the data of the identified second source operand in a compute operation and store a result of the compute operation into the identified destination operand at 3405. In some examples, the transposed data is stored. Note that the execution may use one or more alternating memory row reads, alternating writes, reading memory locations twice, writing out in multiple cycles, etc. Note the operations of FIG. 33 apply in some examples for the transposing of data.

In some examples, the instruction is committed or retired at 3409.

Some examples utilize instruction formats described herein. Some examples are implemented in one or more computer architectures, cores, accelerators, etc. Some examples are generated or are IP cores. Some examples utilize emulation and/or translation.

### Example Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

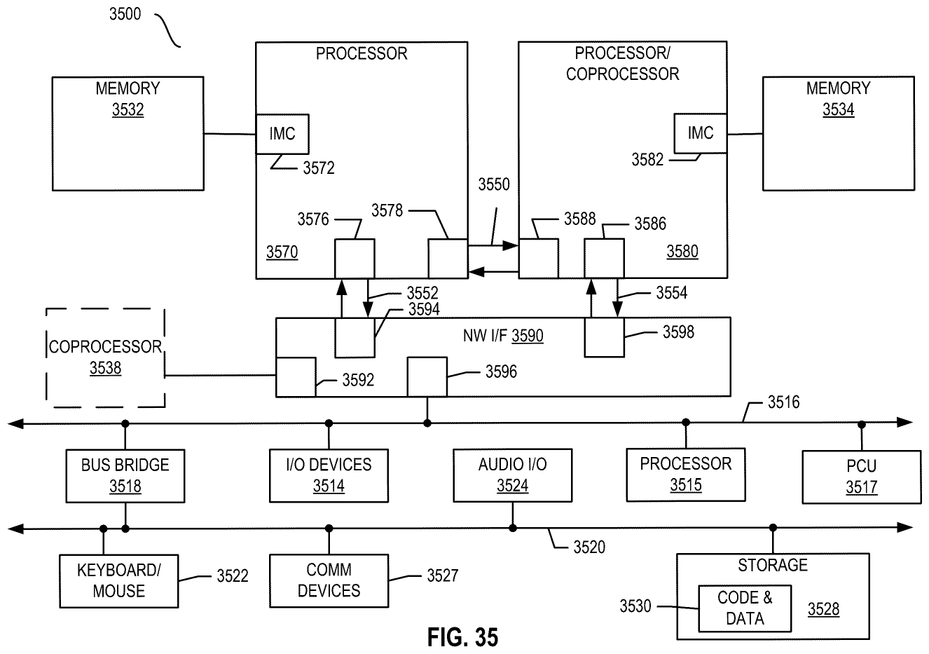

FIG. 35 illustrates an example computing system. Multiprocessor system 3500 is an interfaced system and includes a plurality of processors or cores including a first processor 3570 and a second processor 3580 coupled via an interface 3550 such as a point-to-point (P-P) interconnect, a fabric, and/or bus. In some examples, the first processor 3570 and the second processor 3580 are homogeneous. In some examples, first processor 3570 and the second processor 3580 are heterogenous. Though the example multiprocessor system 3500 is shown to have two processors, the system may have three or more processors, or may be a single processor system. In some examples, the computing system is a system on a chip (SoC).

Processors 3570 and 3580 are shown including integrated memory controller (IMC) circuitry 3572 and 3582, respectively. Processor 3570 also includes interface circuits 3576 and 3578; similarly, second processor 3580 includes interface circuits 3586 and 3588. Processors 3570, 3580 may exchange information via the interface 3550 using interface circuits 3578, 3588. IMCs 3572 and 3582 couple the processors 3570, 3580 to respective memories, namely a memory 3532 and a memory 3534, which may be portions of main memory locally attached to the respective processors.

Processors 3570, 3580 may each exchange information with a network interface (NW I/F) 3590 via individual interfaces 3552, 3554 using interface circuits 3576, 3594, 3586, 3598. The network interface 3590 (e.g., one or more of an interconnect, bus, and/or fabric, and in some examples is a chipset) may optionally exchange information with a co-processor 3538 via an interface circuit 3592. In some examples, the co-processor 3538 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 3570, 3580 or outside of both processors, yet connected with the processors via an interface such as P-P interconnect, such that either or both processors' local cache information may be stored in the shared cache if a processor is placed into a low power mode.

Network interface 3590 may be coupled to a first interface 3516 via interface circuit 3596. In some examples, first interface 3516 may be an interface such as a Peripheral Component Interconnect (PCI) interconnect, a PCI Express interconnect or another I/O interconnect. In some examples, first interface 3516 is coupled to a power control unit (PCU) 3517, which may include circuitry, software, and/or firmware to perform power management operations with regard to the processors 3570, 3580 and/or co-processor 3538. PCU 3517 provides control information to a voltage regulator (not shown) to cause the voltage regulator to generate the appropriate regulated voltage. PCU 3517 also provides control information to control the operating voltage generated. In various examples, PCU 3517 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 3517 is illustrated as being present as logic separate from the processor 3570 and/or processor 3580. In other cases, PCU 3517 may execute on a given one or more of cores (not shown) of processor 3570 or 3580. In some cases, PCU 3517 may be implemented as a microcontroller (dedicated or general-purpose) or other control logic configured to execute its own dedicated power management code, sometimes referred to as P-code. In yet other examples, power management operations to be performed by PCU 3517 may be implemented externally to a processor, such as by way of a separate power management integrated circuit (PMIC) or another component external to the processor. In yet other examples, power management operations to be performed by PCU 3517 may be implemented within BIOS or other system software.

Various I/O devices 3514 may be coupled to first interface 3516, along with a bus bridge 3518 which couples first interface 3516 to a second interface 3520. In some examples, one or more additional processor(s) 3515, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 3516. In some examples, second interface 3520 may be a low pin count (LPC) interface. Various devices may be coupled to second interface 3520 including, for example, a keyboard and/or mouse 3522, communication devices 3527 and storage circuitry 3528. Storage circuitry 3528 may be one or more non-transitory machine-readable storage media as described below, such as a disk drive or other mass storage device which may include instructions/code and data 3530 and may implement the storage 3503 in some examples. Further, an audio I/O 3524 may be coupled to second interface 3520. Note that other architectures than the point-to-point architecture described above are possible. For example, instead of the point-to-point architecture, a system such as multiprocessor system 3500 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

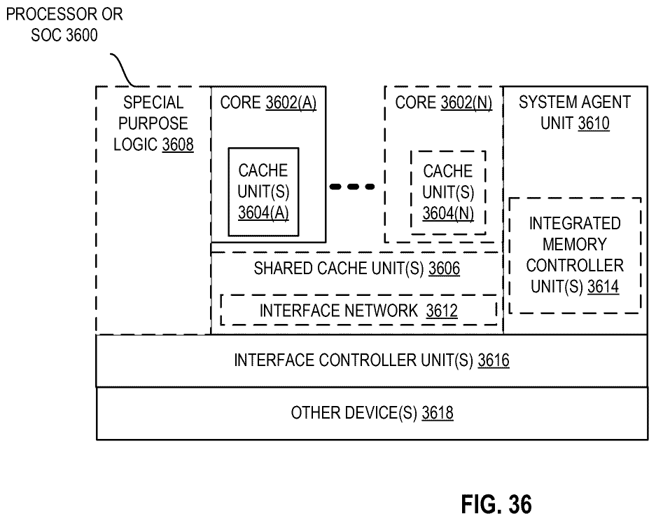

FIG. 36 illustrates a block diagram of an example processor and/or SoC 3600 that may have one or more cores and an integrated memory controller. The solid lined boxes illustrate a processor and/or SoC 3600 with a single core 3602(A), system agent unit circuitry 3610, and a set of one or more interface controller unit(s) circuitry 3616, while the optional addition of the dashed lined boxes illustrates an alternative processor and/or SoC 3600 with multiple cores 3602(A)-(N), a set of one or more integrated memory controller unit(s) circuitry 3614 in the system agent unit circuitry 3610, and special purpose logic 3608, as well as a set of one or more interface controller unit(s) circuitry 3616. Note that the processor and/or SoC 3600 may be one of the processors 3570 or 3580, or co-processor 3538 or 3515 of FIG. 35.

Thus, different implementations of the processor and/or SoC 3600 may include: 1) a CPU with the special purpose logic 3608 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 3602(A)-(N) being one or more general purpose cores (e.g., general purpose in-order cores, general purpose out-of-order cores, or a combination of the two); 2) a co-processor with the cores 3602(A)-(N) being a large number of special purpose cores intended primarily for graphics and/or scientific (throughput); and 3) a co-processor with the cores 3602(A)-(N) being a large number of general purpose in-order cores. Thus, the processor and/or SoC 3600 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 3600 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 3604(A)-(N) within the cores 3602(A)-(N), a set of one or more shared cache unit(s) circuitry 3606, and external memory (not shown) coupled to the set of integrated memory controller unit(s) circuitry 3614. The set of one or more shared cache unit(s) circuitry 3606 may include one or more mid-level caches, such as level 2 (L2), level 3 (L3), level 4 (L4), or other levels of cache, such as a last level cache (LLC), and/or combinations thereof. While in some examples interface network circuitry 3612 (e.g., a ring interconnect) interfaces the special purpose logic 3608 (e.g., integrated graphics logic), the set of shared cache unit(s) circuitry 3606, and the system agent unit circuitry 3610, alternative examples use any number of well-known techniques for interfacing such units. In some examples, coherency is maintained between one or more of the shared cache unit(s) circuitry 3606 and cores 3602(A)-(N). In some examples, interface controller unit(s) circuitry 3616 couple the cores 3602(A)-(N) to one or more other devices 3618 such as one or more I/O devices, storage, one or more communication devices (e.g., wireless networking, wired networking, etc.), etc.

In some examples, one or more of the cores 3602(A)-(N) are capable of multi-threading. The system agent unit circuitry 3610 includes those components coordinating and operating cores 3602(A)-(N). The system agent unit circuitry 3610 may include, for example, power control unit (PCU) circuitry and/or display unit circuitry (not shown). The PCU may be or may include logic and components needed for regulating the power state of the cores 3602(A)-(N) and/or the special purpose logic 3608 (e.g., integrated graphics logic). The display unit circuitry is for driving one or more externally connected displays.

The cores 3602(A)-(N) may be homogenous in terms of instruction set architecture (ISA). Alternatively, the cores 3602(A)-(N) may be heterogeneous in terms of ISA; that is, a subset of the cores 3602(A)-(N) may be capable of executing an ISA, while other cores may be capable of executing only a subset of that ISA or another ISA.

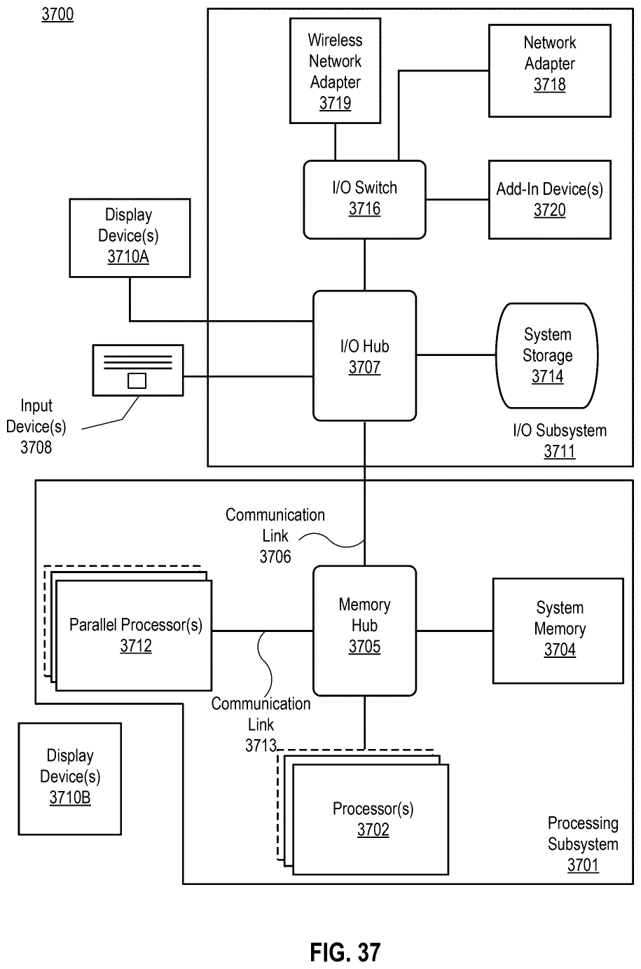

FIG. 37 is a block diagram illustrating a computing system 3700 configured to implement one or more aspects of the examples described herein. The computing system 3700 includes a processing subsystem 3701 having one or more processor(s) 3702 and a system memory 3704 communicating via an interconnection path that may include a memory hub 3705. The memory hub 3705 may be a separate component within a chipset component or may be integrated within the one or more processor(s) 3702. The memory hub 3705 couples with an I/O subsystem 3711 via a communication link 3706. The I/O subsystem 3711 includes an I/O hub 3707 that can enable the computing system 3700 to receive input from one or more input device(s) 3708. Additionally, the I/O hub 3707 can enable a display controller, which may be included in the one or more processor(s) 3702, to provide outputs to one or more display device(s) 3710A. In some examples the one or more display device(s) 3710A coupled with the I/O hub 3707 can include a local, internal, or embedded display device.

The processing subsystem 3701, for example, includes one or more parallel processor(s) 3712 coupled to memory hub 3705 via a bus or communication link 3713. The communication link 3713 may be one of any number of standards-based communication link technologies or protocols, such as, but not limited to PCI Express, or may be a vendor specific communications interface or communications fabric. The one or more parallel processor(s) 3712 may form a computationally focused parallel or vector processing system that can include a large number of processing cores and/or processing clusters, such as a many integrated core (MIC) processor. For example, the one or more parallel processor(s) 3712 form a graphics processing subsystem that can output pixels to one of the one or more display device(s) 3710A coupled via the I/O hub 3707. The one or more parallel processor(s) 3712 can also include a display controller and display interface (not shown) to enable a direct connection to one or more display device(s) 3710B.

Within the I/O subsystem 3711, a system storage unit 3714 can connect to the I/O hub 3707 to provide a storage mechanism for the computing system 3700. An I/O switch 3716 can be used to provide an interface mechanism to enable connections between the I/O hub 3707 and other components, such as a network adapter 3718 and/or wireless network adapter 3719 that may be integrated into the platform, and various other devices that can be added via one or more add-in device(s) 3720. The add-in device(s) 3720 may also include, for example, one or more external graphics processor devices, graphics cards, and/or compute accelerators. The network adapter 3718 can be an Ethernet adapter or another wired network adapter. The wireless network adapter 3719 can include one or more of a Wi-Fi, Bluetooth, near field communication (NFC), or other network device that includes one or more wireless radios.

The computing system 3700 can include other components not explicitly shown, including USB or other port connections, optical storage drives, video capture devices, and the like, which may also be connected to the I/O hub 3707. Communication paths interconnecting the various components in FIG. 37 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 3712 may incorporate circuitry optimized for graphics and video processing, including, for example, video output circuitry, and constitutes a graphics processing unit (GPU). Alternatively or additionally, the one or more parallel processor(s) 3712 can incorporate circuitry optimized for general purpose processing, while preserving the underlying computational architecture, described in greater detail herein. Components of the computing system 3700 may be integrated with one or more other system elements on a single integrated circuit. For example, the one or more parallel processor(s) 3712, memory hub 3705, processor(s) 3702, and I/O hub 3707 can be integrated into a system on chip (SoC) integrated circuit. Alternatively, the components of the computing system 3700 can be integrated into a single package to form a system in package (SIP) configuration. In some examples at least a portion of the components of the computing system 3700 can be integrated into a multi-chip module (MCM), which can be interconnected with other multi-chip modules into a modular computing system.

It will be appreciated that the computing system 3700 shown herein is illustrative and that variations and modifications are possible. The connection topology, including the number and arrangement of bridges, the number of processor(s) 3702, and the number of parallel processor(s) 3712, may be modified as desired. For instance, system memory 3704 can be connected to the processor(s) 3702 directly rather than through a bridge, while other devices communicate with system memory 3704 via the memory hub 3705 and the processor(s) 3702. In other alternative topologies, the parallel processor(s) 3712 are connected to the I/O hub 3707 or directly to one of the one or more processor(s) 3702, rather than to the memory hub 3705. In other examples, the I/O hub 3707 and memory hub 3705 may be integrated into a single chip. It is also possible that two or more sets of processor(s) 3702 are attached via multiple sockets, which can couple with two or more instances of the parallel processor(s) 3712.

Some of the particular components shown herein are optional and may not be included in all implementations of the computing system 3700. For example, any number of add-in cards or peripherals may be supported, or some components may be eliminated. Furthermore, some architectures may use different terminology for components similar to those illustrated in FIG. 37. For example, the memory hub 3705 may be referred to as a Northbridge in some architectures, while the I/O hub 3707 may be referred to as a Southbridge.

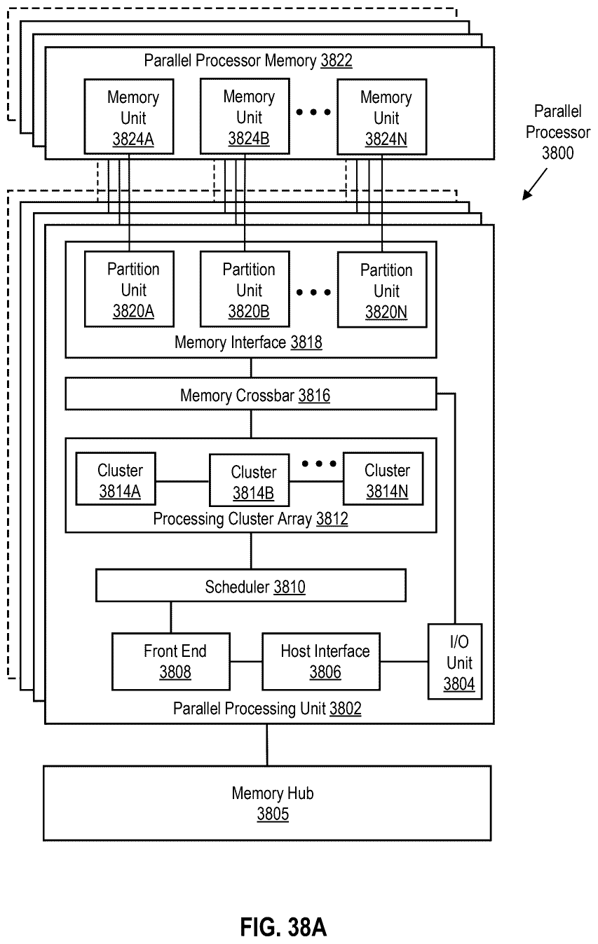

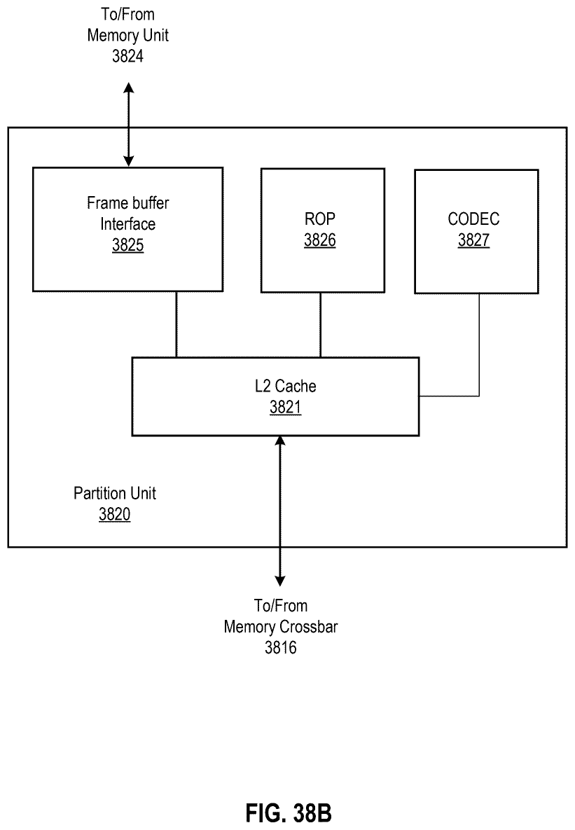

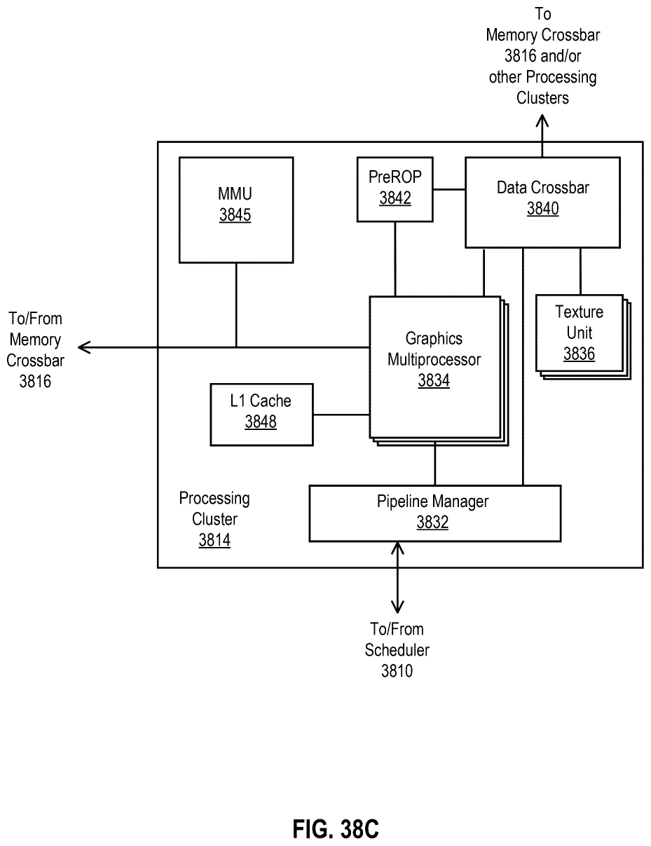

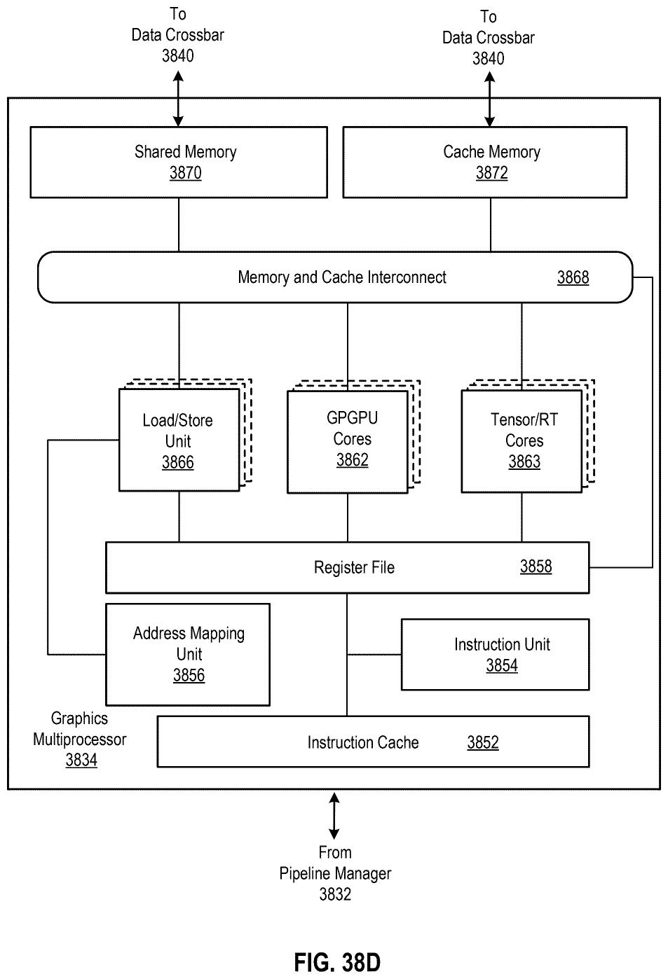

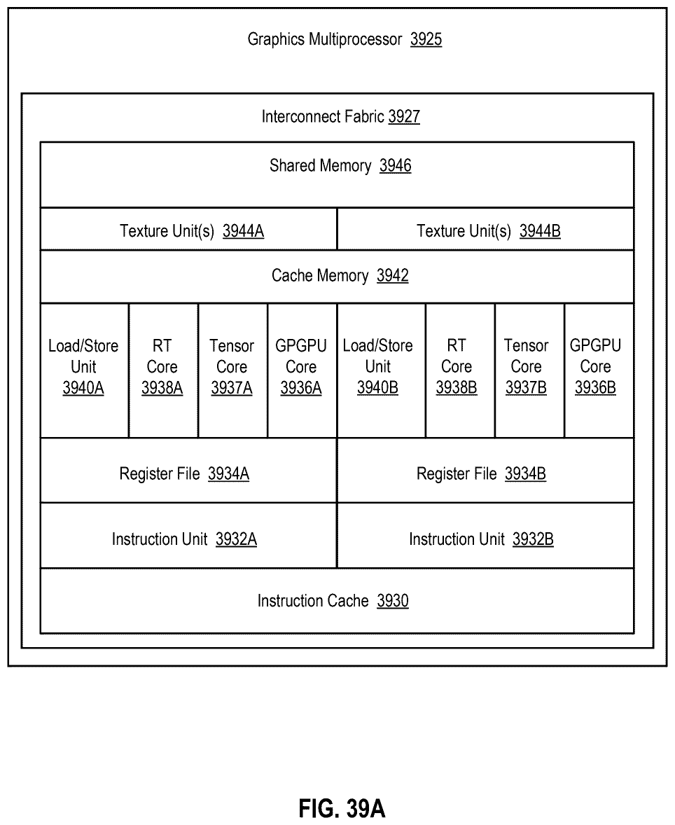

FIG. 38A illustrates examples of a parallel processor 3800. The parallel processor 3800 may be a GPU, GPGPU or the like as described herein. The various components of the parallel processor 3800 may be implemented using one or more integrated circuit devices, such as programmable processors, application specific integrated circuits (ASICs), or field programmable gate arrays (FPGA). The parallel processor 3800 may be one or more of the parallel processor(s) 3712 shown in FIG. 37.

The parallel processor 3800 includes a parallel processing unit 3802. The parallel processing unit includes an I/O unit 3804 that enables communication with other devices, including other instances of the parallel processing unit 3802. The I/O unit 3804 may be directly connected to other devices. For instance, the I/O unit 3804 connects with other devices via the use of a hub or switch interface, such as memory hub 3705. The connections between the memory hub 3705 and the I/O unit 3804 form a communication link 3713. Within the parallel processing unit 3802, the I/O unit 3804 connects with a host interface 3806 and a memory crossbar 3816, where the host interface 3806 receives commands directed to performing processing operations and the memory crossbar 3816 receives commands directed to performing memory operations.

When the host interface 3806 receives a command buffer via the I/O unit 3804, the host interface 3806 can direct work operations to perform those commands to a front end 3808. In some examples the front end 3808 couples with a scheduler 3810, which is configured to distribute commands or other work items to a processing cluster array 3812. The scheduler 3810 ensures that the processing cluster array 3812 is properly configured and in a valid state before tasks are distributed to the processing clusters of the processing cluster array 3812. The scheduler 3810 may be implemented via firmware logic executing on a microcontroller. The microcontroller implemented scheduler 3810 is configurable to perform complex scheduling and work distribution operations at coarse and fine granularity, enabling rapid preemption and context switching of threads executing on the processing cluster array 3812. Preferably, the host software can prove workloads for scheduling on the processing cluster array 3812 via one of multiple graphics processing doorbells. In other examples, polling for new workloads or interrupts can be used to identify or indicate availability of work to perform. The workloads can then be automatically distributed across the processing cluster array 3812 by the scheduler 3810 logic within the scheduler microcontroller.

The processing cluster array 3812 can include up to “N” processing clusters (e.g., cluster 3814A, cluster 3814B, through cluster 3814N). Each cluster 3814A-3814N of the processing cluster array 3812 can execute a large number of concurrent threads. The scheduler 3810 can allocate work to the clusters 3814A-3814N of the processing cluster array 3812 using various scheduling and/or work distribution algorithms, which may vary depending on the workload arising for each type of program or computation. The scheduling can be handled dynamically by the scheduler 3810 or can be assisted in part by compiler logic during compilation of program logic configured for execution by the processing cluster array 3812. Optionally, different clusters 3814A-3814N of the processing cluster array 3812 can be allocated for processing different types of programs or for performing different types of computations.

The processing cluster array 3812 can be configured to perform various types of parallel processing operations. For example, the processing cluster array 3812 is configured to perform general-purpose parallel compute operations. For example, the processing cluster array 3812 can include logic to execute processing tasks including filtering of video and/or audio data, performing modeling operations, including physics operations, and performing data transformations.

The processing cluster array 3812 is configured to perform parallel graphics processing operations. In such examples in which the parallel processor 3800 is configured to perform graphics processing operations, the processing cluster array 3812 can include additional logic to support the execution of such graphics processing operations, including, but not limited to texture sampling logic to perform texture operations, as well as tessellation logic and other vertex processing logic. Additionally, the processing cluster array 3812 can be configured to execute graphics processing related shader programs such as, but not limited to vertex shaders, tessellation shaders, geometry shaders, and pixel shaders. The parallel processing unit 3802 can transfer data from system memory via the I/O unit 3804 for processing. During processing the transferred data can be stored to on-chip memory (e.g., parallel processor memory 3822) during processing, then written back to system memory.

In examples in which the parallel processing unit 3802 is used to perform graphics processing, the scheduler 3810 may be configured to divide the processing workload into approximately equal sized tasks, to better enable distribution of the graphics processing operations to multiple clusters 3814A-3814N of the processing cluster array 3812. In some of these examples, portions of the processing cluster array 3812 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 3814A-3814N may be stored in buffers to allow the intermediate data to be transmitted between clusters 3814A-3814N for further processing.

During operation, the processing cluster array 3812 can receive processing tasks to be executed via the scheduler 3810, which receives commands defining processing tasks from front end 3808. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 3810 may be configured to fetch the indices corresponding to the tasks or may receive the indices from the front end 3808. The front end 3808 can be configured to ensure the processing cluster array 3812 is configured to a valid state before the workload specified by incoming command buffers (e.g., batch-buffers, push buffers, etc.) is initiated.

Each of the one or more instances of the parallel processing unit 3802 can couple with parallel processor memory 3822. The parallel processor memory 3822 can be accessed via the memory crossbar 3816, which can receive memory requests from the processing cluster array 3812 as well as the I/O unit 3804. The memory crossbar 3816 can access the parallel processor memory 3822 via a memory interface 3818. The memory interface 3818 can include multiple partition units (e.g., partition unit 3820A, partition unit 3820B, through partition unit 3820N) that can each couple to a portion (e.g., memory unit) of parallel processor memory 3822. The number of partition units 3820A-3820N may be configured to be equal to the number of memory units, such that a first partition unit 3820A has a corresponding first memory unit 3824A, a second partition unit 3820B has a corresponding second memory unit 3824B, and an Nth partition unit 3820N has a corresponding Nth memory unit 3824N. In other examples, the number of partition units 3820A-3820N may not be equal to the number of memory devices.

The memory units 3824A-3824N can include various types of memory devices, including dynamic random-access memory (DRAM) or graphics random access memory, such as synchronous graphics random access memory (SGRAM), including graphics double data rate (GDDR) memory. Optionally, the memory units 3824A-3824N may also include 3D stacked memory, including but not limited to high bandwidth memory (HBM). Persons skilled in the art will appreciate that the specific implementation of the memory units 3824A-3824N can vary and can be selected from one of various conventional designs. Render targets, such as frame buffers or texture maps may be stored across the memory units 3824A-3824N, allowing partition units 3820A-3820N to write portions of each render target in parallel to efficiently use the available bandwidth of parallel processor memory 3822. In some examples, a local instance of the parallel processor memory 3822 may be excluded in favor of a unified memory design that utilizes system memory in conjunction with local cache memory.

Optionally, any one of the clusters 3814A-3814N of the processing cluster array 3812 has the ability to process data that will be written to any of the memory units 3824A-3824N within parallel processor memory 3822. The memory crossbar 3816 can be configured to transfer the output of each cluster 3814A-3814N to any partition unit 3820A-3820N or to another cluster 3814A-3814N, which can perform additional processing operations on the output. Each cluster 3814A-3814N can communicate with the memory interface 3818 through the memory crossbar 3816 to read from or write to various external memory devices. In one of the examples with the memory crossbar 3816 the memory crossbar 3816 has a connection to the memory interface 3818 to communicate with the I/O unit 3804, as well as a connection to a local instance of the parallel processor memory 3822, enabling the processing units within the different processing clusters 3814A-3814N to communicate with system memory or other memory that is not local to the parallel processing unit 3802. Generally, the memory crossbar 3816 may, for example, be able to use virtual channels to separate traffic streams between the clusters 3814A-3814N and the partition units 3820A-3820N.

While a single instance of the parallel processing unit 3802 is illustrated within the parallel processor 3800, any number of instances of the parallel processing unit 3802 can be included. For example, multiple instances of the parallel processing unit 3802 can be provided on a single add-in card, or multiple add-in cards can be interconnected. For example, the parallel processor 3800 can be an add-in device, such as add-in device(s) 3720 of FIG. 37, which may be a graphics card such as a discrete graphics card that includes one or more GPUs, one or more memory devices, and device-to-device or network or fabric interfaces. The different instances of the parallel processing unit 3802 can be configured to inter-operate even if the different instances have different numbers of processing cores, different amounts of local parallel processor memory, and/or other configuration differences. Optionally, some instances of the parallel processing unit 3802 can include higher precision floating point units relative to other instances. Systems incorporating one or more instances of the parallel processing unit 3802 or the parallel processor 3800 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 3802 can be partitioned into multiple instances. Those multiple instances can be configured to execute workloads associated with different clients in an isolated manner, enabling a pre-determined quality of service to be provided for each client. For example, each cluster 3814A-3814N can be compartmentalized and isolated from other clusters, allowing the processing cluster array 3812 to be divided into multiple compute partitions or instances. In such configuration, workloads that execute on an isolated partition are protected from faults or errors associated with a different workload that executes on a different partition. The partition units 3820A-3820N can be configured to enable a dedicated and/or isolated path to memory for the clusters 3814A-3814N associated with the respective compute partitions. This datapath isolation enables the compute resources within a partition can communicate with one or more assigned memory units 3824A-3824N without being subjected to inference by the activities of other partitions.

FIG. 38B is a block diagram of a partition unit 3820. The partition unit 3820 may be an instance of one of the partition units 3820A-3820N of FIG. 38A. As illustrated, the partition unit 3820 includes an L2 cache 3821, a frame buffer interface 3825, and a ROP 3826 (raster operations unit). The L2 cache 3821 is a read/write cache that is configured to perform load and store operations received from the memory crossbar 3816 and ROP 3826. Read misses and urgent write-back requests are output by L2 cache 3821 to frame buffer interface 3825 for processing. Updates can also be sent to the frame buffer via the frame buffer interface 3825 for processing. In some examples the frame buffer interface 3825 interfaces with one of the memory units in parallel processor memory, such as the memory units 3824A-3824N of FIG. 38A (e.g., within parallel processor memory 3822). The partition unit 3820 may additionally or alternatively also interface with one of the memory units in parallel processor memory via a memory controller (not shown).

In graphics applications, the ROP 3826 is a processing unit that performs raster operations such as stencil, z test, blending, and the like. The ROP 3826 then outputs processed graphics data that is stored in graphics memory. In some examples the ROP 3826 includes or couples with a CODEC 3827 that includes compression logic to compress depth or color data that is written to memory or the L2 cache 3821 and decompress depth or color data that is read from memory or the L2 cache 3821. The compression logic can be lossless compression logic that makes use of one or more of multiple compression algorithms. The type of compression that is performed by the CODEC 3827 can vary based on the statistical characteristics of the data to be compressed. For example, in some examples, delta color compression is performed on depth and color data on a per-tile basis. In some examples the CODEC 3827 includes compression and decompression logic that can compress and decompress compute data associated with machine learning operations. The CODEC 3827 can, for example, compress sparse matrix data for sparse machine learning operations. The CODEC 3827 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 3826 may be included within each processing cluster (e.g., cluster 3814A-3814N of FIG. 38A) instead of within the partition unit 3820. In such example, read and write requests for pixel data are transmitted over the memory crossbar 3816 instead of pixel fragment data. The processed graphics data may be displayed on a display device, such as one of the one or more display device(s) 3710A-3710B of FIG. 37, routed for further processing by the processor(s) 3702, or routed for further processing by one of the processing entities within the parallel processor 3800 of FIG. 38A.

FIG. 38C is a block diagram of a processing cluster 3814 within a parallel processing unit. For example, the processing cluster is an instance of one of the processing clusters 3814A-3814N of FIG. 38A. The processing cluster 3814 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of the processing cluster 3814 can be controlled via a pipeline manager 3832 that distributes processing tasks to SIMT parallel processors. The pipeline manager 3832 receives instructions from the scheduler 3810 of FIG. 38A and manages execution of those instructions via a graphics multiprocessor 3834 and/or a texture unit 3836. The graphics multiprocessor 3834 is an exemplary instance of a SIMT parallel processor. However, various types of SIMT parallel processors of differing architectures may be included within the processing cluster 3814. One or more instances of the graphics multiprocessor 3834 can be included within a processing cluster 3814. The graphics multiprocessor 3834 can process data and a data crossbar 3840 can be used to distribute the processed data to one of multiple possible destinations, including other shader units. The pipeline manager 3832 can facilitate the distribution of processed data by specifying destinations for processed data to be distributed via the data crossbar 3840.

Each graphics multiprocessor 3834 within the processing cluster 3814 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 3814 constitute a thread. A set of threads executing across the set of parallel processing engines is a thread group. A thread group executes the same program on different input data. Each thread within a thread group can be assigned to a different processing engine within a graphics multiprocessor 3834. A thread group may include fewer threads than the number of processing engines within the graphics multiprocessor 3834. When a thread group includes fewer threads than the number of processing engines, one or more of the processing engines may be idle during cycles in which that thread group is being processed. A thread group may also include more threads than the number of processing engines within the graphics multiprocessor 3834. When the thread group includes more threads than the number of processing engines within the graphics multiprocessor 3834, processing can be performed over consecutive clock cycles. Optionally, multiple thread groups can be executed concurrently on the graphics multiprocessor 3834.

The graphics multiprocessor 3834 may include an internal cache memory to perform load and store operations. Optionally, the graphics multiprocessor 3834 can forego an internal cache and use a cache memory (e.g., level 1 (L1) cache 3848) within the processing cluster 3814. Each graphics multiprocessor 3834 also has access to level 2 (L2) caches within the partition units (e.g., partition units 3820A-3820N of FIG. 38A) that are shared among all processing clusters 3814 and may be used to transfer data between threads. The graphics multiprocessor 3834 may also access off-chip global memory, which can include one or more of local parallel processor memory and/or system memory. Any memory external to the parallel processing unit 3802 may be used as global memory. Embodiments in which the processing cluster 3814 includes multiple instances of the graphics multiprocessor 3834 can share common instructions and data, which may be stored in the L1 cache 3848.

Each processing cluster 3814 may include an MMU 3845 (memory management unit) that is configured to map virtual addresses into physical addresses. In other examples, one or more instances of the MMU 3845 may reside within the memory interface 3818 of FIG. 38A. The MMU 3845 includes a set of page table entries (PTEs) used to map a virtual address to a physical address of a tile and optionally a cache line index. The MMU 3845 may include address translation lookaside buffers (TLB) or caches that may reside within the graphics multiprocessor 3834 or the L1 cache 3848 of processing cluster 3814. The physical address is processed to distribute surface data access locality to allow efficient request interleaving among partition units. The cache line index may be used to determine whether a request for a cache line is a hit or miss.

In graphics and computing applications, a processing cluster 3814 may be configured such that each graphics multiprocessor 3834 is coupled to a texture unit 3836 for performing texture mapping operations, e.g., determining texture sample positions, reading texture data, and filtering the texture data. Texture data is read from an internal texture L1 cache (not shown) or in some examples from the L1 cache within graphics multiprocessor 3834 and is fetched from an L2 cache, local parallel processor memory, or system memory, as needed. Each graphics multiprocessor 3834 outputs processed tasks to the data crossbar 3840 to provide the processed task to another processing cluster 3814 for further processing or to store the processed task in an L2 cache, local parallel processor memory, or system memory via the memory crossbar 3816. A preROP 3842 (pre-raster operations unit) is configured to receive data from graphics multiprocessor 3834, direct data to ROP units, which may be located with partition units as described herein (e.g., partition units 3820A-3820N of FIG. 38A). The preROP 3842 unit can perform optimizations for color blending, organize pixel color data, and perform address translations.

It will be appreciated that the core architecture described herein is illustrative and that variations and modifications are possible. Any number of processing units, e.g., graphics multiprocessor 3834, texture units 3836, preROPs 3842, etc., may be included within a processing cluster 3814. Further, while only one processing cluster 3814 is shown, a parallel processing unit as described herein may include any number of instances of the processing cluster 3814. Optionally, each processing cluster 3814 can be configured to operate independently of other processing clusters 3814 using separate and distinct processing units, L1 caches, L2 caches, etc.

FIG. 38D shows an example of the graphics multiprocessor 3834 in which the graphics multiprocessor 3834 couples with the pipeline manager 3832 of the processing cluster 3814. The graphics multiprocessor 3834 has an execution pipeline including but not limited to an instruction cache 3852, an instruction unit 3854, an address mapping unit 3856, a register file 3858, one or more general purpose graphics processing unit (GPGPU) cores 3862, and one or more load/store units 3866. The GPGPU cores 3862 and load/store units 3866 are coupled with cache memory 3872 and shared memory 3870 via a memory and cache interconnect 3868. The graphics multiprocessor 3834 may additionally include tensor and/or ray-tracing cores 3863 that include hardware logic to accelerate matrix and/or ray-tracing operations.

The instruction cache 3852 may receive a stream of instructions to execute from the pipeline manager 3832. The instructions are cached in the instruction cache 3852 and dispatched for execution by the instruction unit 3854. The instruction unit 3854 can dispatch instructions as thread groups (e.g., warps), with each thread of the thread group assigned to a different execution unit within GPGPU core 3862. An instruction can access any of a local, shared, or global address space by specifying an address within a unified address space. The address mapping unit 3856 can be used to translate addresses in the unified address space into a distinct memory address that can be accessed by the load/store units 3866.

The register file 3858 provides a set of registers for the functional units of the graphics multiprocessor 3834. The register file 3858 provides temporary storage for operands connected to the data paths of the functional units (e.g., GPGPU cores 3862, load/store units 3866) of the graphics multiprocessor 3834. The register file 3858 may be divided between each of the functional units such that each functional unit is allocated a dedicated portion of the register file 3858. For example, the register file 3858 may be divided between the different warps being executed by the graphics multiprocessor 3834.

The GPGPU cores 3862 can each include floating point units (FPUs) and/or integer arithmetic logic units (ALUs) that are used to execute instructions of the graphics multiprocessor 3834. In some implementations, the GPGPU cores 3862 can include hardware logic that may otherwise reside within the tensor and/or ray-tracing cores 3863. The GPGPU cores 3862 can be similar in architecture or can differ in architecture. For example and in some examples, a first portion of the GPGPU cores 3862 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 3834 can additionally include one or more fixed function or special function units to perform specific functions such as copy rectangle or pixel blending operations. One or more of the GPGPU cores can also include fixed or special function logic.

The GPGPU cores 3862 may include SIMD logic capable of performing a single instruction on multiple sets of data. Optionally, GPGPU cores 3862 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 3868 is an interconnect network that connects each of the functional units of the graphics multiprocessor 3834 to the register file 3858 and to the shared memory 3870. For example, the memory and cache interconnect 3868 is a crossbar interconnect that allows the load/store unit 3866 to implement load and store operations between the shared memory 3870 and the register file 3858. The register file 3858 can operate at the same frequency as the GPGPU cores 3862, thus data transfer between the GPGPU cores 3862 and the register file 3858 is very low latency. The shared memory 3870 can be used to enable communication between threads that execute on the functional units within the graphics multiprocessor 3834. The cache memory 3872 can be used as a data cache for example, to cache texture data communicated between the functional units and the texture unit 3836. The shared memory 3870 can also be used as a program managed cached. The shared memory 3870 and the cache memory 3872 can couple with the data crossbar 3840 to enable communication with other components of the processing cluster. Threads executing on the GPGPU cores 3862 can programmatically store data within the shared memory in addition to the automatically cached data that is stored within the cache memory 3872.

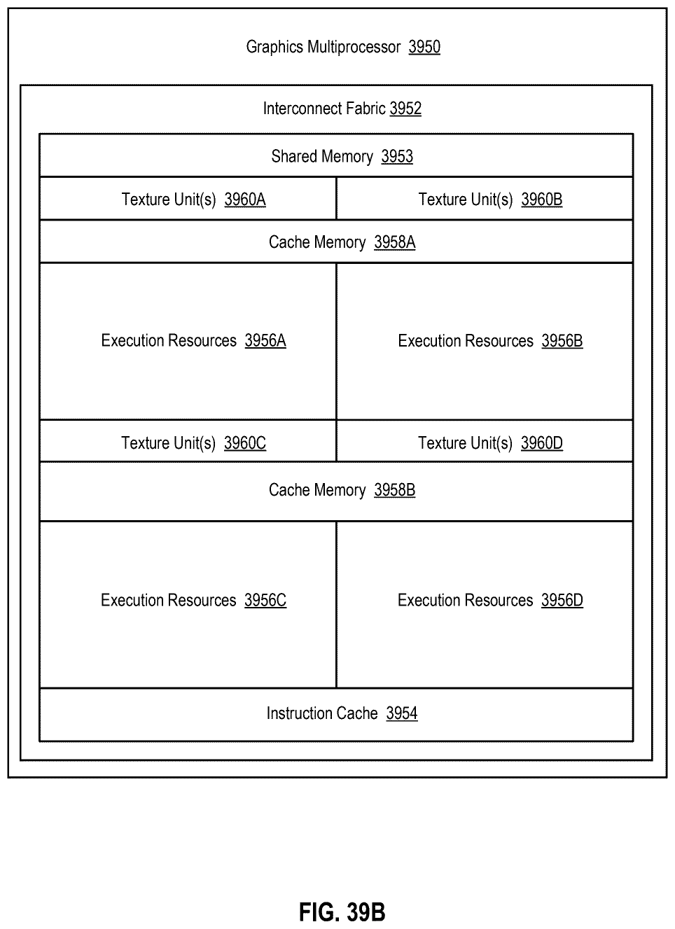

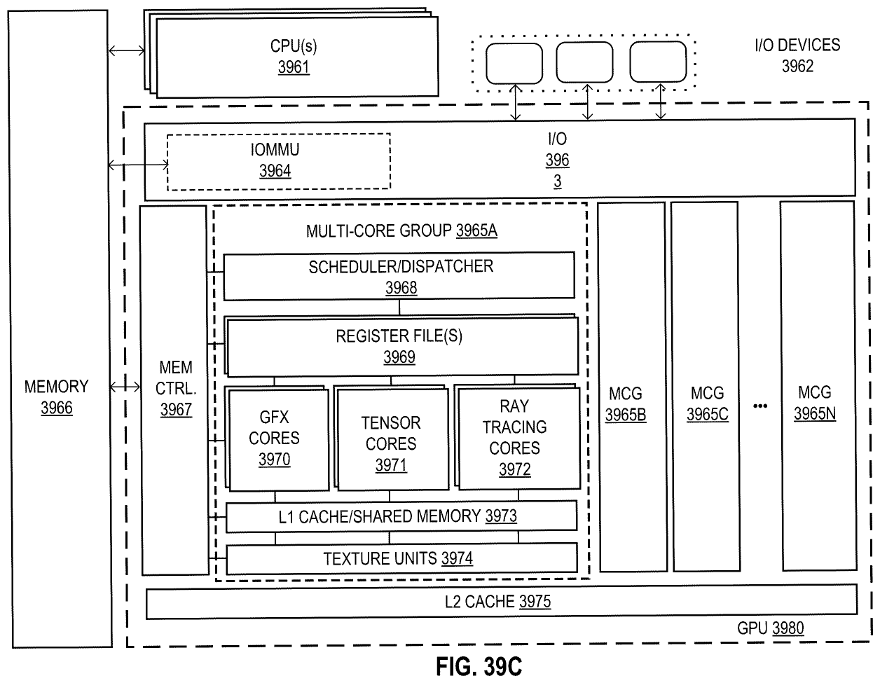

FIGS. 39A-39C illustrate additional graphics multiprocessors, according to examples. FIG. 39A-39B illustrate graphics multiprocessors 3925, 3950, which are related to the graphics multiprocessor 3834 of FIG. 38C and may be used in place of one of those. Therefore, the disclosure of any features in combination with the graphics multiprocessor 3834 herein also discloses a corresponding combination with the graphics multiprocessors 3925, 3950, but is not limited to such. FIG. 39C illustrates a graphics processing unit (GPU) 3980 which includes dedicated sets of graphics processing resources arranged into multi-core groups 3965A-3965N, which correspond to the graphics multiprocessors 3925, 3950. The illustrated graphics multiprocessors 3925, 3950 and the multi-core groups 3965A-3965N can be streaming multiprocessors (SM) capable of simultaneous execution of a large number of execution threads.

The graphics multiprocessor 3925 of FIG. 39A includes multiple additional instances of execution resource units relative to the graphics multiprocessor 3834 of FIG. 38D. For example, the graphics multiprocessor 3925 can include multiple instances of the instruction unit 3932A-3932B, register file 3934A-3934B, and texture unit(s) 3944A-3944B. The graphics multiprocessor 3925 also includes multiple sets of graphics or compute execution units (e.g., GPGPU core 3936A-3936B, tensor core 3937A-3937B, ray-tracing core 3938A-3938B) and multiple sets of load/store units 3940A-3940B. The execution resource units have a common instruction cache 3930, texture and/or data cache memory 3942, and shared memory 3946.

The various components can communicate via an interconnect fabric 3927. The interconnect fabric 3927 may include one or more crossbar switches to enable communication between the various components of the graphics multiprocessor 3925. The interconnect fabric 3927 may be a separate, high-speed network fabric layer upon which each component of the graphics multiprocessor 3925 is stacked. The components of the graphics multiprocessor 3925 communicate with remote components via the interconnect fabric 3927. For example, the cores 3936A-3936B, 3937A-3937B, and 3938A-3938B can each communicate with shared memory 3946 via the interconnect fabric 3927. The interconnect fabric 3927 can arbitrate communication within the graphics multiprocessor 3925 to ensure a fair bandwidth allocation between components.

The graphics multiprocessor 3950 of FIG. 39B includes multiple sets of execution resources 3956A-3956D, where each set of execution resource includes multiple instruction units, register files, GPGPU cores, and load store units, as illustrated in FIG. 38D and FIG. 39A. The execution resources 3956A-3956D can work in concert with texture unit(s) 3960A-3960D for texture operations, while sharing an instruction cache 3954, and shared memory 3953. For example, the execution resources 3956A-3956D can share an instruction cache 3954 and shared memory 3953, as well as multiple instances of a texture and/or data cache memory 3958A-3958B. The various components can communicate via an interconnect fabric 3952 similar to the interconnect fabric 3927 of FIG. 39A.

Persons skilled in the art will understand that the architecture described in FIGS. 1, 38A-38D, and 39A-39B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 3802 of FIG. 38A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 39C illustrates a graphics processing unit (GPU) 3980 which includes dedicated sets of graphics processing resources arranged into multi-core groups 3965A-3965N. While the details of only a single multi-core group 3965A are provided, it will be appreciated that the other multi-core groups 3965B-3965N may be equipped with the same or similar sets of graphics processing resources. Details described with respect to the multi-core groups 3965A-3965N may also apply to any graphics multiprocessor 3834, 3925, 3950 described herein.

As illustrated, a multi-core group 3965A may include a set of graphics cores 3970, a set of tensor cores 3971, and a set of ray tracing cores 3972. A scheduler/dispatcher 3968 schedules and dispatches the graphics threads for execution on the various cores 3970, 3971, 3972. A set of register files 3969 store operand values used by the cores 3970, 3971, 3972 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 3973 store graphics data such as texture data, vertex data, pixel data, ray data, bounding volume data, etc., locally within each multi-core group 3965A. One or more texture units 3974 can also be used to perform texturing operations, such as texture mapping and sampling. A Level 2 (L2) cache 3975 shared by all or a subset of the multi-core groups 3965A-3965N stores graphics data and/or instructions for multiple concurrent graphics threads. As illustrated, the L2 cache 3975 may be shared across a plurality of multi-core groups 3965A-3965N. One or more memory controllers 3967 couple the GPU 3980 to a memory 3966 which may be a system memory (e.g., DRAM) and/or a dedicated graphics memory (e.g., GDDR6 memory).

Input/output (I/O) circuitry 3963 couples the GPU 3980 to one or more I/O devices 3962 such as digital signal processors (DSPs), network controllers, or user input devices. An on-chip interconnect may be used to couple the I/O devices 3962 to the GPU 3980 and memory 3966. One or more I/O memory management units (IOMMUs) 3964 of the I/O circuitry 3963 couple the I/O devices 3962 directly to the system memory 3966. Optionally, the IOMMU 3964 manages multiple sets of page tables to map virtual addresses to physical addresses in system memory 3966. The I/O devices 3962, CPU(s) 3961, and GPU(s) 3980 may then share the same virtual address space.

In one implementation of the IOMMU 3964, the IOMMU 3964 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 3966). The base addresses of each of the first and second sets of page tables may be stored in control registers and swapped out on a context switch (e.g., so that the new context is provided with access to the relevant set of page tables). While not illustrated in FIG. 39C, each of the cores 3970, 3971, 3972 and/or multi-core groups 3965A-3965N may include translation lookaside buffers (TLBs) to cache guest virtual to guest physical translations, guest physical to host physical translations, and guest virtual to host physical translations.

The CPU(s) 3961, GPUs 3980, and I/O devices 3962 may be integrated on a single semiconductor chip and/or chip package. The illustrated memory 3966 may be integrated on the same chip or may be coupled to the memory controllers 3967 via an off-chip interface. In one implementation, the memory 3966 comprises GDDR6 memory which shares the same virtual address space as other physical system-level memories, although the underlying principles described herein are not limited to this specific implementation.

The tensor cores 3971 may include a plurality of execution units specifically designed to perform matrix operations, which are the fundamental compute operation used to perform deep learning operations. For example, simultaneous matrix multiplication operations may be used for neural network training and inferencing. The tensor cores 3971 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 3971. The training of neural networks, in particular, requires a significant number of matrix dot product operations. In order to process an inner-product formulation of an N×N×N matrix multiply, the tensor cores 3971 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 3971 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 3971 support a sparse mode of operation for matrices in which the vast majority of values are zero. The tensor cores 3971 include support for sparse input matrices that are encoded in a sparse matrix representation (e.g., coordinate list encoding (COO), compressed sparse row (CSR), compress sparse column (CSC), etc.). The tensor cores 3971 also include support for compressed sparse matrix representations in the event that the sparse matrix representation may be further compressed. Compressed, encoded, and/or compressed and encoded matrix data, along with associated compression and/or encoding metadata, can be read by the tensor cores 3971 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 3971, output matrix C may be output in a compressed format, a sparse encoding, or a compressed sparse encoding.

The ray tracing cores 3972 may accelerate ray tracing operations for both real-time ray tracing and non-real-time ray tracing implementations. In particular, the ray tracing cores 3972 may include ray traversal/intersection circuitry for performing ray traversal using bounding volume hierarchies (BVHs) and identifying intersections between rays and primitives enclosed within the BVH volumes. The ray tracing cores 3972 may also include circuitry for performing depth testing and culling (e.g., using a Z buffer or similar arrangement). In one implementation, the ray tracing cores 3972 perform traversal and intersection operations in concert with the image denoising techniques described herein, at least a portion of which may be executed on the tensor cores 3971. For example, the tensor cores 3971 may implement a deep learning neural network to perform denoising of frames generated by the ray tracing cores 3972. However, the CPU(s) 3961, graphics cores 3970, and/or ray tracing cores 3972 may also implement all or a portion of the denoising and/or deep learning algorithms.

In addition, as described above, a distributed approach to denoising may be employed in which the GPU 3980 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 3972 may process all BVH traversal and/or ray-primitive intersections, saving the graphics cores 3970 from being overloaded with thousands of instructions per ray. For example, each ray tracing core 3972 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 3965A can simply launch a ray probe, and the ray tracing cores 3972 independently perform ray traversal and intersection and return hit data (e.g., a hit, no hit, multiple hits, etc.) to the thread context. The other cores 3970, 3971 are freed to perform other graphics or compute work while the ray tracing cores 3972 perform the traversal and intersection operations.

Optionally, each ray tracing core 3972 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 3970 and tensor cores 3971) are freed to perform other forms of graphics work.

In some examples described below, a hybrid rasterization/ray tracing approach is used in which work is distributed between the graphics cores 3970 and ray tracing cores 3972.

The ray tracing cores 3972 (and/or other cores 3970, 3971) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 3972, graphics cores 3970 and tensor cores 3971 is Vulkan API (e.g., Vulkan version 1.1.85 and later). Note, however, that the underlying principles described herein are not limited to any particular ray tracing ISA.

In general, the various cores 3972, 3971, 3970 may support a ray tracing instruction set that includes instructions/functions for one or more of ray generation, closest hit, any hit, ray-primitive intersection, per-primitive and hierarchical bounding box construction, miss, visit, and exceptions. More specifically, some examples includes ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 3972 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 3972 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 3972 can also be used to perform computations that are not directly analogous to ray tracing. For example, mesh projection, mesh refinement, and volume sampling computations can be accelerated using the ray tracing cores 3972. Generic coordinate space calculations, such as nearest neighbor calculations can also be performed. For example, the set of points near a given point can be discovered by defining a bounding box in the coordinate space around the point. BVH and ray probe logic within the ray tracing cores 3972 can then be used to determine the set of point intersections within the bounding box. The intersections constitute the origin point and the nearest neighbors to that origin point. Computations that are performed using the ray tracing cores 3972 can be performed in parallel with computations performed on the graphics cores 3972 and tensor cores 3971. A shader compiler can be configured to compile a compute shader or other general-purpose graphics processing program into low level primitives that can be parallelized across the graphics cores 3970, tensor cores 3971, and ray tracing cores 3972.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

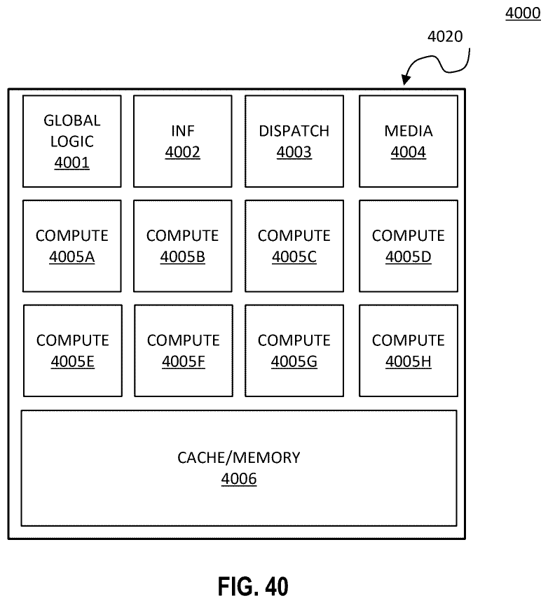

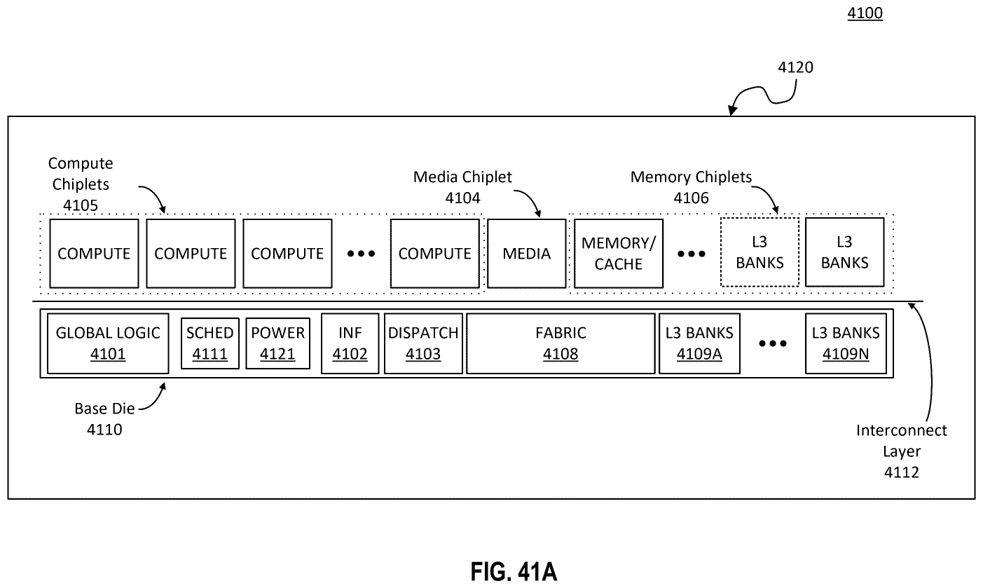

FIG. 40 shows a parallel compute system 4000, according to some examples. In some examples the parallel compute system 4000 includes a parallel processor 4020, which can be a graphics processor or compute accelerator as described herein. The parallel processor 4020 includes a global logic unit 4001, an interface 4002, a thread dispatcher 4003, a media unit 4004, a set of compute units 4005A-4005H, and a cache/memory units 4006. The global logic unit 4001, in some examples, includes global functionality for the parallel processor 4020, including device configuration registers, global schedulers, power management logic, and the like. The interface 4002 can include a front-end interface for the parallel processor 4020. The thread dispatcher 4003 can receive workloads from the interface 4002 and dispatch threads for the workload to the compute units 4005A-4005H. If the workload includes any media operations, at least a portion of those operations can be performed by the media unit 4004. The media unit can also offload some operations to the compute units 4005A-4005H. The cache/memory units 4006 can include cache memory (e.g., L3 cache) and local memory (e.g., HBM, GDDR) for the parallel processor 4020. Compute units 4005 may include units for one or more of a network or communication processor, a core, a graphics processor, a general purpose graphics processing unit (GPGPU), a neural-network processing unit (NPU), an embedded processor, a security processor, a cryptographic accelerator, a matrix accelerator, an in-memory analytics accelerator, a compression accelerator, a data streaming accelerator, or the like.

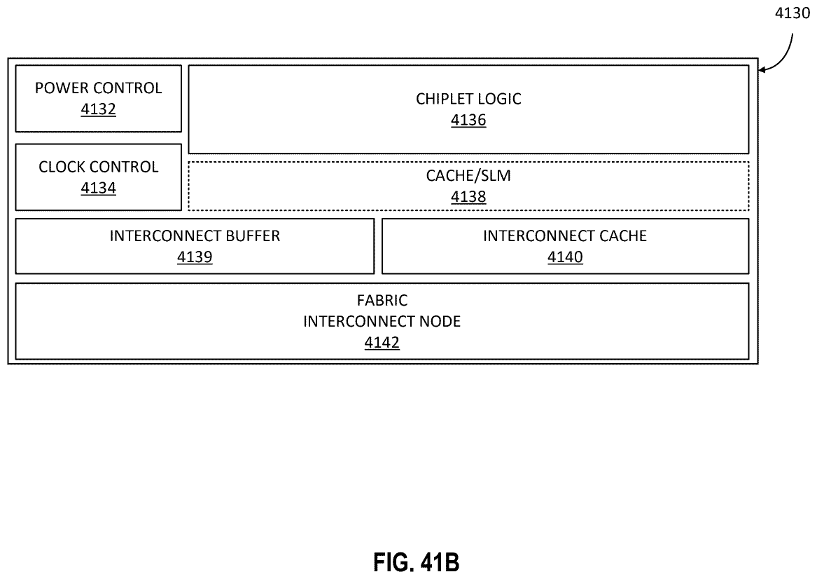

FIGS. 41A-41B illustrate a hybrid logical/physical view of a disaggregated parallel processor, according to examples described herein. FIG. 41A illustrates a disaggregated parallel compute system 4100. FIG. 41B illustrates a chiplet 4130 of the disaggregated parallel compute system 4100.

As shown in FIG. 41A, a disaggregated parallel compute system 4100 can include a parallel processor 4120 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 4105, a media chiplet 4104, and memory chiplets 4106. Each chiplet can be separately manufactured using different process technologies. For example, compute chiplets 4105 may be manufactured using the smallest or most advanced process technology available at the time of fabrication, while memory chiplets 4106 or other chiplets (e.g., I/O, networking, etc.) may be manufactured using a larger or less advanced process technologies.

The various chiplets can be bonded to a base die 4110 and configured to communicate with each other and logic within the base die 4110 via an interconnect layer 4112. In some examples, the base die 4110 can include global logic 4101, which can include scheduler 4111 and power management 4121 logic units, an interface 4102, a dispatch unit 4103, and an interconnect fabric 4108 coupled with or integrated with one or more L3 cache banks 4109A-4109N. The interconnect fabric 4108 can be an inter-chiplet fabric that is integrated into the base die 4110. Logic chiplets can use the fabric 4108 to relay messages between the various chiplets. Additionally, L3 cache banks 4109A-4109N in the base die and/or L3 cache banks within the memory chiplets 4106 can cache data read from and transmitted to DRAM chiplets within the memory chiplets 4106 and to system memory of a host.

In some examples the global logic 4101 is a microcontroller that can execute firmware to perform scheduler 4111 and power management 4121 functionality for the parallel processor 4120. The microcontroller that executes the global logic can be tailored for the target use case of the parallel processor 4120. The scheduler 4111 can perform global scheduling operations for the parallel processor 4120. The power management 4121 functionality can be used to enable or disable individual chiplets within the parallel processor when those chiplets are not in use.

The various chiplets of the parallel processor 4120 can be designed to perform specific functionality that, in existing designs, would be integrated into a single die. A set of compute chiplets 4105 can include clusters of compute units (e.g., execution units, streaming multiprocessors, etc.) that include programmable logic to execute compute or graphics shader instructions. A media chiplet 4104 can include hardware logic to accelerate media encode and decode operations. Memory chiplets 4106 can include volatile memory (e.g., DRAM) and one or more SRAM cache memory banks (e.g., L3 banks).

As shown in FIG. 41B, each chiplet 4130 can include common components and application specific components. Chiplet logic 4136 within the chiplet 4130 can include the specific components of the chiplet, such as an array of streaming multiprocessors, compute units, or execution units described herein. The chiplet logic 4136 can couple with an optional cache or shared local memory 4138 or can include a cache or shared local memory within the chiplet logic 4136. The chiplet 4130 can include a fabric interconnect node 4142 that receives commands via the inter-chiplet fabric. Commands and data received via the fabric interconnect node 4142 can be stored temporarily within an interconnect buffer 4139. Data transmitted to and received from the fabric interconnect node 4142 can be stored in an interconnect cache 4140. Power control 4132 and clock control 4134 logic can also be included within the chiplet. The power control 4132 and clock control 4134 logic can receive configuration commands via the fabric can configure dynamic voltage and frequency scaling for the chiplet 4130. In some examples, each chiplet can have an independent clock domain and power domain and can be clock gated and power gated independently of other chiplets.

At least a portion of the components within the illustrated chiplet 4130 can also be included within logic embedded within the base die 4110 of FIG. 41A. For example, logic within the base die that communicates with the fabric can include a version of the fabric interconnect node 4142. Base die logic that can be independently clock or power gated can include a version of the power control 4132 and/or clock control 4134 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

Example Core Architectures-In-order and out-of-order core block diagram.

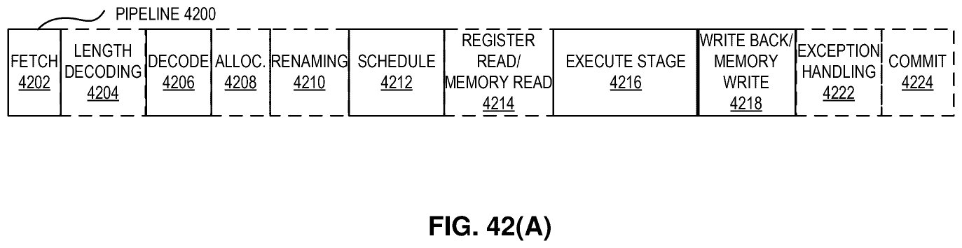

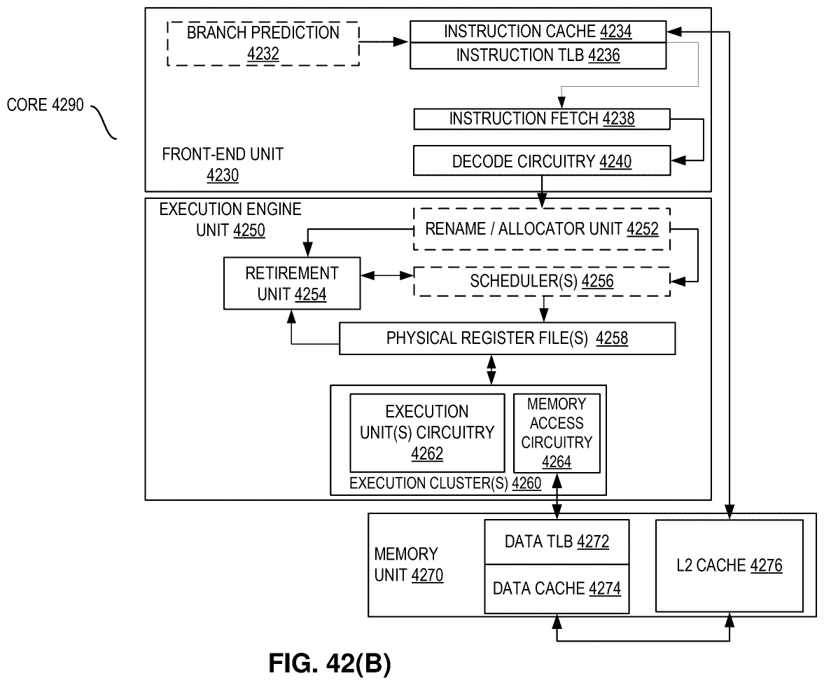

FIG. 42(A) is a block diagram illustrating both an example in-order pipeline and an example register renaming, out-of-order issue/execution pipeline according to examples. FIG. 42(B) is a block diagram illustrating both an example in-order architecture core and an example register renaming, out-of-order issue/execution architecture core to be included in a processor according to examples. The solid lined boxes in FIGS. 42(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 42(A), a processor pipeline 4200 includes a fetch stage 4202, an optional length decoding stage 4204, a decode stage 4206, an optional allocation (Alloc) stage 4208, an optional renaming stage 4210, a schedule (also known as a dispatch or issue) stage 4212, an optional register read/memory read stage 4214, an execute stage 4216, a write back/memory write stage 4218, an optional exception handling stage 4222, and an optional commit stage 4224. One or more operations can be performed in each of these processor pipeline stages. For example, during the fetch stage 4202, one or more instructions are fetched from instruction memory, and during the decode stage 4206, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 4206 and the register read/memory read stage 4214 may be combined into one pipeline stage. In some examples, during the execute stage 4216, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 42(B) may implement the pipeline 4200 as follows: 1) the instruction fetch circuitry 4238 performs the fetch and length decoding stages 4202 and 4204; 2) the decode circuitry 4240 performs the decode stage 4206; 3) the rename/allocator unit circuitry 4252 performs the allocation stage 4208 and renaming stage 4210; 4) the scheduler(s) circuitry 4256 performs the schedule stage 4212; 5) the physical register file(s) circuitry 4258 and the memory unit circuitry 4270 perform the register read/memory read stage 4214; the execution cluster(s) 4260 perform the execute stage 4216; 6) the memory unit circuitry 4270 and the physical register file(s) circuitry 4258 perform the write back/memory write stage 4218; 7) various circuitry may be involved in the exception handling stage 4222; and 8) the retirement unit circuitry 4254 and the physical register file(s) circuitry 4258 perform the commit stage 4224.

FIG. 42(B) shows a processor core 4290 including front-end unit circuitry 4230 coupled to execution engine unit circuitry 4250, and both are coupled to memory unit circuitry 4270. The core 4290 may be a reduced instruction set architecture computing (RISC) core, a complex instruction set architecture computing (CISC) core, a very long instruction word (VLIW) core, or a hybrid or alternative core type. As yet another option, the core 4290 may be a special-purpose core, such as, for example, a network or communication core, compression engine, co-processor core, general purpose computing graphics processing unit (GPGPU) core, graphics core, or the like.

The front-end unit circuitry 4230 may include branch prediction circuitry 4232 coupled to instruction cache circuitry 4234, which is coupled to an instruction translation lookaside buffer (TLB) 4236, which is coupled to instruction fetch circuitry 4238, which is coupled to decode circuitry 4240. In some examples, the instruction cache circuitry 4234 is included in the memory unit circuitry 4270 rather than the front-end unit circuitry 4230. The decode circuitry 4240 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 4240 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 4240 may be implemented using various different mechanisms. Examples of suitable mechanisms include, but are not limited to, look-up tables, hardware implementations, programmable logic arrays (PLAs), microcode read only memories (ROMs), etc. In some examples, the core 4290 includes a microcode ROM (not shown) or other medium that stores microcode for certain macroinstructions (e.g., in decode circuitry 4240 or otherwise within the front-end unit circuitry 4230). In some examples, the decode circuitry 4240 includes a micro-operation (micro-op) or operation cache (not shown) to hold/cache decoded operations, micro-tags, or micro-operations generated during the decode or other stages of the processor pipeline 4200. The decode circuitry 4240 may be coupled to rename/allocator unit circuitry 4252 in the execution engine unit circuitry 4250.

The execution engine unit circuitry 4250 includes the rename/allocator unit circuitry 4252 coupled to retirement unit circuitry 4254 and a set of one or more scheduler(s) circuitry 4256. The scheduler(s) circuitry 4256 represents any number of different schedulers, including reservations stations, central instruction window, etc. In some examples, the scheduler(s) circuitry 4256 can include arithmetic logic unit (ALU) scheduler/scheduling circuitry, ALU queues, address generation unit (AGU) scheduler/scheduling circuitry, AGU queues, etc. The scheduler(s) circuitry 4256 is coupled to the physical register file(s) circuitry 4258. Each of the physical register file(s) circuitry 4258 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 4258 includes vector registers unit circuitry, writemask registers unit circuitry, and scalar register unit circuitry. These register units may provide architectural vector registers, vector mask registers, general-purpose registers, etc. The physical register file(s) circuitry 4258 is coupled to the retirement unit circuitry 4254 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 4254 and the physical register file(s) circuitry 4258 are coupled to the execution cluster(s) 4260. The execution cluster(s) 4260 includes a set of one or more execution unit(s) circuitry 4262 and a set of one or more memory access circuitry 4264. The execution unit(s) circuitry 4262 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 4262 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 4256, physical register file(s) circuitry 4258, and execution cluster(s) 4260 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 4264). It should also be understood that where separate pipelines are used, one or more of these pipelines may be out-of-order issue/execution and the rest in-order.

In some examples, the execution engine unit circuitry 4250 may perform load store unit (LSU) address/data pipelining to an Advanced Microcontroller Bus (AMB) interface (not shown), and address phase and writeback, data phase load, store, and branches.

The set of memory access circuitry 4264 is coupled to the memory unit circuitry 4270, which includes data TLB circuitry 4272 coupled to data cache circuitry 4274 coupled to level 2 (L2) cache circuitry 4276. In some examples, the memory access circuitry 4264 may include load unit circuitry, store address unit circuitry, and store data unit circuitry, each of which is coupled to the data TLB circuitry 4272 in the memory unit circuitry 4270. The instruction cache circuitry 4234 is further coupled to the level 2 (L2) cache circuitry 4276 in the memory unit circuitry 4270. In some examples, the instruction cache 4234 and the data cache 4274 are combined into a single instruction and data cache (not shown) in L2 cache circuitry 4276, level 3 (L3) cache circuitry (not shown), and/or main memory. The L2 cache circuitry 4276 is coupled to one or more other levels of cache and eventually to a main memory.

The core 4290 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 4290 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry.

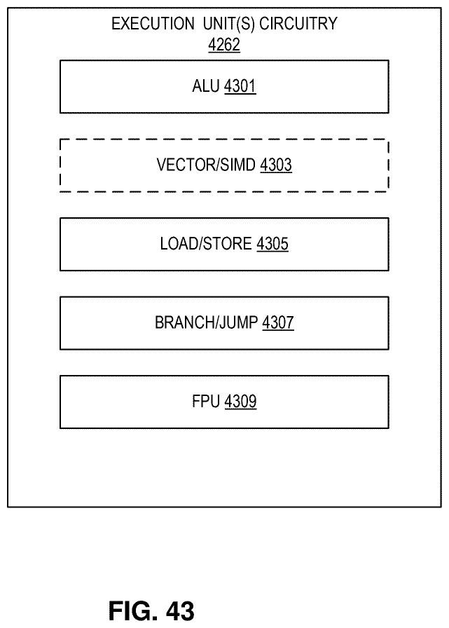

FIG. 43 illustrates examples of execution unit(s) circuitry, such as execution unit(s) circuitry 4262 of FIG. 42(B). As illustrated, execution unit(s) circuitry 4262 may include one or more ALU circuits 4301, optional vector/single instruction multiple data (SIMD) circuits 4303, load/store circuits 4305, branch/jump circuits 4307, and/or Floating-point unit (FPU) circuits 4309. ALU circuits 4301 perform integer arithmetic and/or Boolean operations. Vector/SIMD circuits 4303 perform vector/SIMD operations on packed data (such as SIMD/vector registers). Load/store circuits 4305 execute load and store instructions to load data from memory into registers or store from registers to memory. Load/store circuits 4305 may also generate addresses. Branch/jump circuits 4307 cause a branch or jump to a memory address depending on the instruction. FPU circuits 4309 perform floating-point arithmetic. The width of the execution unit(s) circuitry 4262 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

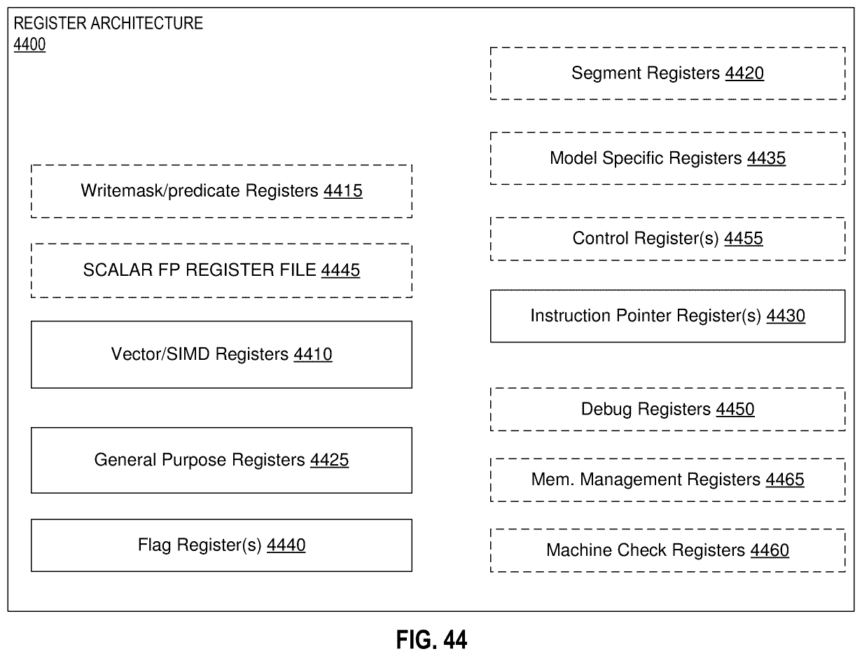

FIG. 44 is a block diagram of a register architecture 4400 according to some examples. As illustrated, the register architecture 4400 includes vector/SIMD registers 4410 that vary from 128-bit to 1,024 bits width. In some examples, the vector/SIMD registers 4410 are physically 512-bits and, depending upon the mapping, only some of the lower bits are used. For example, in some examples, the vector/SIMD registers 4410 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 4400 includes writemask/predicate registers 4415. For example, in some examples, there are 8 writemask/predicate registers (sometimes called k0 through k7) that are each 16-bit, 32-bit, 64-bit, or 128-bit in size. Writemask/predicate registers 4415 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 4415 corresponds to a data element position of the destination. In other examples, the writemask/predicate registers 4415 are scalable and consists of a set number of enable bits for a given vector element (e.g., 8 enable bits per 64-bit vector element).

The register architecture 4400 includes a plurality of general-purpose registers 4425. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 4400 includes scalar floating-point (FP) register file 4445 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 4440 (e.g., EFLAGS, RFLAGS, etc.) store status and control information for arithmetic, compare, and system operations. For example, the one or more flag registers 4440 may store condition code information such as carry, parity, auxiliary carry, zero, sign, and overflow. In some examples, the one or more flag registers 4440 are called program status and control registers.

Segment registers 4420 contain segment points for use in accessing memory. In some examples, these registers are referenced by the names CS, DS, SS, ES, FS, and GS.

Model specific registers or machine specific registers (MSRs) 4435 control and report on processor performance. Most MSRs 4435 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 4460 consist of control, status, and error reporting MSRs that are used to detect and report on hardware errors. Control register(s) 4455 (e.g., CR0-CR4) determine the operating mode of a processor (e.g., processor 3570, 3580, 3538, 3515, and/or 3600) and the characteristics of a currently executing task. In some examples, MSRs 4435 are a subset of control registers 4455.

One or more instruction pointer register(s) 4430 store an instruction pointer value. Debug registers 4450 control and allow for the monitoring of a processor or core's debugging operations.

Memory (mem) management registers 4465 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 4400 may, for example, be used in register file/memory 'ISAB08, or physical register file(s) circuitry 4258.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

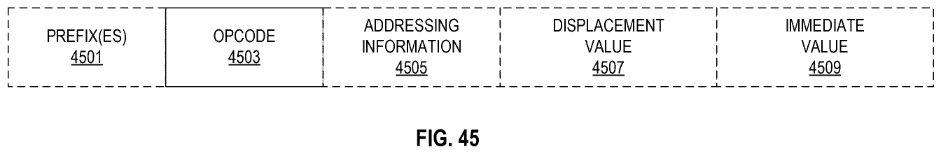

FIG. 45 illustrates examples of an instruction format. As illustrated, an instruction may include multiple components including, but not limited to, one or more fields for: one or more prefixes, an opcode, addressing information (e.g., register identifiers, memory addressing information, etc.), a displacement value, and/or an immediate value. Note that some instructions utilize some or all the fields of the format whereas others may only use the field for the opcode 4503. In some examples, the order illustrated is the order in which these fields are to be encoded, however, it should be appreciated that in other examples these fields may be encoded in a different order, combined, etc.

The prefix(es) f 4501, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 4503 is used to at least partially define the operation to be performed upon a decoding of the instruction. In some examples, a primary opcode encoded in the opcode field 4503 is one, two, or three bytes in length. In other examples, a primary opcode can be a different length. An additional 3-bit opcode field is sometimes encoded in another field.

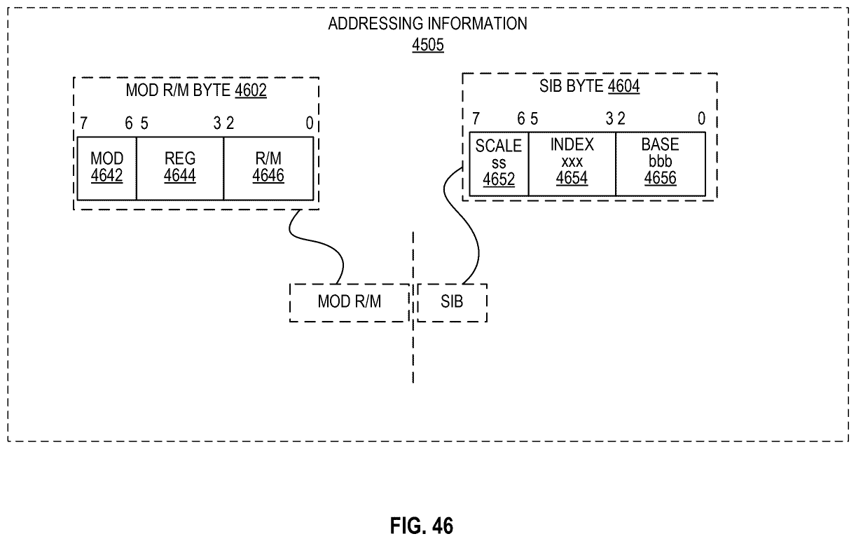

The addressing information field 4505 is used to address one or more operands of the instruction, such as a location in memory or one or more registers. FIG. 46 illustrates examples of the addressing information field 4505. In this illustration, an optional MOD R/M byte 4602 and an optional Scale, Index, Base (SIB) byte 4604 are shown. The MOD R/M byte 4602 and the SIB byte 4604 are used to encode up to two operands of an instruction, each of which is a direct register or effective memory address. Note that both of these fields are optional in that not all instructions include one or more of these fields. The MOD R/M byte 4602 includes a MOD field 4642, a register (reg) field 4644, and R/M field 4646.

The content of the MOD field 4642 distinguishes between memory access and non-memory access modes. In some examples, when the MOD field 4642 has a binary value of 11 (11b), a register-direct addressing mode is utilized, and otherwise a register-indirect addressing mode is used.

The register field 4644 may encode either the destination register operand or a source register operand or may encode an opcode extension and not be used to encode any instruction operand. The content of register field 4644, directly or through address generation, specifies the locations of a source or destination operand (either in a register or in memory). In some examples, the register field 4644 is supplemented with an additional bit from a prefix (e.g., prefix 4501) to allow for greater addressing.

The R/M field 4646 may be used to encode an instruction operand that references a memory address or may be used to encode either the destination register operand or a source register operand. Note the R/M field 4646 may be combined with the MOD field 4642 to dictate an addressing mode in some examples.

The SIB byte 4604 includes a scale field 4652, an index field 4654, and a base field 4656 to be used in the generation of an address. The scale field 4652 indicates a scaling factor. The index field 4654 specifies an index register to use. In some examples, the index field 4654 is supplemented with an additional bit from a prefix (e.g., prefix 4501) to allow for greater addressing. The base field 4656 specifies a base register to use. In some examples, the base field 4656 is supplemented with an additional bit from a prefix (e.g., prefix 4501) to allow for greater addressing. In practice, the content of the scale field 4652 allows for the scaling of the content of the index field 4654 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 4507 provides this value. Additionally, in some examples, a displacement factor usage is encoded in the MOD field of the addressing information field 4505 that indicates a compressed displacement scheme for which a displacement value is calculated and stored in the displacement field 4507.

In some examples, the immediate value field 4509 specifies an immediate value for the instruction. An immediate value may be encoded as a 1-byte value, a 2-byte value, a 4-byte value, etc.

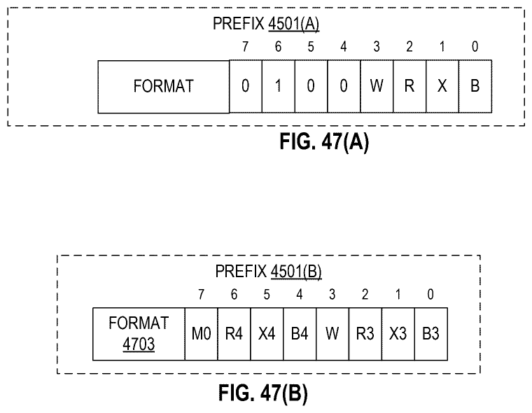

FIGS. 47(A)-(B) illustrate examples of a first prefix 4501(A). FIG. 47(A) illustrates first examples of the first prefix 4501(A). In some examples, the first prefix 4501(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 4501(A) may specify up to three registers using 3-bit fields depending on the format: 1) using the reg field 4644 and the R/M field 4646 of the MOD R/M byte 4602; 2) using the MOD R/M byte 4602 with the SIB byte 4604 including using the reg field 4644 and the base field 4656 and index field 4654; or 3) using the register field of an opcode.

In the first prefix 4501(A), bit positions of the payload byte 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 4644 and MOD R/M R/M field 4646 alone can each only address 8 registers.

In the first prefix 4501(A), bit position 2 (R) may be an extension of the MOD R/M reg field 4644 and may be used to modify the MOD R/M reg field 4644 when that field encodes a general-purpose register, a 64-bit packed data register (e.g., a SSE register), or a control or debug register. R is ignored when MOD R/M byte 4602 specifies other registers or defines an extended opcode.

Bit position 1 (X) may modify the SIB byte index field 4654.

Bit position 0 (B) may modify the base in the MOD R/M R/M field 4646 or the SIB byte base field 4656; or it may modify the opcode register field used for accessing general purpose registers (e.g., general purpose registers 4425).

FIG. 47(B) illustrates second examples of the first prefix 4501(A). In some examples, the prefix 4501(A) supports addressing 32 general purpose registers. In some examples, this prefix is called REX2.

In some examples, one or more of instructions for increment, decrement, negation, addition, subtraction, AND, OR, XOR, shift arithmetically left, shift logically left, shift arithmetically right, shift logically right, rotate left, rotate right, multiply, divide, population count, leading zero count, total zero count, etc. support flag suppression.

In some examples, one or more of instructions for increment, decrement, NOT, negation, addition, add with carry, integer subtraction with borrow, subtraction, AND, OR, XOR, shift arithmetically left, shift logically left, shift arithmetically right, shift logically right, rotate left, rotate right, multiply, divide, population count, leading zero count, total zero count, unsinged integer addition of two operands with carry flag, unsinged integer addition of two operands with overflow flag, conditional move, pop, push, etc. support REX2.

As shown, REX2 has a format field 4703 in a first byte and 8 bits in a second byte (e.g., a payload byte). In some examples, the format field 303 has a value of 0xD5. In some examples, 0xD5 encodes an ASCIII Adjust AX Before Division (AAD) instruction in a 32-bit mode. In those examples, in a 64-bit mode it is used as the first byte of the prefix of FIG. 47(B).

The payload byte includes several bits.

Bit position 0 (B3) may modify the base in the MOD R/M R/M field 4646 or the SIB byte base field 4656; or it may modify the opcode register field used for accessing general purpose registers (e.g., general purpose registers 4425).

Bit position 1 (X3) may modify the SIB byte index field 4654.

Bit position 2 (R3) may be used as an extension of the MOD R/M reg field 4644 and may be used to modify the MOD R/M reg field 4644 when that field encodes a general-purpose register, a 64-bit packed data register (e.g., an SSE register), or a control or debug register. R3 may be ignored when MOD R/M byte 4602 specifies other registers or defines an extended opcode.

Bit position 3 (W) can be used to determine an operand size, but may not solely determine operand width. As such, when W=0, the operand size is determined by a code segment descriptor (CS.D) and when W=1, the operand size is 64-bit.

Bit position 4 (B4) may further (along with B3) modify the base in the MOD R/M R/M field 4646 or the SIB byte base field 4656; or it may modify the opcode register field used for accessing general purpose registers (e.g., general purpose registers 4425).

Bit position 5 (X4) may further (along with X3) modify the SIB byte index field 4654.

Bit position 6 (R4) may further (along with R3) be used as an extension of the MOD R/M reg field 4644 and may be used to modify the MOD R/M reg field 4644 when that field encodes a general-purpose register, a 64-bit packed data register (e.g., an SSE register), or a control or debug register.

In some examples, bit position 7 (M0) indicates an opcode map (e.g., 0 or 1).

R3, R4, X3, X4, B3, and B4 allow for the addressing of 32 GPRs. That is an R, X or B register identifier is extended by the R3, X3, and B3 and R4, X4, and B4 bits in a REX2 prefix when and only when it encodes a GPR register. In some examples, the vector (or any other type of) registers are not encoded using those bits.

In some examples, REX2 must be the last prefix and the byte following it is interpreted as the main opcode byte in the opcode map indicated by M0. The 0x0F escape byte is neither needed nor allowed. In some examples, prefixes which may precede the REX2 prefix are LOCK (0xF0), REPE/REP/REPZ (0xF3), REPNE/REPNZ (0xF2), operand-size override (0x66), address-size override (0x67), and segment overrides.

In general, when any of the bits in REX2 R4, X4, B4, R3, X3, and B3 are not used they are ignored. For example, when there is no index register, X4 and X3 are both ignored. Similarly, when the R, X, or B register identifier encodes a vector register, the R4, X4, or B4 bit is ignored. There are, however, in some examples, one or two exceptions to this general rule: 1) an attempt to access a non-existent control register or debug register will trigger #UD and 2) instructions with opcodes 0x50-0x5F (including POP and PUSH) use R4 to encode a push-pop acceleration hint.

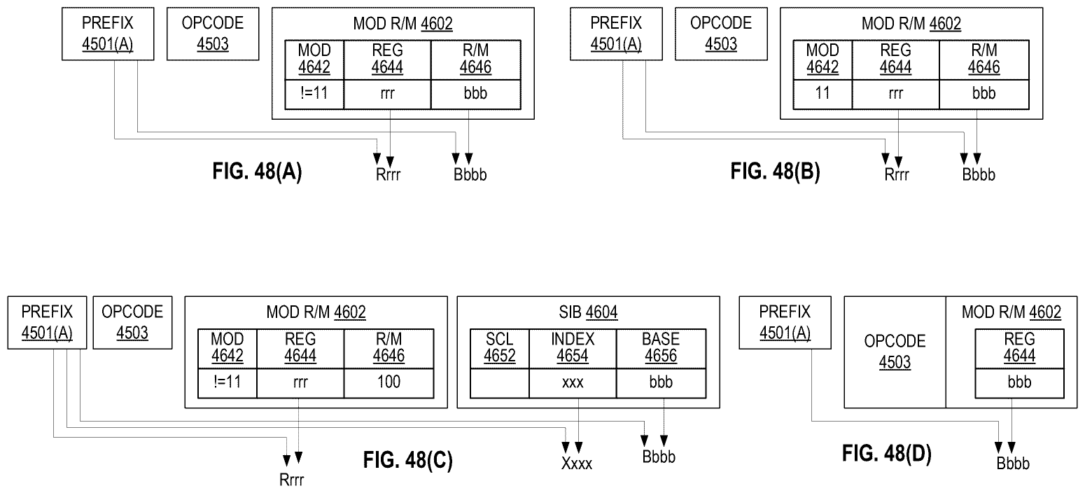

FIGS. 48(A)-(D) illustrate examples of how the R, X, and B fields of the first prefix 4501(A) are used. FIG. 48(A) illustrates R and B from the first prefix 4501(A) being used to extend the reg field 4644 and R/M field 4646 of the MOD R/M byte 4602 when the SIB byte 4604 is not used for memory addressing. FIG. 48(B) illustrates R and B from the first prefix 4501(A) being used to extend the reg field 4644 and R/M field 4646 of the MOD R/M byte 4602 when the SIB byte 4604 is not used (register-register addressing). FIG. 48(C) illustrates R, X, and B from the first prefix 4501(A) being used to extend the reg field 4644 of the MOD R/M byte 4602 and the index field 4654 and base field 4656 when the SIB byte 4604 being used for memory addressing. FIG. 48(D) illustrates B from the first prefix 4501(A) being used to extend the reg field 4644 of the MOD R/M byte 4602 when a register is encoded in the opcode 4503. The R4 and R3 values of FIG. 47(B) can be used to expand rrr, B4 and B3 can be used to expand bbb, and X4 and X3 can be used to expand xxx.

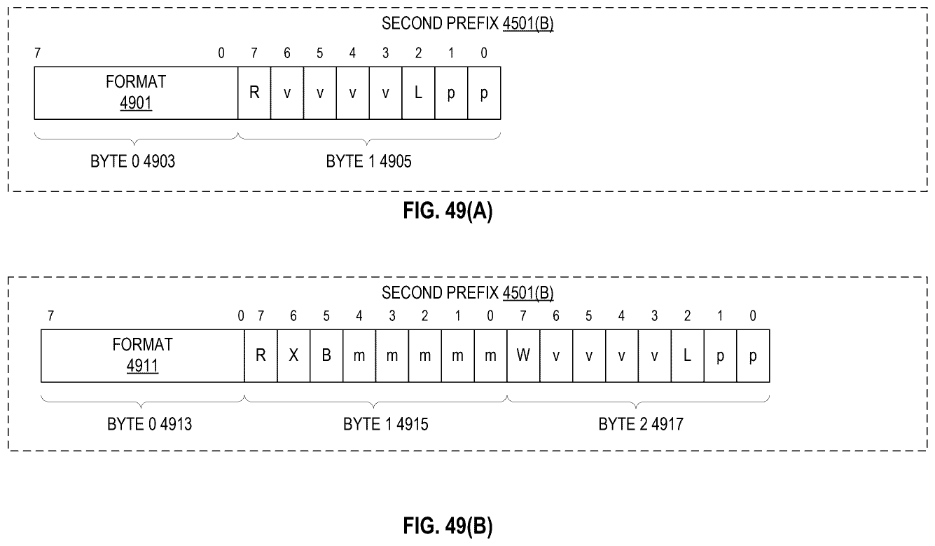

FIGS. 49(A)-(B) illustrate examples of a second prefix 4501(B). In some examples, the second prefix 4501(B) is an example of a VEX prefix. The second prefix 4501(B) encoding allows instructions to have more than two operands, and allows SIMD vector registers (e.g., vector/SIMD registers 4410) to be longer than 64-bits (e.g., 128-bit and 256-bit). The use of the second prefix 4501(B) provides for three-operand (or more) syntax. For example, previous two-operand instructions performed operations such as A=A+B, which overwrites a source operand. The use of the second prefix 4501(B) enables operands to perform nondestructive operations such as A=B+C.

In some examples, the second prefix 4501(B) comes in two forms—a two-byte form and a three-byte form. The two-byte second prefix 4501(B) is used mainly for 128-bit, scalar, and some 256-bit instructions; while the three-byte second prefix 4501(B) provides a compact replacement of the first prefix 4501(A) and 3-byte opcode instructions.

FIG. 49(A) illustrates examples of a two-byte form of the second prefix 4501(B). In some examples, a format field 4901 (byte 0 4903) contains the value C5H. In some examples, byte 1 4905 includes an “R” value in bit[7]. This value is the complement of the “R” value of the first prefix 4501(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 4646 to encode the instruction operand that references a memory address or encode either the destination register operand or a source register operand.

Instructions that use this prefix may use the MOD R/M reg field 4644 to encode either the destination register operand or a source register operand, or to be treated as an opcode extension and not used to encode any instruction operand.

For instruction syntax that support four operands, vvvv, the MOD R/M R/M field 4646 and the MOD R/M reg field 4644 encode three of the four operands. Bits[7:4] of the immediate value field 4509 are then used to encode the third source register operand.

FIG. 49(B) illustrates examples of a three-byte form of the second prefix 4501(B). In some examples, a format field 4911 (byte 0 4913) contains the value C4H. Byte 1 4915 includes in bits[7:5] “R,” “X,” and “B” which are the complements of the same values of the first prefix 4501(A). Bits[4:0] of byte 1 4915 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 4917 is used similar to W of the first prefix 4501(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 4646 to encode the instruction operand that references a memory address or encode either the destination register operand or a source register operand.

Instructions that use this prefix may use the MOD R/M reg field 4644 to encode either the destination register operand or a source register operand, or to be treated as an opcode extension and not used to encode any instruction operand.

For instruction syntax that support four operands, vvvv, the MOD R/M R/M field 4646, and the MOD R/M reg field 4644 encode three of the four operands. Bits[7:4] of the immediate value field 4509 are then used to encode the third source register operand.

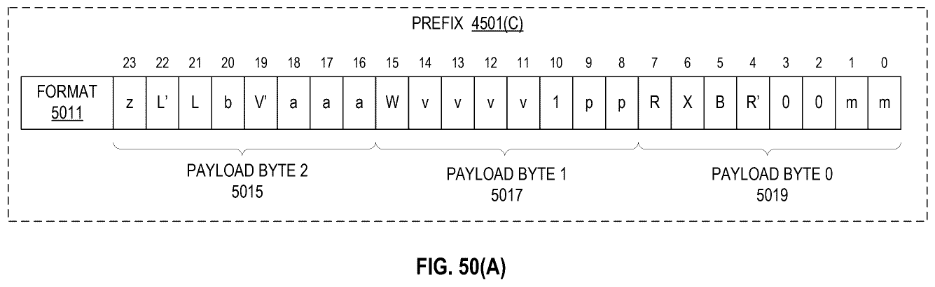

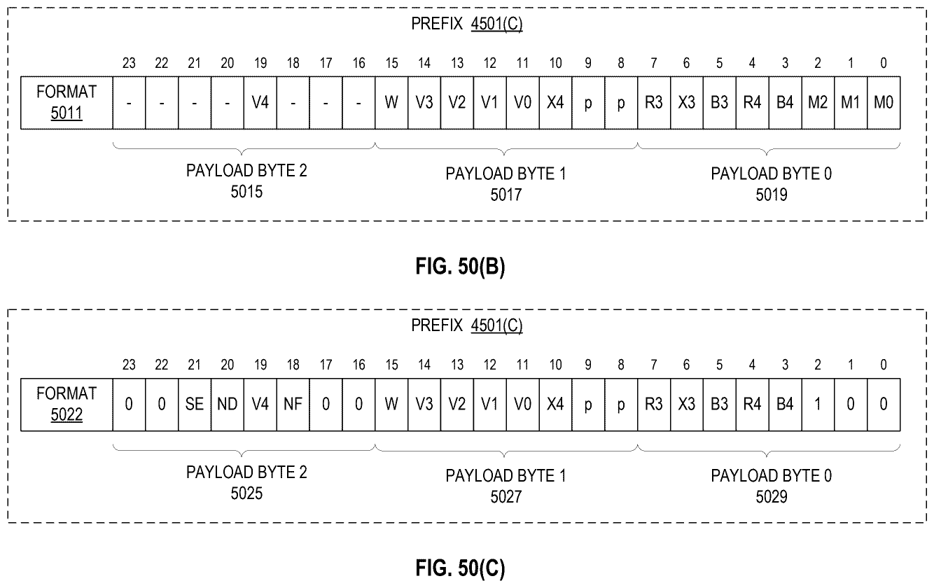

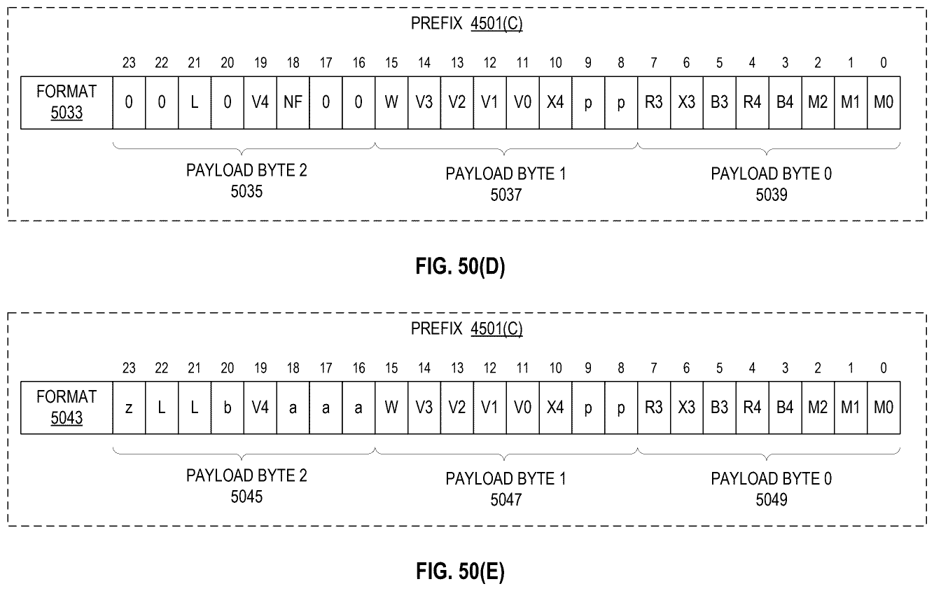

FIGS. 50(A)-(E) illustrates examples of a third prefix 4501(C). FIG. 50(A) illustrates first examples of the third prefix. In some examples, the third prefix 4501(C) is an example of an EVEX prefix. The third prefix 4501(C) is a four-byte prefix.

The third prefix 4501(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 44) or predication utilize this prefix. Opmask register allow for conditional processing or selection control. Opmask instructions, whose source/destination operands are opmask registers and treat the content of an opmask register as a single value, are encoded using the second prefix 4501(B).

The third prefix 4501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 4501(C) is a format field 5011 that has a value, in some examples, of 62H. Subsequent bytes are referred to as payload bytes 5015-5019 and collectively form a 24-bit value of P[23:0] providing specific capability in the form of one or more fields (detailed herein).

In some examples, P[1:0] of payload byte 5019 are identical to the low two mm bits. P[3:2] are reserved in some examples. Bit P[4] (R′) allows access to the high 16 vector register set when combined with P[7] and the MOD R/M reg field 4644. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 4644 and MOD R/M R/M field 4646. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 4501(A) and second prefix 4511(B) and may serve as an opcode extension bit or operand size promotion.

P[18:16] specify the index of a register in the opmask (writemask) registers (e.g., writemask/predicate registers 4415). In some examples, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other some examples, preserving the old value of each element of the destination where the corresponding mask bit has a 0. In contrast, when zeroing vector masks allow any set of elements in the destination to be zeroed during the execution of any operation (specified by the base operation and the augmentation operation); in some examples, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 4501(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or |
| | | | Destination |
| RM | MOD R/M R/M | GPR, Vector | 1^{st} Source or |
| | | | Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

FIG. 50(B) illustrates second examples of the third prefix. In some examples, the prefix 46K01(B) is an example of an EVEX2 prefix. The EVEX2 prefix 4501(C) is a four-byte prefix.

In some examples, one or more of instructions for increment, decrement, NOT, negation, addition, add with carry, integer subtraction with borrow, subtraction, AND, OR, XOR, shift arithmetically left, shift logically left, shift arithmetically right, shift logically right, rotate left, rotate right, multiply, divide, population count, pop, push, leading zero count, total zero count, unsinged integer addition of two operands with carry flag, unsinged integer addition of two operands with overflow flag, conditional move, etc. support EVEX2.

For these instructions it should be noted that NDD may or may not be used depending on the settings of the prefix of those instructions.

The extended EVEX prefix is an extension of a 4-byte EVEX prefix and is used to provide APX features for legacy instructions which cannot be provided by the REX2 prefix (in particular, the new data destination) and APX extensions of VEX and EVEX instructions. Most bits in the third payload byte (except for the V4 bit) are left unspecified because the payload bit assignment depends on whether the EVEX prefix is used to provide APX extension to a legacy, VEX, or EVEX instruction, the details of which will be given in the subsections below. The byte following the extended EVEX prefix is always interpreted as the main opcode byte. Escape sequences 0x0F, 0x0F38 and 0x0F3A are neither needed nor allowed.

The EVEX2 prefix 5001(B) can encode 32 vector registers (e.g., 128-bit, 256-bit, and 512-bit registers) in 64-bit mode and/or 32 general purpose registers.

The EVEX2 prefix 5001(B) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 5001(B) is a format field 5011 that has a value, in some examples, of 0x62. Subsequent bytes are referred to as payload bytes 5015-5019 and collectively form a 24-bit value of P[23:0] providing specific capability in the form of one or more fields (detailed herein).

Bits 0:2 (M0, M1, and M2) of a first payload byte (payload byte 0) 5017 are used to provide an opcode map identification. Note that this is limited to 8 maps.

Bit 3 (B4) provides the fifth bit and most significant bit for the B register identifier.

Bit 4 (R4) provides the fifth bit and most significant bit for the R register identifier.

Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).

Bits 9:8 provide opcode extensionality equivalent to some legacy prefixes (e.g., 00=no prefix, 01=66H, 10=F3H, and 11=F2H).

Bit 10 (X4) provides the fifth bit and most significant bit for the X register identifier.

Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.

Bit 15 (W) may serve as an opcode extension bit or operand size promotion.

Bit 19 can be combined with bits 14:11 to encode a register in a new data destination.

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 4501(C) are detailed in the following table.

| | 4 | 3 | [2:0] | REG. TYPE | COMMON USAGES |
|---|---|---|---|---|---|
| R | R4 | R3 | MOD R/M | GPR | Destination or Source |
| register | | | reg | | |
| B | B4 | B3 | MOD R/M | GPR | Destination or Source |
| register | | | reg | | |
| V | V4 | V3V2V1V0 | | GPR | 2nd Source or |
| register | | | | | Destination |
| RM | B4 | B3 | MOD R/M | GPR | 1st Source or |
| | | | R/M | | Destination |
| BASE | B4 | B3 | MOD R/M | GPR | Memory addressing |
| | | | R/M | | |
| INDEX | X4 | X3 | SIB.index | GPR | Memory addressing |

FIG. 50(C) illustrates third examples of the third prefix. In some examples, the prefix 4501(C) is an example of an EVEX2 prefix. The EVEX2 prefix 4501(C) is a four-byte prefix.

The EVEX2 prefix 4501(C) can encode at least 32 vector registers (e.g., 128-bit, 256-bit, and 512-bit registers) in 64-bit mode and/or up to 64 general purpose registers.

The EVEX2 prefix 4501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 4501(C) is a format field 5022 that has a value, in one example, of 0x62. Subsequent bytes are referred to as payload bytes 555-5029 and collectively form a 24-bit value of P[23:0] providing specific capability in the form of one or more fields (detailed herein).

Bits 0:1 are set to zero and bit 2 is set to 1.

Bit 3 (B4) provides the fifth bit and most significant bit for the B register identifier.

Bit 4 (R4) provides the fifth bit and most significant bit for the R register identifier.

Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).

Bits 9:8 provide opcode extensionality equivalent to some legacy prefixes (e.g., 00=no prefix, 01=66H, 10=F3H, and 11=F2H).

Bit 10 (X4) provides the fifth bit and most significant bit for the X register identifier.

Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.

Bit 15 (W) may serve as an opcode extension bit or operand size promotion.

Bits 16:17 are zero.

Bit 18 is used to indicate a flags update suppression in most examples. When set to 1, the carry, sign, zero, adjust, overflow, and parity bits are not updated. In some examples, instructions for increment, decrement, negation, addition, subtraction, AND, OR, shift arithmetically left, shift logically left, shift arithmetically right, shift logically right, rotate left, rotate right, multiply, divide, population count, leading zero count, total zero count, etc. support flag suppression.

Bit 19 can be combined with bits 14:11 to encode a register in a new data destination.

Bit 20 indicates a NDD in some examples. In some examples, if EVEX2.ND=0, there is no NDD and EVEX2. [V4,V3,V2,V1,V0] must be all zero. In some examples, if EVEX2.ND=1, there is an NDD whose register ID is encoded by EVEX2. [V4,V3,V2,V1,V0]. Although some instructions do not support NDD, the EVEX2.ND bit may be used to control whether its destination register has its upper bits (namely, bits[63: operand size]) zeroed when operand size is 8-bit or 16-bit. That is, if EVEX2.ND=1, the upper bits are always zeroed; otherwise, they keep the old values when operand size is 8-bit or 16-bit. For these instructions, EVEX2. [V4,V3,V2,V1,V0] is all zero.

Bit 21 is used in some examples to indicate exceptions are to be suppressed.

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 4501(C) are detailed in the following table.

| | 4 | 3 | [2:0] | REG. TYPE | COMMON USAGES |
|---|---|---|---|---|---|
| R | R4 | R3 | MOD R/M | GPR | Destination or Source |
| register | | | reg | | |
| B | B4 | B3 | MOD R/M | GPR | Destination or Source |
| register | | | reg | | |
| V | V4 | V3V2V1V0 | | GPR | 2nd Source or |
| register | | | | | Destination |
| RM | B4 | B3 | MOD R/M | GPR | 1st Source or |
| | | | R/M | | Destination |
| BASE | B4 | B3 | MOD R/M | GPR | Memory addressing |
| | | | R/M | | |
| INDEX | X4 | X3 | SIB.index | GPR | Memory addressing |

FIG. 50(D) illustrates fourth examples of the third prefix. In some examples, the prefix 4501(C) is an example of an EVEX2 prefix. The EVEX2 prefix 4501(C) is a four-byte prefix.

The extended EVEX prefix is an extension of the current 4-byte EVEX prefix and is used to provide APX features for legacy instructions which cannot be provided by the REX2 prefix (in particular, the new data destination) and APX extensions of VEX and EVEX instructions. Most bits in the third payload byte (except for the V4 bit) are left unspecified because the payload bit assignment depends on whether the EVEX prefix is used to provide APX extension to a legacy, VEX, or EVEX instruction, the details of which will be given in the subsections below. The byte following the extended EVEX prefix is always interpreted as the main opcode byte. Escape sequences 0x0F, 0x0F38 and 0x0F3A are neither needed nor allowed.

The EVEX2 prefix 4501(C) can encode 32 vector registers (e.g., 128-bit, 256-bit, and 512-bit registers) in 64-bit mode and/or 32 general purpose registers.

The EVEX2 prefix 4501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 4501(C) is a format field 5033 that has a value, in some examples, of 0x62. Subsequent bytes are referred to as payload bytes 5035-5039 and collectively form a 24-bit value of P[23:0] providing specific capability in the form of one or more fields (detailed herein).

Bits 0:2 (M0, M1, and M2) of a first payload byte (payload byte 0) 5039 are used to provide an opcode map identification. Note that this is limited to 8 maps.

Bit 3 (B4) provides the fifth bit and most significant bit for the B register identifier.

Bit 4 (R4) provides the fifth bit and most significant bit for the R register identifier.

Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).

Bits 9:8 provide opcode extensionality equivalent to some legacy prefixes (e.g., 00=no prefix, 01=66H, 10=F3H, and 11=F2H).

Bit 10 (X4) provides the fifth bit and most significant bit for the X register identifier.

Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.

Bit 15 (W) may serve as an opcode extension bit or operand size promotion.

Bits 16:17 are zero.

Bit 18 is used to indicate a flags update suppression in most examples. When set to 1, the carry, sign, zero, adjust, overflow, and parity bits are not updated.

Bit 19 can be combined with bits 14:11 to encode a register in a new data destination.

Bits 20, 22, and 23 are zero.

Bit 21 is a length specifier field.

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 4501(C) are detailed in the following table.

| | 4 | 3 | [2:0] | REG. TYPE | COMMON USAGES |
|---|---|---|---|---|---|
| R | R4 | R3 | MOD R/M | GPR | Destination or Source |
| register | | | reg | | |
| B | B4 | B3 | MOD R/M | GPR | Destination or Source |
| register | | | reg | | |
| V | V4 | V3V2V1V0 | | GPR | 2nd Source or |
| register | | | | | Destination |
| RM | B4 | B3 | MOD R/M | GPR | 1st Source or |
| | | | R/M | | Destination |
| BASE | B4 | B3 | MOD R/M | GPR | Memory addressing |
| | | | R/M | | |
| INDEX | X4 | X3 | SIB.index | GPR | Memory addressing |

FIG. 50(E) illustrates fifth examples of the third prefix. In some examples, the prefix 4501(C) is an example of an EVEX2 prefix. The EVEX2 prefix 4501(C) is a four-byte prefix.

The EVEX2 prefix 4501(C) can encode at least 32 vector registers (e.g., 128-bit, 256-bit, and 512-bit registers) in 64-bit mode and/or up to 64 general purpose registers. I

The EVEX2 prefix 4501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the EVEX2 prefix 4501(C) is a format field 5043 that has a value, in one example, of 0x62. Subsequent bytes are referred to as payload bytes 5045-5049 and collectively form a 24-bit value of P[23:0] providing specific capability in the form of one or more fields (detailed herein).

Bits 0:2 (M0, M1, and M2) of a first payload byte (payload byte 0) 5039 are used to provide an opcode map identification. Note that this is limited to 8 maps.

Bit 3 (B4) provides the fifth bit and most significant bit for the B register identifier.

Bit 4 (R4) provides the fifth bit and most significant bit for the R register identifier.

Bit 5 (B3), bit 6 (X3), and bit 7 (R3) provide the fourth bit for the B, X, and R register identifiers respectively when combined with a MOD R/M register field (R register), a MOD R/M R/M field (B register), and/or a SIB.INDEX field (X register).

Bits 9:8 provide opcode extensionality equivalent to some legacy prefixes (e.g., 00=no prefix, 01=66H, 10=F3H, and 11=F2H).

Bit 10 (X4) provides the fifth bit and most significant bit for the X register identifier.

Bits 14:11, shown as V3V2V1V0 may be used to: 1) encode the first source register operand, specified in inverted (1s complement) form and valid for instructions with 2 or more source operands; 2) encode a new data destination register operand, specified in 1s complement form for certain vector shifts; or 3) not encode any operand, the field is reserved and should contain a certain value, such as 1111b.

Bit 15 (W) may serve as an opcode extension bit or operand size promotion.

Bits 16:18 specify the index of a register in the opmask (writemask) registers (e.g., writemask/predicate registers 2615). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

Bit 19 can be combined with bits 14:11 to encode a register in a new data destination.

Bit 20 encodes multiple functionalities, which differ across different classes of instructions and can affect the meaning of the vector length/rounding control specifier field bits 21:22]).

Bit 23 indicates support for merging-writemasking (e.g., when set to 0) or support for zeroing and merging-writemasking (e.g., when set to 1).

In some examples, R3, R4, B3, X3, X4, V3, V2, V1, V0 are inverted. In some examples, B4 and X5 are repurposed reserved bits of an existing prefix that are used to provide the fifth and most significant bits of the B and X register identifiers. Their polarities are chosen so that the current fixed values at those two locations encode logical 0 after the repurposing. (In other words, the current fixed value at B4 is 0 and that at X4 is 1.)

Example examples of source and/or destination encoding in instructions using the EVEX2 prefix 4501(C) are detailed in the following table.

| | 4 | 3 | [2:0] | REG. TYPE | COMMON USAGES |
|---|---|---|---|---|---|
| R | R4 | R3 | MOD R/M | GPR | Destination or Source |
| register | | | reg | | |
| B | B4 | B3 | MOD R/M | GPR | Destination or Source |
| register | | | reg | | |
| V | V4 | V3V2V1V0 | | GPR | 2nd Source or |
| register | | | | | Destination |
| RM | B4 | B3 | MOD R/M | GPR | 1st Source or |
| | | | R/M | | Destination |
| BASE | B4 | B3 | MOD R/M | GPR | Memory addressing |
| | | | R/M | | |
| INDEX | X4 | X3 | SIB.index | GPR | Memory addressing |

The table below illustrates the new prefixes and how they differ from at least one legacy format. Note that OP is an operation to be performed.

| | APX REX2 | APX EVEX2 |
|---|---|---|
| Legacy Format | (No-NDD) Prefix | (NDD) Prefix |
| OP R/M, Reg | OP R/M, Reg | V = OP R/M, Reg |
| OP Reg, R/M | OP Reg, R/M | V = OP Reg, R/M |
| OP R/M, Imm | OP R/M, Imm | V = OP R/M, Imm |
| OP R/M | OP R/M | V = OP R/M |

### Graphics Execution Units

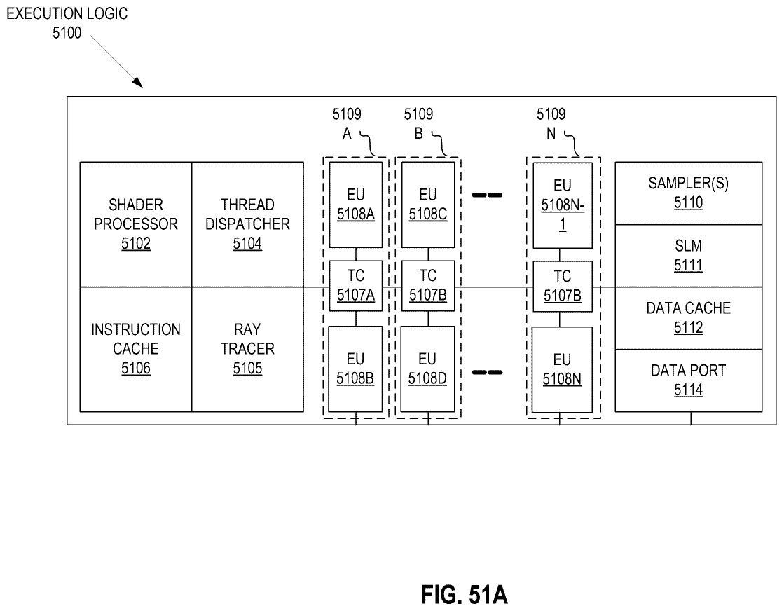

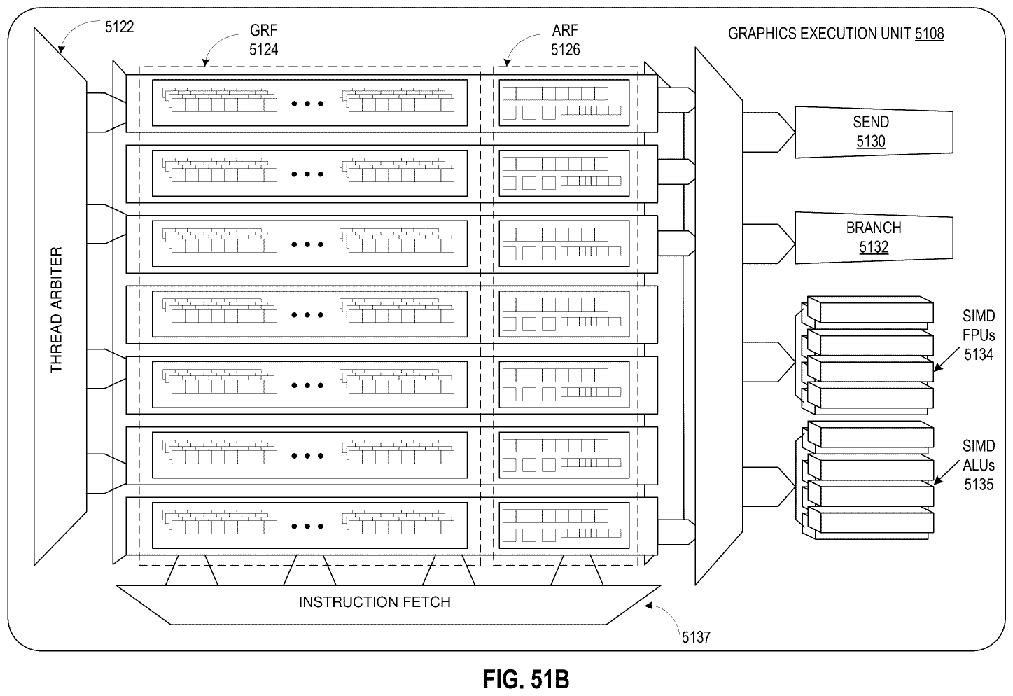

FIGS. 51A-51B illustrate thread execution logic 5100 including an array of processing elements employed in a graphics processor core according to examples described herein. Elements of FIGS. 51A-51B having the same reference numbers (or names) as the elements of any other figure herein can operate or function in any manner similar to that described elsewhere herein, but are not limited to such. FIG. 51A is representative of an execution unit within a general-purpose graphics processor, while FIG. 51B is representative of an execution unit that may be used within a compute accelerator.

As illustrated in FIG. 51A, in some examples thread execution logic 5100 includes a shader processor 5102, a thread dispatcher 5104, instruction cache 5106, a scalable execution unit array including a plurality of execution units 5108A-5108N, a sampler 5110, shared local memory 5111, a data cache 5112, and a data port 5114. In some examples the scalable execution unit array can dynamically scale by enabling or disabling one or more execution units (e.g., any of execution units 5108A, 5108B, 5108C, 5108D, through 5108N-1 and 5108N) based on the computational requirements of a workload. In some examples the included components are interconnected via an interconnect fabric that links to each of the components. In some examples, thread execution logic 5100 includes one or more connections to memory, such as system memory or cache memory, through one or more of instruction cache 5106, data port 5114, sampler 5110, and execution units 5108A-5108N. In some examples, each execution unit (e.g. 5108A) is a stand-alone programmable general-purpose computational unit that is capable of executing multiple simultaneous hardware threads while processing multiple data elements in parallel for each thread. In various examples, the array of execution units 5108A-5108N is scalable to include any number individual execution units.

In some examples, the execution units 5108A-5108N are primarily used to execute shader programs. A shader processor 5102 can process the various shader programs and dispatch execution threads associated with the shader programs via a thread dispatcher 5104. In some examples the thread dispatcher includes logic to arbitrate thread initiation requests from the graphics and media pipelines and instantiate the requested threads on one or more execution unit in the execution units 5108A-5108N. For example, a geometry pipeline can dispatch vertex, tessellation, or geometry shaders to the thread execution logic for processing. In some examples, thread dispatcher 5104 can also process runtime thread spawning requests from the executing shader programs.

In some examples, the execution units 5108A-5108N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 5108A-5108N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 5108A-5108N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 5108A-5108N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 5108A-5108N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused graphics execution unit 5109A-5109N having thread control logic (5107A-5107N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 5109A-5109N includes at least two execution units. For example, fused execution unit 5109A includes a first EU 5108A, second EU 5108B, and thread control logic 5107A that is common to the first EU 5108A and the second EU 5108B. The thread control logic 5107A controls threads executed on the fused graphics execution unit 5109A, allowing each EU within the fused execution units 5109A-5109N to execute using a common instruction pointer register.

One or more internal instruction caches (e.g., 5106) are included in the thread execution logic 5100 to cache thread instructions for the execution units. In some examples, one or more data caches (e.g., 5112) are included to cache thread data during thread execution. Threads executing on the thread execution logic 5100 can also store explicitly managed data in the shared local memory 5111. In some examples, a sampler 5110 is included to provide texture sampling for 3D operations and media sampling for media operations. In some examples, sampler 5110 includes specialized texture or media sampling functionality to process texture or media data during the sampling process before providing the sampled data to an execution unit.

During execution, the graphics and media pipelines send thread initiation requests to thread execution logic 5100 via thread spawning and dispatch logic. Once a group of geometric objects has been processed and rasterized into pixel data, pixel processor logic (e.g., pixel shader logic, fragment shader logic, etc.) within the shader processor 5102 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 5102 then executes an application programming interface (API)-supplied pixel or fragment shader program. To execute the shader program, the shader processor 5102 dispatches threads to an execution unit (e.g., 5108A) via thread dispatcher 5104. In some examples, shader processor 5102 uses texture sampling logic in the sampler 5110 to access texture data in texture maps stored in memory. Arithmetic operations on the texture data and the input geometry data compute pixel color data for each geometric fragment, or discards one or more pixels from further processing.

In some examples, the data port 5114 provides a memory access mechanism for the thread execution logic 5100 to output processed data to memory for further processing on a graphics processor output pipeline. In some examples, the data port 5114 includes or couples to one or more cache memories (e.g., data cache 5112) to cache data for memory access via the data port.

In some examples, the execution logic 5100 can also include a ray tracer 5105 that can provide ray tracing acceleration functionality. The ray tracer 5105 can support a ray tracing instruction set that includes instructions/functions for ray generation.

FIG. 51B illustrates exemplary internal details of an execution unit 5108, according to examples. A graphics execution unit 5108 can include an instruction fetch unit 5137, a general register file array (GRF) 5124, an architectural register file array (ARF) 5126, a thread arbiter 5122, a send unit 5130, a branch unit 5132, a set of SIMD floating point units (FPUs) 5134, and in some examples a set of dedicated integer SIMD ALUs 5135. The GRF 5124 and ARF 5126 includes the set of general register files and architecture register files associated with each simultaneous hardware thread that may be active in the graphics execution unit 5108. In some examples, per thread architectural state is maintained in the ARF 5126, while data used during thread execution is stored in the GRF 5124. The execution state of each thread, including the instruction pointers for each thread, can be held in thread-specific registers in the ARF 5126.

In some examples the graphics execution unit 5108 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 5108 is not limited to the number of hardware threads, and multiple logical threads can be assigned to each hardware thread.

In some examples, the graphics execution unit 5108 can co-issue multiple instructions, which may each be different instructions. The thread arbiter 5122 of the graphics execution unit thread 5108 can dispatch the instructions to one of the send unit 5130, branch unit 5132, or SIMD FPU(s) 5134 for execution. Each execution thread can access 128 general-purpose registers within the GRF 5124, where each register can store 32 bytes, accessible as a SIMD 8-element vector of 32-bit data elements. In some examples, each execution unit thread has access to 4 Kbytes within the GRF 5124, although examples are not so limited, and greater or fewer register resources may be provided in other examples. In some examples the graphics execution unit 5108 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 5124 can store a total of 28 Kbytes. Where 16 threads may access 4 Kbytes, the GRF 5124 can store a total of 64 Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 5130. In some examples, branch instructions are dispatched to a dedicated branch unit 5132 to facilitate SIMD divergence and eventual convergence.

In some examples the graphics execution unit 5108 includes one or more SIMD FPU(s) 5134 to perform floating-point operations. In some examples, the FPU(s) 5134 also support integer computation. In some examples the FPU(s) 5134 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 5135 are also present, and may be specifically optimized to perform operations associated with machine learning computations.

In some examples, arrays of multiple instances of the graphics execution unit 5108 can be instantiated in a graphics sub-core grouping (e.g., a sub-slice). For scalability, product architects can choose the exact number of execution units per sub-core grouping. In some examples the execution unit 5108 can execute instructions across a plurality of execution channels. In a further example, each thread executed on the graphics execution unit 5108 is executed on a different channel.

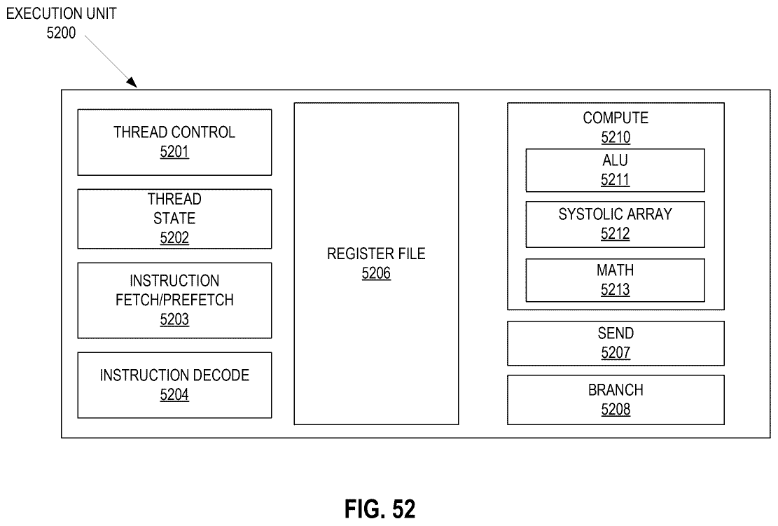

FIG. 52 illustrates an additional execution unit 5200, according to an example. In some examples, the execution unit 5200 includes a thread control unit 5201, a thread state unit 5202, an instruction fetch/prefetch unit 5203, and an instruction decode unit 5204. The execution unit 5200 additionally includes a register file 5206 that stores registers that can be assigned to hardware threads within the execution unit. The execution unit 5200 additionally includes a send unit 5207 and a branch unit 5208. In some examples, the send unit 5207 and branch unit 5208 can operate similarly as the send unit 5130 and a branch unit 5132 of the graphics execution unit 5108 of FIG. 51B.

The execution unit 5200 also includes a compute unit 5210 that includes multiple different types of functional units. In some examples the compute unit 5210 includes an ALU unit 5211 that includes an array of arithmetic logic units. The ALU unit 5211 can be configured to perform 64-bit, 32-bit, and 16-bit integer and floating point operations. Integer and floating point operations may be performed simultaneously. The compute unit 5210 can also include a systolic array 5212, and a math unit 5213. The systolic array 5212 includes a W wide and D deep network of data processing units that can be used to perform vector or other data-parallel operations in a systolic manner. In some examples the systolic array 5212 can be configured to perform matrix operations, such as matrix dot product operations. In some examples the systolic array 5212 support 16-bit floating point operations, as well as 8-bit and 4-bit integer operations. In some examples the systolic array 5212 can be configured to accelerate machine learning operations. In such examples, the systolic array 5212 can be configured with support for the bfloat 16-bit floating point format. In some examples, a math unit 5213 can be included to perform a specific subset of mathematical operations in an efficient and lower-power manner than the ALU unit 5211. The math unit 5213 can include a variant of math logic that may be found in shared function logic of a graphics processing engine provided by other examples. In some examples the math unit 5213 can be configured to perform 32-bit and 64-bit floating point operations.

The thread control unit 5201 includes logic to control the execution of threads within the execution unit. The thread control unit 5201 can include thread arbitration logic to start, stop, and preempt execution of threads within the execution unit 5200. The thread state unit 5202 can be used to store thread state for threads assigned to execute on the execution unit 5200. Storing the thread state within the execution unit 5200 enables the rapid pre-emption of threads when those threads become blocked or idle. The instruction fetch/prefetch unit 5203 can fetch instructions from an instruction cache of higher level execution logic (e.g., instruction cache 5106 as in FIG. 51A). The instruction fetch/prefetch unit 5203 can also issue prefetch requests for instructions to be loaded into the instruction cache based on an analysis of currently executing threads. The instruction decode unit 5204 can be used to decode instructions to be executed by the compute units. In some examples, the instruction decode unit 5204 can be used as a secondary decoder to decode complex instructions into constituent micro-operations.

The execution unit 5200 additionally includes a register file 5206 that can be used by hardware threads executing on the execution unit 5200. Registers in the register file 5206 can be divided across the logic used to execute multiple simultaneous threads within the compute unit 5210 of the execution unit 5200. The number of logical threads that may be executed by the execution unit 5200 is not limited to the number of hardware threads, and multiple logical threads can be assigned to each hardware thread. The size of the register file 5206 can vary across examples based on the number of supported hardware threads. In some examples, register renaming may be used to dynamically allocate registers to hardware threads.

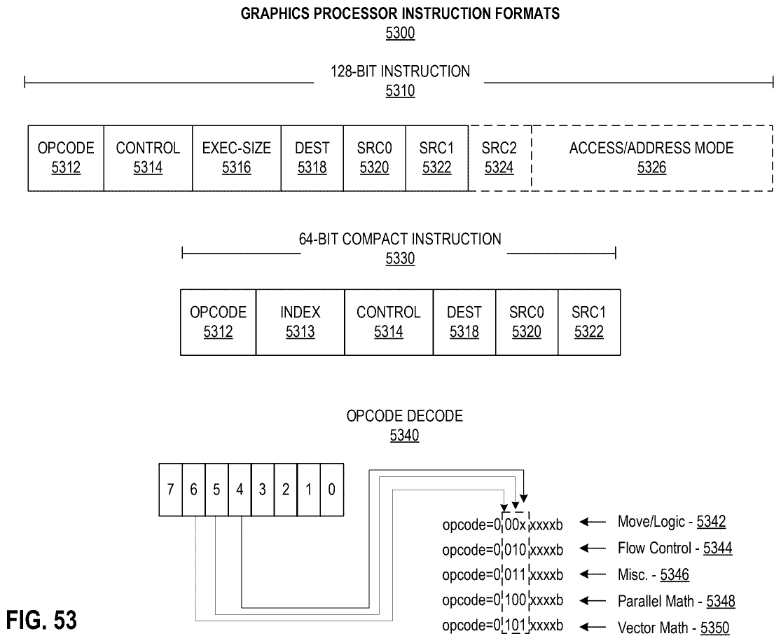

FIG. 53 is a block diagram illustrating a graphics processor instruction formats 5300 according to some examples. In one or more example, the graphics processor execution units support an instruction set having instructions in multiple formats. The solid lined boxes illustrate the components that are generally included in an execution unit instruction, while the dashed lines include components that are optional or that are only included in a sub-set of the instructions. In some examples, instruction format 5300 described and illustrated are macro-instructions, in that they are instructions supplied to the execution unit, as opposed to micro-operations resulting from instruction decode once the instruction is processed.

In some examples, the graphics processor execution units natively support instructions in a 128-bit instruction format 5310. A 64-bit compacted instruction format 5330 is available for some instructions based on the selected instruction, instruction options, and number of operands. The native 128-bit instruction format 5310 provides access to all instruction options, while some options and operations are restricted in the 64-bit compacted format 5330. The native instructions available in the 64-bit compacted format 5330 vary by example. In some examples, the instruction is compacted in part using a set of index values in an index field 5313. The execution unit hardware references a set of compaction tables based on the index values and uses the compaction table outputs to reconstruct a native instruction in the 128-bit instruction format 5310. Other sizes and formats of instruction can be used.

For each format, instruction opcode 5312 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some examples, instruction control field 5314 enables control over certain execution options, such as channels selection (e.g., predication) and data channel order (e.g., swizzle). For instructions in the 128-bit instruction format 5310 an exec-size field 5316 limits the number of data channels that will be executed in parallel. In some examples, exec-size field 5316 is not available for use in the 64-bit compact instruction format 5330.

Some execution unit instructions have up to three operands including two source operands, src0 5320, src1 5322, and one destination 5318. In some examples, the execution units support dual destination instructions, where one of the destinations is implied. Data manipulation instructions can have a third source operand (e.g., SRC2 5324), where the instruction opcode 5312 determines the number of source operands. An instruction's last source operand can be an immediate (e.g., hard-coded) value passed with the instruction.

In some examples, the 128-bit instruction format 5310 includes an access/address mode field 5326 specifying, for example, whether direct register addressing mode or indirect register addressing mode is used. When direct register addressing mode is used, the register address of one or more operands is directly provided by bits in the instruction.

In some examples, the 128-bit instruction format 5310 includes an access/address mode field 5326, which specifies an address mode and/or an access mode for the instruction. In some examples the access mode is used to define a data access alignment for the instruction. Some examples support access modes including a 16-byte aligned access mode and a 1-byte aligned access mode, where the byte alignment of the access mode determines the access alignment of the instruction operands. For example, when in a first mode, the instruction may use byte-aligned addressing for source and destination operands and when in a second mode, the instruction may use 16-byte-aligned addressing for all source and destination operands.

In some examples, the address mode portion of the access/address mode field 5326 determines whether the instruction is to use direct or indirect addressing. When direct register addressing mode is used bits in the instruction directly provide the register address of one or more operands. When indirect register addressing mode is used, the register address of one or more operands may be computed based on an address register value and an address immediate field in the instruction.

In some examples instructions are grouped based on opcode 5312 bit-fields to simplify Opcode decode 5340. For an 8-bit opcode, bits 4, 5, and 6 allow the execution unit to determine the type of opcode. The precise opcode grouping shown is merely an example. In some examples, a move and logic opcode group 5342 includes data movement and logic instructions (e.g., move (mov), compare (cmp)). In some examples, move and logic opcode group 5342 shares the five most significant bits (MSB), where move (mov) instructions are in the form of 0000xxxxb and logic instructions are in the form of 0001xxxxb. A flow control instruction group 5344 (e.g., call, jump (jmp)) includes instructions in the form of 0010xxxxb (e.g., 0x20). A miscellaneous instruction group 5346 includes a mix of instructions, including synchronization instructions (e.g., wait, send) in the form of 0011xxxxb (e.g., 0x30). A parallel math instruction group 5348 includes component-wise arithmetic instructions (e.g., add, multiply (mul)) in the form of 0100xxxxb (e.g., 0x40). The parallel math instruction group 5348 performs the arithmetic operations in parallel across data channels. The vector math group 5350 includes arithmetic instructions (e.g., dp4) in the form of 0101xxxxb (e.g., 0x50). The vector math group performs arithmetic such as dot product calculations on vector operands. The illustrated opcode decode 5340, in some examples, can be used to determine which portion of an execution unit will be used to execute a decoded instruction. For example, some instructions may be designated as systolic instructions that will be performed by a systolic array. Other instructions, such as ray-tracing instructions (not shown) can be routed to a ray-tracing core or ray-tracing logic within a slice or partition of execution logic.

### Graphics Pipeline

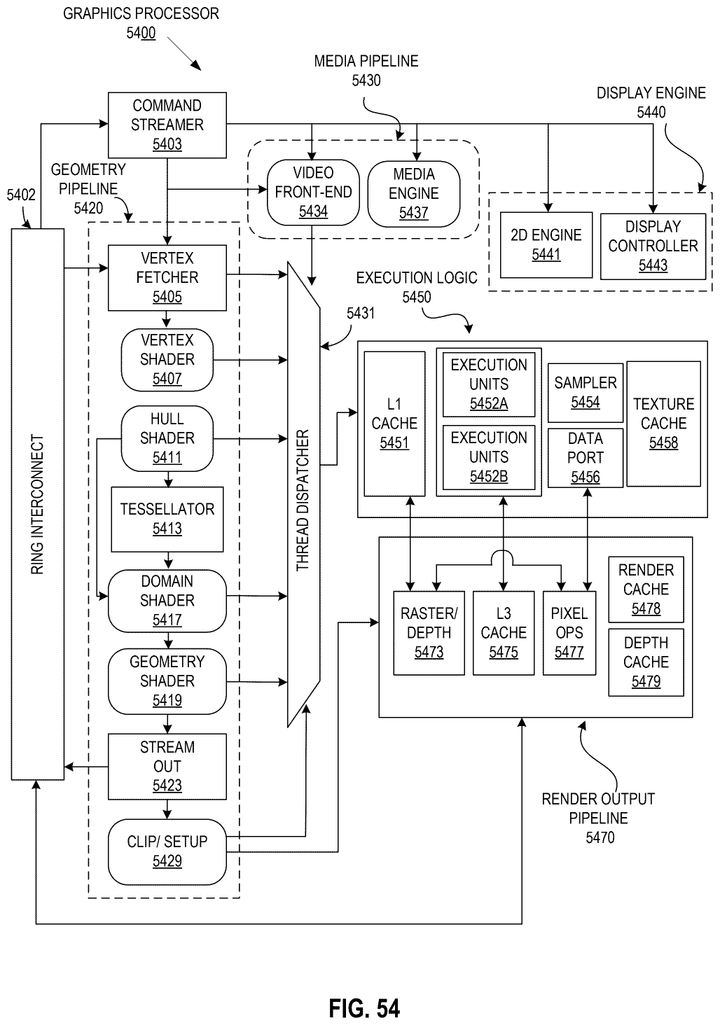

FIG. 54 is a block diagram of another example of a graphics processor 5400. Elements of FIG. 54 having the same reference numbers (or names) as the elements of any other figure herein can operate or function in any manner similar to that described elsewhere herein, but are not limited to such.

In some examples, graphics processor 5400 includes a geometry pipeline 5420, a media pipeline 5430, a display engine 5440, thread execution logic 5450, and a render output pipeline 5470. In some examples, graphics processor 5400 is a graphics processor within a multi-core processing system that includes one or more general-purpose processing cores. The graphics processor is controlled by register writes to one or more control registers (not shown) or via commands issued to graphics processor 5400 via a ring interconnect 5402. In some examples, ring interconnect 5402 couples graphics processor 5400 to other processing components, such as other graphics processors or general-purpose processors. Commands from ring interconnect 5402 are interpreted by a command streamer 5403, which supplies instructions to individual components of the geometry pipeline 5420 or the media pipeline 5430.

In some examples, command streamer 5403 directs the operation of a vertex fetcher 5405 that reads vertex data from memory and executes vertex-processing commands provided by command streamer 5403. In some examples, vertex fetcher 5405 provides vertex data to a vertex shader 5407, which performs coordinate space transformation and lighting operations to each vertex. In some examples, vertex fetcher 5405 and vertex shader 5407 execute vertex-processing instructions by dispatching execution threads to execution units 5452A-5452B via a thread dispatcher 5431.

In some examples, execution units 5452A-5452B are an array of vector processors having an instruction set for performing graphics and media operations. In some examples, execution units 5452A-5452B have an attached L1 cache 5451 that is specific for each array or shared between the arrays. The cache can be configured as a data cache, an instruction cache, or a single cache that is partitioned to contain data and instructions in different partitions.

In some examples, geometry pipeline 5420 includes tessellation components to perform hardware-accelerated tessellation of 3D objects. In some examples, a programmable hull shader 5411 configures the tessellation operations. A programmable domain shader 5417 provides back-end evaluation of tessellation output. A tessellator 5413 operates at the direction of hull shader 5411 and contains special purpose logic to generate a set of detailed geometric objects based on a coarse geometric model that is provided as input to geometry pipeline 5420. In some examples, if tessellation is not used, tessellation components (e.g., hull shader 5411, tessellator 5413, and domain shader 5417) can be bypassed.

In some examples, complete geometric objects can be processed by a geometry shader 5419 via one or more threads dispatched to execution units 5452A-5452B, or can proceed directly to the clipper 5429. In some examples, the geometry shader operates on entire geometric objects, rather than vertices or patches of vertices as in previous stages of the graphics pipeline. If the tessellation is disabled the geometry shader 5419 receives input from the vertex shader 5407. In some examples, geometry shader 5419 is programmable by a geometry shader program to perform geometry tessellation if the tessellation units are disabled.

Before rasterization, a clipper 5429 processes vertex data. The clipper 5429 may be a fixed function clipper or a programmable clipper having clipping and geometry shader functions. In some examples, a rasterizer and depth test component 5473 in the render output pipeline 5470 dispatches pixel shaders to convert the geometric objects into per pixel representations. In some examples, pixel shader logic is included in thread execution logic 5450. In some examples, an application can bypass the rasterizer and depth test component 5473 and access un-rasterized vertex data via a stream out unit 5423.

The graphics processor 5400 has an interconnect bus, interconnect fabric, or some other interconnect mechanism that allows data and message passing amongst the major components of the processor. In some examples, execution units 5452A-5452B and associated logic units (e.g., L1 cache 5451, sampler 5454, texture cache 5458, etc.) interconnect via a data port 5456 to perform memory access and communicate with render output pipeline components of the processor. In some examples, sampler 5454, caches 5451, 5458 and execution units 5452A-5452B each have separate memory access paths. In some examples the texture cache 5458 can also be configured as a sampler cache.

In some examples, render output pipeline 5470 contains a rasterizer and depth test component 5473 that converts vertex-based objects into an associated pixel-based representation. In some examples, the rasterizer logic includes a windower/masker unit to perform fixed function triangle and line rasterization. An associated render cache 5478 and depth cache 5479 are also available in some examples. A pixel operations component 5477 performs pixel-based operations on the data, though in some instances, pixel operations associated with 2D operations (e.g. bit block image transfers with blending) are performed by the 2D engine 5441, or substituted at display time by the display controller 5443 using overlay display planes. In some examples, a shared L3 cache 5475 is available to all graphics components, allowing the sharing of data without the use of main system memory.

In some examples, media pipeline 5430 includes a media engine 5437 and a video front-end 5434. In some examples, video front-end 5434 receives pipeline commands from the command streamer 5403. In some examples, media pipeline 5430 includes a separate command streamer. In some examples, video front-end 5434 processes media commands before sending the command to the media engine 5437. In some examples, media engine 5437 includes thread spawning functionality to spawn threads for dispatch to thread execution logic 5450 via thread dispatcher 5431.

In some examples, graphics processor 5400 includes a display engine 5440. In some examples, display engine 5440 is external to graphics processor 5400 and couples with the graphics processor via the ring interconnect 5402, or some other interconnect bus or fabric. In some examples, display engine 5440 includes a 2D engine 5441 and a display controller 5443. In some examples, display engine 5440 contains special purpose logic capable of operating independently of the 3D pipeline. In some examples, display controller 5443 couples with a display device (not shown), which may be a system integrated display device, as in a laptop computer, or an external display device attached via a display device connector.

In some examples, the geometry pipeline 5420 and media pipeline 5430 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

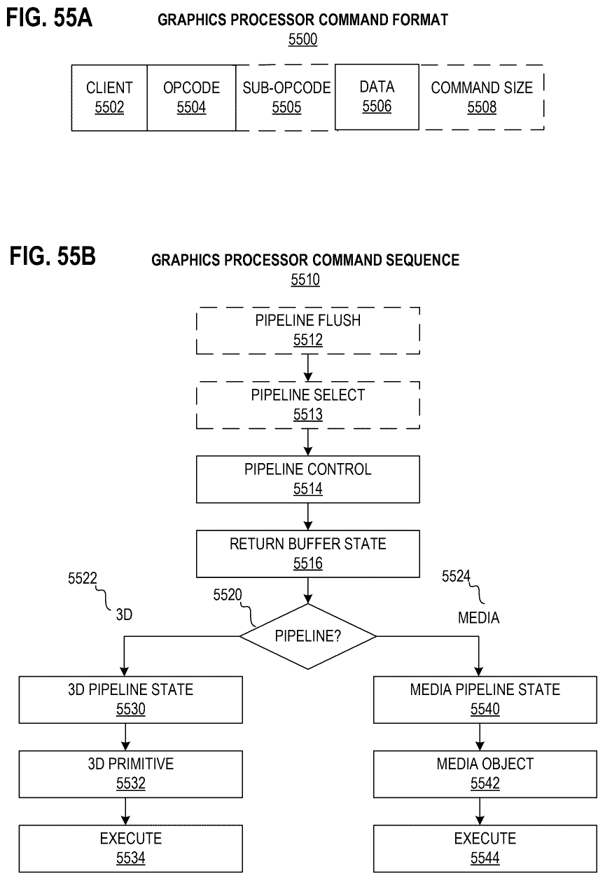

FIG. 55A is a block diagram illustrating a graphics processor command format 5500 according to some examples. FIG. 55B is a block diagram illustrating a graphics processor command sequence 5510 according to an example. The solid lined boxes in FIG. 55A illustrate the components that are generally included in a graphics command while the dashed lines include components that are optional or that are only included in a sub-set of the graphics commands. The graphics processor command format 5500 of FIG. 55A includes data fields to identify a client 5502, a command operation code (opcode) 5504, and data 5506 for the command. A sub-opcode 5505 and a command size 5508 are also included in some commands.

In some examples, client 5502 specifies the client unit of the graphics device that processes the command data. In some examples, a graphics processor command parser examines the client field of each command to condition the further processing of the command and route the command data to the appropriate client unit. In some examples, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 5504 and, if present, sub-opcode 5505 to determine the operation to perform. The client unit performs the command using information in data field 5506. For some commands an explicit command size 5508 is expected to specify the size of the command. In some examples, the command parser automatically determines the size of at least some of the commands based on the command opcode. In some examples commands are aligned via multiples of a double word. Other command formats can be used.

The flow diagram in FIG. 55B illustrates a graphics processor command sequence 5510. In some examples, software or firmware of a data processing system that features an example of a graphics processor uses a version of the command sequence shown to set up, execute, and terminate a set of graphics operations. A sample command sequence is shown and described for purposes of example only as examples are not limited to these specific commands or to this command sequence. Moreover, the commands may be issued as batch of commands in a command sequence, such that the graphics processor will process the sequence of commands in at least partially concurrence.

In some examples, the graphics processor command sequence 5510 may begin with a pipeline flush command 5512 to cause any active graphics pipeline to complete the currently pending commands for the pipeline. In some examples, the 3D pipeline 5522 and the media pipeline 5524 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some examples, pipeline flush command 5512 can be used for pipeline synchronization or before placing the graphics processor into a low power state.

In some examples, a pipeline select command 5513 is used when a command sequence requires the graphics processor to explicitly switch between pipelines. In some examples, a pipeline select command 5513 is required only once within an execution context before issuing pipeline commands unless the context is to issue commands for both pipelines. In some examples, a pipeline flush command 5512 is required immediately before a pipeline switch via the pipeline select command 5513.

In some examples, a pipeline control command 5514 configures a graphics pipeline for operation and is used to program the 3D pipeline 5522 and the media pipeline 5524. In some examples, pipeline control command 5514 configures the pipeline state for the active pipeline. In some examples, the pipeline control command 5514 is used for pipeline synchronization and to clear data from one or more cache memories within the active pipeline before processing a batch of commands.

In some examples, return buffer state commands 5516 are used to configure a set of return buffers for the respective pipelines to write data. Some pipeline operations require the allocation, selection, or configuration of one or more return buffers into which the operations write intermediate data during processing. In some examples, the graphics processor also uses one or more return buffers to store output data and to perform cross thread communication. In some examples, the return buffer state includes selecting the size and number of return buffers to use for a set of pipeline operations.

The remaining commands in the command sequence differ based on the active pipeline for operations. Based on a pipeline determination 5520, the command sequence is tailored to the 3D pipeline 5522 beginning with the 3D pipeline state 5530 or the media pipeline 5524 beginning at the media pipeline state 5540.

The commands to configure the 3D pipeline state 5530 include 3D state setting commands for vertex buffer state, vertex element state, constant color state, depth buffer state, and other state variables that are to be configured before 3D primitive commands are processed. The values of these commands are determined at least in part based on the particular 3D API in use. In some examples, 3D pipeline state 5530 commands are also able to selectively disable or bypass certain pipeline elements if those elements will not be used.

In some examples, 3D primitive 5532 command is used to submit 3D primitives to be processed by the 3D pipeline. Commands and associated parameters that are passed to the graphics processor via the 3D primitive 5532 command are forwarded to the vertex fetch function in the graphics pipeline. The vertex fetch function uses the 3D primitive 5532 command data to generate vertex data structures. The vertex data structures are stored in one or more return buffers. In some examples, 3D primitive 5532 command is used to perform vertex operations on 3D primitives via vertex shaders. To process vertex shaders, 3D pipeline 5522 dispatches shader execution threads to graphics processor execution units.

In some examples, 3D pipeline 5522 is triggered via an execute 5534 command or event. In some examples, a register write triggers command execution. In some examples execution is triggered via a ‘go’ or ‘kick’ command in the command sequence. In some examples, command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some examples, the graphics processor command sequence 5510 follows the media pipeline 5524 path when performing media operations. In general, the specific use and manner of programming for the media pipeline 5524 depends on the media or compute operations to be performed. Specific media decode operations may be offloaded to the media pipeline during media decode. In some examples, the media pipeline can also be bypassed and media decode can be performed in whole or in part using resources provided by one or more general-purpose processing cores. In some examples, the media pipeline also includes elements for general-purpose graphics processor unit (GPGPU) operations, where the graphics processor is used to perform SIMD vector operations using computational shader programs that are not explicitly related to the rendering of graphics primitives.

In some examples, media pipeline 5524 is configured in a similar manner as the 3D pipeline 5522. A set of commands to configure the media pipeline state 5540 are dispatched or placed into a command queue before the media object commands 5542. In some examples, commands for the media pipeline state 5540 include data to configure the media pipeline elements that will be used to process the media objects. This includes data to configure the video decode and video encode logic within the media pipeline, such as encode or decode format. In some examples, commands for the media pipeline state 5540 also support the use of one or more pointers to “indirect” state elements that contain a batch of state settings.

In some examples, media object commands 5542 supply pointers to media objects for processing by the media pipeline. The media objects include memory buffers containing video data to be processed. In some examples, all media pipeline states must be valid before issuing a media object command 5542. Once the pipeline state is configured and media object commands 5542 are queued, the media pipeline 5524 is triggered via an execute command 5544 or an equivalent execute event (e.g., register write). Output from media pipeline 5524 may then be post processed by operations provided by the 3D pipeline 5522 or the media pipeline 5524. In some examples, GPGPU operations are configured and executed in a similar manner as media operations.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

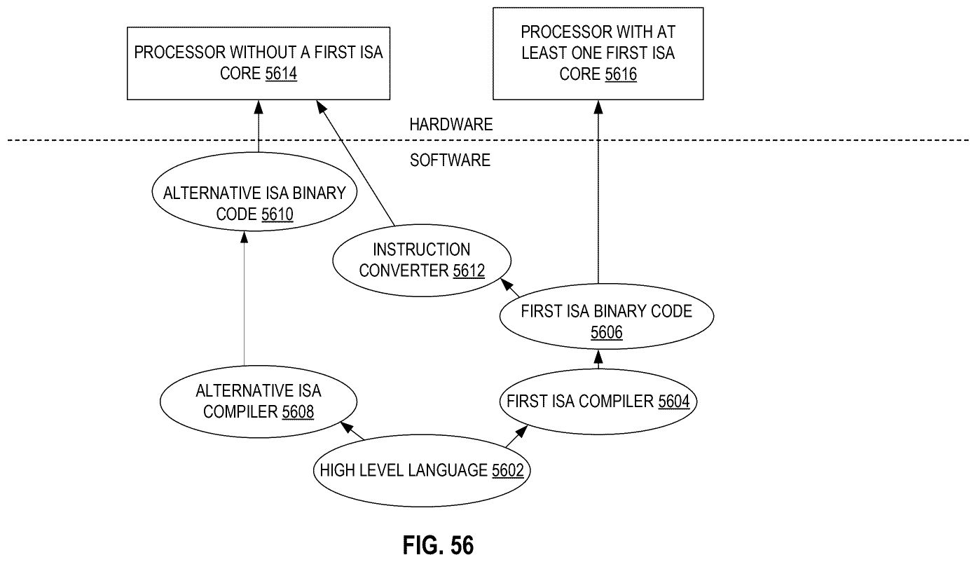

FIG. 56 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 56 shows a program in a high-level language 5602 may be compiled using a first ISA compiler 5604 to generate first ISA binary code 5606 that may be natively executed by a processor with at least one first ISA core 5616. The processor with at least one first ISA core 5616 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 5604 represents a compiler that is operable to generate first ISA binary code 5606 (e.g., object code) that can, with or without additional linkage processing, be executed on the processor with at least one first ISA core 5616. Similarly, FIG. 56 shows the program in the high-level language 5602 may be compiled using an alternative ISA compiler 5608 to generate alternative ISA binary code 5610 that may be natively executed by a processor without a first ISA core 5614. The instruction converter 5612 is used to convert the first ISA binary code 5606 into code that may be natively executed by the processor without a first ISA core 5614. This converted code is not necessarily to be the same as the alternative ISA binary code 5610; however, the converted code will accomplish the general operation and be made up of instructions from the alternative ISA. Thus, the instruction converter 5612 represents software, firmware, hardware, or a combination thereof that, through emulation, simulation or any other process, allows a processor or other electronic device that does not have a first ISA processor or core to execute the first ISA binary code 5606.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

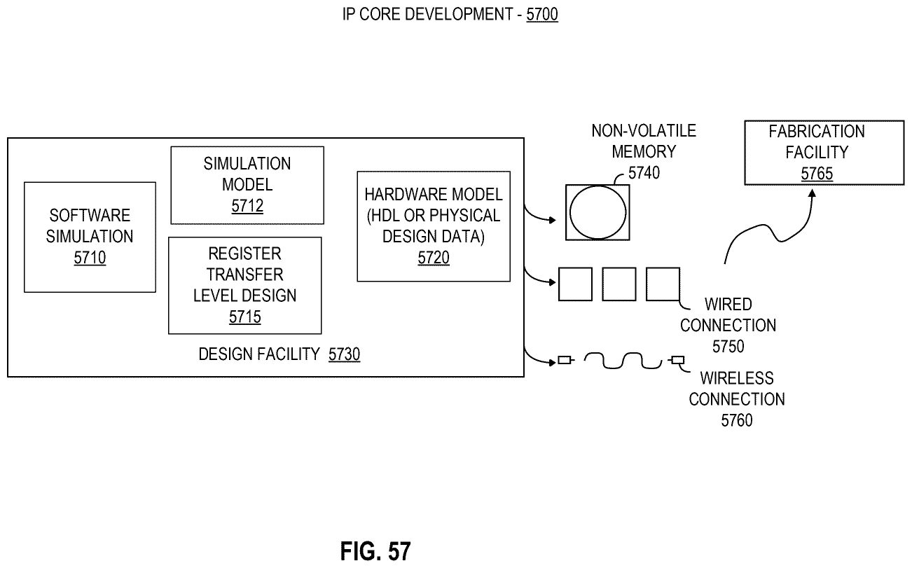

FIG. 57 is a block diagram illustrating an IP core development system 5700 that may be used to manufacture an integrated circuit to perform operations according to some examples. The IP core development system 5700 may be used to generate modular, re-usable designs that can be incorporated into a larger design or used to construct an entire integrated circuit (e.g., an SOC integrated circuit). A design facility 5730 can generate a software simulation 5710 of an IP core design in a high-level programming language (e.g., C/C++). The software simulation 5710 can be used to design, test, and verify the behavior of the IP core using a simulation model 5712. The simulation model 5712 may include functional, behavioral, and/or timing simulations. A register transfer level (RTL) design 5715 can then be created or synthesized from the simulation model 5712. The RTL design 5715 is an abstraction of the behavior of the integrated circuit that models the flow of digital signals between hardware registers, including the associated logic performed using the modeled digital signals. In addition to an RTL design 5715, lower-level designs at the logic level or transistor level may also be created, designed, or synthesized. Thus, the particular details of the initial design and simulation may vary.

The RTL design 5715 or equivalent may be further synthesized by the design facility into a hardware model 5720, which may be in a hardware description language (HDL), or some other representation of physical design data. The HDL may be further simulated or tested to verify the IP core design. The IP core design can be stored for delivery to a fabrication facility 5765 using non-volatile memory 5740 (e.g., hard disk, flash memory, or any non-volatile storage medium). Alternatively, the IP core design may be transmitted (e.g., via the Internet) over a wired connection 5750 or wireless connection 5760. The fabrication facility 5765 may then fabricate an integrated circuit that is based at least in part on the IP core design. The fabricated integrated circuit can be configured to perform operations in accordance with at least some examples described herein.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:

1. An apparatus comprising:
a plurality of transpose engines to transpose a source matrix operand of a single instruction to generate a transposed source matrix; and
control circuitry to direct the plurality of transpose engines to alternately operate in a parallel loading mode and a serial loading mode to generate the transposed source matrix, wherein the plurality of transposes engines and the control circuitry are at least a portion of transpose circuitry.

2. The apparatus of example 1, wherein the single instruction comprises an identifier of a location of the source matrix operand and an identifier of a location of a destination location to store the transposed source matrix.

3. The apparatus of example 2, wherein at least one of the location of the source matrix operation and the location of the destination location is a memory location.

4. The apparatus of example 2, wherein at least one of the location of the source matrix operation and the location of the destination location is a tile register.

5. The apparatus of any of examples 1-4, wherein the plurality of transpose engines comprises a plurality of data storage circuits coupled to switches.

6. The apparatus of example 5, wherein the data storage circuits are registers.

7. The apparatus of any of examples 1-6, further comprising:
a host processor; and
a matrix operations accelerator, wherein at least one of the host processor and the matrix operations accelerator are coupled to the transpose circuitry.

8. The apparatus of example 7, wherein the single instruction comprises an opcode, an identifier of a location of the source matrix operand, an identifier of a second source matrix operand, and an identifier of a location of a destination location, wherein the opcode is to indicate that at least the source matrix operand is to be transposed prior to a compute operation by the matrix operations accelerator using the generated transposed source matrix and the second source matrix.

9. A method comprising:
decoding an instance of a single instruction having fields for an opcode, a source operand identifier, and a destination operand identifier, wherein the opcode is to indicate that execution circuitry is to at least transpose data of the identified source operand; and
executing, by transpose circuitry independent of a matrix operations accelerator and a host processor, the decoded single instruction according to the opcode.

10. The method of example 9, wherein the transpose circuitry comprises:
a plurality of transpose engines to transpose a source matrix operand of a single instruction to generate a transposed source matrix; and
control circuitry to direct the plurality of transpose engines to alternately operate in a parallel loading mode and a serial loading mode to generate the transposed source matrix, wherein the plurality of transposes engines and the control circuitry are at least a portion of transpose circuitry.

11. The method of example 10, wherein the plurality of transpose engines comprises a plurality of data storage circuits coupled to switches.

12. The method of example 11, wherein the data storage circuits are registers.

13. The method of any of examples 9-12, wherein at least one of a location of the source matrix operation and a location of the destination location is a memory location.

14. The method of any of examples 9-12, wherein at least one of a location of the source matrix operation and a location of the destination location is a tile register.

15. The method of any of examples 9-14, further comprising:
performing, in response to the instance of the single instruction, a compute operation using the transposed source matrix in the matrix operations accelerator.

16. The method of example 15, wherein the instance of the single instruction further comprises an identifier of a second source matrix operand, wherein the opcode is to indicate that at least the source matrix operand is to be transposed prior to a compute operation by the matrix operations accelerator using the transposed source matrix and the second source matrix.

17. A system comprising:
transpose circuitry comprising:
   a plurality of transpose engines to transpose a source matrix operand of a single instruction to generate a transposed source matrix, and
   control circuitry to direct the plurality of transpose engines to alternately operate in a parallel loading mode and a serial loading mode to generate the transposed source matrix, wherein the plurality of transposes engines and the control circuitry are at least a portion of transpose circuitry;
a host processor coupled to the transpose circuitry; and
a matrix operations accelerator coupled to at least the host processor.

18. The system of example 17, wherein the system is a system-on-a-chip.

19. The system of any of examples 17-18, wherein the single instruction comprises an identifier of a location of the source matrix operand and an identifier of a location of a destination location to store the transposed source matrix.

20. The system of any of examples 17-18, wherein the single instruction comprises an opcode, an identifier of a location of the source matrix operand, an identifier of a second source matrix operand, and an identifier of a location of a destination location, wherein the opcode is to indicate that at least the source matrix operand is to be transposed prior to a compute operation by the matrix operations accelerator using the generated transposed source matrix and the second source matrix.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a plurality of transpose engines to transpose a source matrix operand of a single instruction to generate a transposed source matrix; and
control circuitry to direct the plurality of transpose engines to alternately operate in a parallel loading mode and a serial loading mode to generate the transposed source matrix, wherein the plurality of transposes engines and the control circuitry are at least a portion of transpose circuitry.

2. The apparatus of claim 1, wherein the single instruction comprises an identifier of a location of the source matrix operand and an identifier of a location of a destination location to store the transposed source matrix.

3. The apparatus of claim 2, wherein at least one of the location of the source matrix operation and the location of the destination location is a memory location.

4. The apparatus of claim 2, wherein at least one of the location of the source matrix operation and the location of the destination location is a tile register.

5. The apparatus of claim 1, wherein the plurality of transpose engines comprises a plurality of data storage circuits coupled to switches.

6. The apparatus of claim 5, wherein the data storage circuits are registers.

7. The apparatus of claim 1, further comprising:
a host processor; and
a matrix operations accelerator, wherein at least one of the host processor and the matrix operations accelerator are coupled to the transpose circuitry.

8. The apparatus of claim 7, wherein the single instruction comprises an opcode, an identifier of a location of the source matrix operand, an identifier of a second source matrix operand, and an identifier of a location of a destination location, wherein the opcode is to indicate that at least the source matrix operand is to be transposed prior to a compute operation by the matrix operations accelerator using the generated transposed source matrix and the second source matrix.

9. A method comprising:
decoding an instance of a single instruction having fields for an opcode, a source operand identifier, and a destination operand identifier, wherein the opcode is to indicate that execution circuitry is to at least transpose data of the identified source operand; and
executing, by transpose circuitry independent of a matrix operations accelerator and a host processor, the decoded single instruction according to the opcode.

10. The method of claim 9, wherein the transpose circuitry comprises:
a plurality of transpose engines to transpose a source matrix operand of a single instruction to generate a transposed source matrix; and
control circuitry to direct the plurality of transpose engines to alternately operate in a parallel loading mode and a serial loading mode to generate the transposed source matrix, wherein the plurality of transposes engines and the control circuitry are at least a portion of transpose circuitry.

11. The method of claim 10, wherein the plurality of transpose engines comprises a plurality of data storage circuits coupled to switches.

12. The method of claim 11, wherein the data storage circuits are registers.

13. The method of claim 9, wherein at least one of a location of the source matrix operation and a location of a destination location is a memory location.

14. The method of claim 9, wherein at least one of a location of the source matrix operation and a location of a destination location is a tile register.

15. The method of claim 9, further comprising:
performing, in response to the instance of the single instruction, a compute operation using the transposed source matrix in the matrix operations accelerator.

16. The method of claim 15, wherein the instance of the single instruction further comprises an identifier of a second source matrix operand, wherein the opcode is to indicate that at least the source matrix operand is to be transposed prior to a compute operation by the matrix operations accelerator using the transposed source matrix and the second source matrix.

17. A system comprising:
transpose circuitry comprising:
a plurality of transpose engines to transpose a source matrix operand of a single instruction to generate a transposed source matrix, and
control circuitry to direct the plurality of transpose engines to alternately operate in a parallel loading mode and a serial loading mode to generate the transposed source matrix, wherein the plurality of transposes engines and the control circuitry are at least a portion of transpose circuitry;
a host processor coupled to the transpose circuitry; and
a matrix operations accelerator coupled to at least the host processor.

18. The system of claim 17, wherein the system is a system-on-a-chip.

19. The system of claim 17, wherein the single instruction comprises an identifier of a location of the source matrix operand and an identifier of a location of a destination location to store the transposed source matrix.

20. The system of claim 17, wherein the single instruction comprises an opcode, an identifier of a location of the source matrix operand, an identifier of a second source matrix operand, and an identifier of a location of a destination location, wherein the opcode is to indicate that at least the source matrix operand is to be transposed prior to a compute operation by the matrix operations accelerator using the generated transposed source matrix and the second source matrix.
